(19) United States
(12) Patent Application Publication
(10) Pub. No.: US 2021/0398269 A1
(43) Pub. Date: Dec. 23, 2021

(54) METHOD AND SYSTEM FOR LAYERED WOOD PRODUCT PRODUCTION

(71) Applicant: Boise Cascade Company, Boise, ID (US)

(72) Inventors: David Bolton, Lena, LA (US); Jude Richard Peek, Pineville, LA (US); Curtis Fennell, Boyce, LA (US)

(73) Assignee: Boise Cascade Company, Boise, ID (US)

(21) Appl. No.: 17/361,808

(22) Filed: Jun. 29, 2021

Related U.S. Application Data
(63) Continuation-in-part of application No. 16/697,458, filed on Nov. 27, 2019, now Pat. No. 11,090,833.
(60) Provisional application No. 62/773,992, filed on Nov. 30, 2018.

(51) Int. Cl. G06T 7/00; B27D 1/04; B27D 3/02

(52) U.S. Cl. CPC G06T 7/0004; B27D 1/04; G06T 2207/30161; G06T 2207/10048; B27D 3/02

(57) ABSTRACT

Irregularities on the surfaces of veneer, such as full veneer sheets and/or veneer core material are detected using Near InfraRed (NIR) technology, including Near InfraRed/Short Wave InfraRed (NIR/SWIR) cameras and detectors. A grade is then assigned to the veneer based, at least in part, on the detected irregularities. The graded veneer is then stacked based, at least in part, on the grade assigned to the veneer. The graded veneer stacks are then provided to local robotic panel assembly and pressing systems that include one or more local robotic panel assembly cells for processing the veneer into layered wood product panels.

### RELATED APPLICATIONS

This application is a continuation in part of Bolton et al., U.S. patent application Ser. No. 16/697,458 (attorney docket number BCC-004), filed Nov. 27, 2019, now allowed, entitled “METHOD AND SYSTEM FOR ENSURING THE QUALITY OF A WOOD PRODUCT BASED ON SURFACE IRREGULARITIES USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related to Bolton et al., U.S. patent application Ser. No. 16/205,027 (attorney docket number BCC-005), filed Nov. 29, 2018, now issued as U.S. Pat. No. 10,825,164 on Nov. 3, 2020, entitled “IMAGING SYSTEM FOR ANALYSIS OF WOOD PRODUCTS,” which claims the benefit of David Bolton, U.S. Provisional Patent Application No. 62/595,489, filed on Dec. 6, 2017, entitled “IMAGING SYSTEM FOR ANALYSIS OF WOOD PRODUCTS,” which is hereby incorporated by reference in its entirety as if it were fully set forth herein.

This application is related to Bolton et al., U.S. patent application Ser. No. 16/687,311 (attorney docket number BCC-003), filed Nov. 18, 2019, entitled “METHOD AND SYSTEM FOR DETECTING MOISTURE LEVELS IN WOOD PRODUCTS USING NEAR INFRARED IMAGING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/687,342 (attorney docket number BCC-006), filed on Nov. 18, 2019, entitled “METHOD AND SYSTEM FOR DETECTING MOISTURE LEVELS IN WOOD PRODUCTS USING NEAR INFRARED IMAGING AND MACHINE LEARNING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/687,369 (attorney docket number BCC-007), filed on Nov. 18, 2019, entitled “METHOD AND SYSTEM FOR MOISTURE GRADING WOOD PRODUCTS USING SUPERIMPOSED NEAR INFRARED AND VISUAL IMAGES,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/697,461 (attorney docket number BCC-008), filed on Nov. 27, 2019, now issued as U.S. Pat. No. 10,933,556 on Mar. 2, 2021, entitled “METHOD AND SYSTEM FOR ENSURING THE QUALITY OF A WOOD PRODUCT BASED ON SURFACE IRREGULARITIES USING NEAR INFRARED IMAGING AND MACHINE LEARNING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related to Bolton et al., U.S. patent application Ser. No. 16/697,466 (attorney docket number BCC-009), filed on Nov. 27, 2019, now issued as U.S. Pat. No. 10,933,557 on Mar. 2, 2021, entitled “METHOD AND SYSTEM FOR ADJUSTING THE PRODUCTION PROCESS OF A WOOD PRODUCT BASED ON A LEVEL OF IRREGULARITY OF A SURFACE OF THE WOOD PRODUCT USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related Bolton et al., U.S. patent application Ser. No. 17/230,470 (attorney docket number BCC-013), filed Apr. 14, 2021, entitled “METHOD AND SYSTEM FOR FULL VENEER SHEET GRADING AND STACKING,” which is hereby incorporated by reference in its entirety as if it were fully set forth herein.

This application is related Bolton et al., U.S. patent application Ser. No. 17/230,497 (attorney docket number BCC-017), filed Apr. 14, 2021, entitled “METHOD AND SYSTEM FOR VENEER STRIP GRADING AND STACKING,” which is hereby incorporated by reference in its entirety as if it were fully set forth herein.

This application is related to Bolton et al., U.S. patent application Ser. No. 17/100,464 (attorney docket number BCC-012), filed Nov. 20, 2020, entitled, “METHOD AND SYSTEM FOR LAYERED WOOD PRODUCT PRODUCTION,” which is hereby incorporated by reference in its entirety as if it were fully set forth herein.

This application is related to Bolton et al., U.S. patent application Ser. No. 17/100,498 (attorney docket number BCC-016), filed Nov. 20, 2020, entitled, “METHOD AND SYSTEM FOR LAYERED WOOD PRODUCT PRODUCTION,” which is hereby incorporated by reference in its entirety as if it were fully set forth herein.

### BACKGROUND

There are numerous classes and types of wood products for use in a virtually limitless variety of applications. Wood product types include but are not limited to raw wood products such as logs, debarked blocks, green or dry veneer, and dimensional lumber; intermediate wood components, such as wood I-beam flanges and webs; and layered wood products such as laminated beams, plywood panels, Engineered Wood Products (EWP), Parallel Laminated Veneer (PLV) products, and Laminated Veneer Lumber (LVL) products.

Layered wood products such as EWP, plywood, PLV, and LVL are composite products constructed in a factory from both natural wood and one or more chemically blended glues or resins. They are manufactured on a product assembly line, typically called a “layup line,” where they are fabricated from multiple layers of thin wood, e.g., full veneer sheets, veneer portions, partial veneer sheets, and veneer strips (as discussed below), assembled with one or more layers of adhesives bonding the layers together.

Herein the term “full veneer sheet” includes a continuous sheet of veneer of a defined width “Wf” and a defined length “Lf.” Width “WF” can be any width desired or needed for processing. As a specific illustrative example, in various embodiments, the defined width “Wf” can be 49 to 54 inches, with 54 inches being the ideal average value of width “Wf” In the wood products industry full veneer sheets, both green and dried, are commonly called 54's because 54 inches is an average width “Wf” of a full veneer sheet. Length “Lf” can be any length desired or needed for processing. In various embodiments, the defined length “Lf” can be 97 to 102 inches, with 102 inches being the preferred average value for “Lf.”

Full veneer sheets are typically used for outer layers and/or inner layers of a layered wood product and define the dimensions, i.e., length and width, of the layered wood product panels being created. Therefore, it is critical that the length “Lf” and width “Wf” of the full veneer sheets be consistent for each full veneer sheet.

Any veneer narrower in width than the typical full sheet width of “49-54,” depending on company specifications, while retaining the length of a full sheet Lf, is referred to herein as a “veneer strip,” This is very important as veneer strips can be joined together by a variety of processes commonly called composing or stringing, that involves joining veneer strips with adhesives along the length “Lf” axis to produce a ribbon of continuous wood, that can then be cut into the desired full sheet width “Wf”, typically 54″.

Herein the terms “partial veneer sheet” “veneer short sheet, “and “veneer short strip” are used interchangeable and include a veneer sheet portion that has a length “Lp” that not of the defined length “Lf” of a full veneer sheet. In addition, as used herein, partial veneer sheets can also have any width “Wp” that is less than or equal to the defined full veneer sheet width “Wf” It should be noted that any veneer portion that has any length “Lp” that is not of the defined length “Lf” and a width “Wp” less than or equal to the width “Wf” of a full veneer sheet is considered a partial veneer sheet, even if each partial veneer sheet has a different length “Lp” and width “Wp” from other partial veneer sheets.

If a portion of a veneer sheet is less than full length, typically 102″, then it is not usable as a full veneer sheet, or veneer strip. In this case, these partial veneer sheets are typically stacked with a clean trimmed edge in vertical alignment in a stack as are full veneer sheets and/or veneer strips. However, these partial veneer sheet stacks are commonly sent to a large saw where they are sawn to the length dimension (typically 51″) to be used as the cross ply, or core, in plywood. This process can result in 49% waste of partial veneer sheets. While not an ideal efficiency, this 49% waste is better than 100% waste. These partial veneer sheets can also be composed to produce a continuous ribbon of core material that can then be cut into full size cross ply sheets. So instead of an individual feeding by hand, multiple individual strips, a 51″×51″ core sheet can be manually, or machine laid as a single piece of composed core. The 51″×51″ is common in the industry but may vary in dimension based on specific manufacturers criteria for core sizes.

In addition to full veneer sheets, veneer strips, and partial veneer sheets, many layered wood products include layers made up of veneer sheet portions that are not of consistent length “Lf” and/or width “Wf” These veneer sheet portions are typically used for inner cross plies of the layered wood products and are commonly referred to as “core material.” Core material can typically include partial veneer sheets, veneer strips, and/or partial veneer sheets.

Herein, the term “veneer” can be used to refer collectively, or individually, to veneer ribbon, and/or veneer sheet portions, and/or full veneer sheets, and/or veneer strips, and/or partial veneer sheets, and/or any other veneer core material.

Layered wood products are sometimes referred to as “man-made” but are more commonly referred to as “Engineered Wood Products,” (EWP). Layered wood products offer several advantages over typical milled lumber. For instance, since layered wood products are fabricated and assembled in a factory under controlled conditions to a set of specific product specifications, they can be made stronger, straighter, and more uniform than traditional sawn lumber. In addition, due to their composite nature, layered wood products are much less likely to warp, twist, bow, or shrink than traditional sawn lumber. Many layered wood products also benefit from the multiple grain orientations of the layers and typically can also have a higher allowable stress than a comparable milled lumber product. However, as discussed below, to achieve this potential it is often critical that the veneer making up the layered wood products is inspected and graded in a consistent and accurate manner to have the correct physical characteristics such as physical dimensions, strength, consistent surface texture, and moisture content.

The use of veneer, and particularly veneer that has uniform qualities such as consistent surface texture and moisture content, allows layered wood products of various dimensions to be created without milling a board of the desired thickness or dimension from a single log or single piece of lumber. This, in turn, allows for much more efficient use of natural resources. Indeed, without the use of various layered wood technologies, the forests of the planet would have been depleted long ago simply to meet the construction needs of the ever-increasing world population. In addition, since layered wood products are fabricated in a factory under controlled specifications, layered wood products can be manufactured to virtually any dimensions desired, including dimensions such as length, width, and height well beyond dimensions that can be provided by milling from even the largest trees.

The use of veneer layers in some layered wood products can also allow for better structural integrity since any imperfections in a given veneer layer, such as a knot hole, can be mitigated by rotating and/or exchanging layers of veneer so that the imperfection is only one layer deep and is supported by layers of veneer below and above the imperfection in the layered wood product's structure. However, these advantages are again dependent on the veneer layers being accurately and consistently inspected for surface texture, strength, and moisture content and then being accurately and consistently graded and properly placed in the panel to provide consistent strength by separating defects sufficiently.

As noted, the versatility and potential increased structural integrity and uniformity of layered wood products has resulted in the wide use of these products and there is little question that layered wood products are a critical component of construction worldwide. However, the currently used methods and systems for veneer inspection, grading, and for layered wood product production are antiquated and extremely inefficient in terms of the amount and type of equipment required, the amount of factory production space required, the amount of human interaction and coordination required, and the amount of wasted and/or inefficiently used material and human resources.

One important metric that must be taken into account when grading veneer for producing and utilizing layered wood products is the surface texture of the veneer and any irregularities or uneven surfaces of the veneer. This is critical because the texture of the surfaces of the veneer can be indicative of several parameters including, but not limited to: how effectively and efficiently the wood product has been preprocessed prior to cutting the veneer; whether cutting systems used to cut the veneer are correctly adjusted and the physical condition of the components of the cutting systems; any defects or foreign material in the veneer; the quality of the veneer, and the best use for the veneer. In addition, smoothness and texture of the surfaces of the veneer are representative not only of the surface of the veneer compared to a parallel surface, but also the underlying structural composition of the wood fibers composing the veneer.

Consequently, examining and monitoring the surface texture of the veneer can be critical to determining if the processing of the veneer is being conducted under optimal conditions, if the mechanisms used to process the veneer are in optimal condition and are operating correctly, and if the veneer itself is of the desired quality for the intended use of the veneer.

As one specific illustrative example, veneer is a primary component of numerous intermediate and finished wood products. However, like most wood products, veneer can have widely varying levels of strength, quality, and finish. Therefore, when working with veneer to produce intermediate or finished layered wood products, such as plywood or LVL, it is important to determine as accurately as possible the texture of the surfaces of the veneer.

Veneer is typically created by either stripping long ribbons of veneer from a wood source, such as a peeler log, using a rotary cutting process or using plain slicing methods on source logs or wood blocks when a more pronounced grain pattern is desired.

In a typical process, an entire tree (commonly called a log) is delivered to a mill for processing. The delivered logs are either used within a few days-weeks to prevent dry out or are sprinkled with water to prevent dry out during longer term storage before use. This prevents drying and splitting of the log.

Typically, the logs, i.e., the whole trees, are fed thru a debarker which strips the bark. Then the stripped logs are sent to a block saw that cuts the stripped logs to a desired length, typically 4′-12′. These 4′ to 12′ lengths of stripped log are often called blocks.

After being processed into blocks or peeler logs, preconditioning of the blocks is begun, typically almost immediately. As part of the preconditioning process, the blocks are sent to vats or “baths” of water that often include one or more caustic chemicals, such as sodium hydroxide, which tends to soften the wood chemically. In addition, the caustic water mixture is often heated and/or the blocks/peeler logs are stream treated to soften the component fibers and reduce splintering, cracking and breakage during and after processing.

This preconditioning process is critical to veneer production to ensure the peeling, or slicing, is successful, i.e., results in an unbroken ribbon or sheet of veneer of consistent texture. However, adjusting the preconditioning process has traditionally proven difficult. This is because finding the best combination of chemical composition of the caustic water mix, temperature of the caustic water mix, and soak time for the logs in the vats of caustic water mix is extremely challenging because the diameter of the parent logs, type of wood, density of the wood, and presence of foreign materials is not a constant in any natural resource, such as trees. Consequently, the optimal combination of specific chemical composition of the caustic water mix, specific temperature of the caustic water mix, and specific soak time for optimal preconditioning can vary not only from type of wood to type of wood, but from region to region, harvesting area to harvesting area, grove to grove, harvest to harvest, harvest time/season to harvest time/season, tree to tree, and even within the same tree.

However, if the optimal combination of preconditioning parameters is not found, then the resulting preconditioned logs can be over conditioned and “mushy” resulting in bubbled and overly soft veneer sheets, typically reduced in strength and that are more likely to break, or under conditioned, resulting in hard and roughly cut veneer sheets that are more likely to splinter, crack or break.

The situation described above is made even more complicated by the fact that outer surfaces of a parent log or other wood source are generally more conditioned than the inner surfaces. Consequently, a parent log whose outer diameter wood is correctly conditioned may have inner diameter wood that is under conditioned or not conditioned at all. Likewise, in order to ensure inner diameter wood is correctly conditioned, the outer diameter wood may become over conditioned.

The majority of veneer that is produced today, i.e., hardwood, decorative veneers, face and back veneers, inner plies for LVL veneer cores, and pine or fir veneers, are all typically rotary cut.

FIG. 1 shows a preconditioned wood source, in this example a peeler log 101, being processed into veneer ribbon using rotary cutting methods. When using the rotary cut method, the entire preconditioned peeler log 101 is held in place in a lathe system 100 with the help of a lathe chuck 105. Some lathes use one or more computerized methods to determine the true center of the log in order to optimize the yield (not shown). The rotation speed of the preconditioned peeler log 101 log is typically controlled and variable.

After optimally positioning the preconditioned peeler log 101, it is rotated in direction 103 against a carriage-mounted knife 110 on one side and a pressure bar 111 on the opposite side to cut veneer ribbons 120 of consistent thickness 121. The first few feet of veneer that are obtained when the preconditioned log is rotated may produce sheets of varying lengths. This is called “round-up”. They can be used for different applications or may even be discarded

Ideally, the rotating preconditioned peeler log 101 can start producing quality veneer ribbons 120 akin to cloth being pulled from a bolt. These veneer ribbons 120 are then fed into a clipping line (not shown) to obtain predetermined widths and to remove defects that include rotten areas, large knots, foreign objects, etc. Thereafter, the veneer sheets (not shown) are fed into a dryer (not shown) to reduce the moisture to a level acceptable for the purposed use of the veneer sheets.

In order to produce quality veneer ribbons 120, several processing parameters must be optimized in addition to the preconditioning parameters discussed above. These include but are not limited to ensuring the cutting knife 110 is relatively sharp and free from damage and defects; ensuring the knife is kept at the optimal angle 131 with respect to the preconditioned peeling log surface 107; ensuring the pressure applied by pressure bar 111 keeps the knife 110 in steady contact with the preconditioned peeling log surface 107.

As seen above, in order for high quality veneer to be successfully produced, it is important that the wood source, such as peeler logs, be properly preconditioned using optimally adjusted precondition parameters such as the chemical composition of the soaking water, the temperature of the soaking water, and the soak time. In addition, it is equally important that the processing parameters such as ensuring the cutting knife is relatively sharp and free from damage and defects, ensuring the knife is kept the optimal angle with respect to the preconditioned peeling log surface, ensuring the pressure applied by a pressure bar keeps the knife in steady contact with the preconditioned peeling log surface must be optimized as the veneer is being cut from the wood source. The preconditioning parameters and processing parameters discussed above are referred to collectively herein as production parameters.

It follows that monitoring the variables/parameters associated with log preconditioning and processing is critical to the veneer making process. However, traditionally, this has proven very difficult for several reasons. First, as discussed above, finding the best combination of chemical composition of the caustic water mix, temperature of the caustic water mix, and soak time for the logs in the vats of caustic water mix for preconditioning is extremely complicated and challenging, not only because of the varying physical parameters of the individual blocks/peeler logs, but ambient temperature and relative humidity fluctuations as well.

However, determining whether the preconditioning processing of parent logs is effective can, in theory be determined by analyzing the texture of the veneer produced from the log. Traditionally, this was accomplished by examining the surfaces of the veneer ribbons or sheets under magnification after a parent log, or multiple logs, were fully processed into veneer ribbon.

It is known that under magnification, veneer created from wood source preconditioned using different preconditioning parameters, e.g., from over conditioned logs, from optimally conditioned logs, and from under conditioned logs has a different surface texture that can be identified under magnified conditions using visible light.

FIG. 2A shows a side view of a magnified surface 203 of veneer 201 that was produced from an optimally preconditioned log. In the specific illustrative example of FIG. 2A, the veneer thickness 205 is approximately 0.166 inches and the magnification level is 10×

As seen in FIG. 2A, magnified surface 203 of veneer 201 is relatively consistent in grain and texture down the entire magnified surface 203 of veneer 201 and has no cracks, bulges or bubbles, or sections of significantly uneven grain or width.

FIG. 2B is a representation of a magnified surface 213 of veneer 211 that was produced from an over preconditioned wood source.

As seen in FIG. 2B, due to the over conditioning of the wood source used to generate veneer 211, magnified surface 213 includes bubbles 215. Typically bubbles 215 result in veneer 211 having a “mushy” consistency. Bubbles 215 are typically formed of pulled wood fiber. When sheets of veneer are utilized that are cut from veneer ribbon from over conditioned wood sources, such as veneer 211, and the veneer sheets are stacked, the fibers making up bubbles 215 can be compressed back to relatively flat. However, the structural strength is not regained and this, in turn, results in a degraded strength and inferior texture for veneer 211 and any wood products created with veneer 211.

FIG. 2C shows the magnified surface 223 of veneer 221 that was produced from an under preconditioned wood source.

As seen in FIG. 2C, due to the under conditioning of the wood source used to generate veneer 221, magnified surface 223 includes rips/tears 225. Rips/tears 225 are the result of the veneer 221 being cut from too dry and hard a wood source due to insufficient preconditioning of the wood source, such as a peeler log. This, in turn, results in degraded strength and inferior texture for veneer 221. The magnification level in FIG. 2C is approximately 10×.

Similarly, non-optimal processing parameters such as, uneven knife edges, a dull knife, and uneven knife pressure also results in visual imperfections that can be identified under magnified conditions using visible light.

FIG. 2D shows the magnified surface 233 of veneer 231 that was produced using a damaged knife having one or more nicks or other knife edge damage.

As seen in FIG. 2D, due to the damaged knife edge used to generate veneer 231, magnified surface 233 includes repeating scratches 235. Scratches 235 are the result of the damage/imperfection in the edge of the knife used to produce veneer 231 This, in turn, results in inferior texture for surface 233 of veneer 231.

FIG. 2E is an illustrated representation the magnified surface 243 of veneer 241, as seen from a side view, that was produced using a knife that was not kept at a constant pressure against the surface of the wood source, such as a preconditioned peeling log.

As seen in FIG. 2E, magnified surface 243 of veneer 241 is uneven and “wavy” and includes curvatures 242 due the fact that veneer 241 was produced using a knife that was not kept at a constant pressure against the surface of the wood source. This wavy nature of the magnified surface 243 of veneer 241 creates stress points at each curvature. It is these stress points that often cause a veneer ribbon such as veneer 241 to break as it is flexed in downstream processing, for instance when being processed in a layup line to produce layered wood products such as layered wood product panels.

FIG. 2F shows a magnified side view of a surface 253 of veneer 251 that was produced using a knife that was dull, as seen in side view.

As seen in FIG. 2F, due to the dull knife edge used to generate veneer 251, magnified surface 253 is irregular and includes irregularities or bumps 255. Bumps 255 are the result of the fact that a dull knife tends to move away from or ride over the block/peeler log when hard spots, i.e., areas of high density in the peeler log, are encountered. This produces veneer 251 that, as shown in FIG. 2F can vary in thickness and surface flatness. In contrast, a sharp knife would shear the hard wood smoothly without being pushed back.

As noted, traditionally the effects of improper conditioning and damaged or incorrectly adjusted cutting mechanisms were identified by magnifying the surface of the veneer and then examining the magnified surface. Given the processing and production line speeds for layered wood product production, such as layup lines used to produce layered wood products such as layered wood product panels, this visual examination of the magnified veneer surface was done offline, and typically after an entire log, group of logs, or multiple sheets of veneer had been processed. In addition, since the samples needed to be magnified using traditional visual light-based systems, the sample sizes had to be relatively small, on the order of a few inches by a few inches, and were taken relatively infrequently, such as every few feet or more of veneer.

Consequently, using traditional methods, a defect in the preconditioning or cutting mechanisms, i.e., non-optimized production parameters, was often only discovered after significant amounts of defective product, such as layered wood product panels, were produced. The result was that large amounts of inferior or unusable product, such as layered wood product panels, was often processed and produced before any problem was detected. This is neither an ideal situation for the producer of the layered wood products or the end customer who inevitably must pay a higher price to take into account these inefficiencies. As discussed in more detail below, this also represents an extremely unfortunate waste of natural and human resources.

As noted, traditionally the effects of improper conditioning and/or damaged or incorrectly adjusted cutting mechanisms using visual examination of the magnified veneer surface was done offline, and typically after an entire log, group of logs, or multiple ribbons of veneer had been processed. This is because the traditional methods rely on examination of the veneer surfaces using visible light and visible light is problematic for several reasons.

Frist, visible light represents the spectrum of frequencies extending from 430 to 7100 Terahertz (Thz) which equates relatively large wavelengths extending 380 to 740 nanometers (nm). Consequently, the detail that can be discerned at these relatively large wavelengths is less than that that could be discerned using electromagnetic energy of smaller wavelengths. Consequently, using visible light sources, only the most significant surface features can be detected with the naked eye.

Therefore, surface areas being examined using visible light methods must be magnified. Since the images must be magnified using traditional visible light techniques, the veneer surface must be analyzed in smaller sections and cannot be accomplished easily, or often at all, at the speeds of a typical production line. Therefore, the analysis must be conducted offline, or the production line would have to be slowed to an unacceptable speed.

In addition, visible light is subject to interference and dilution by the background light and ambient light sources that must be present on any production line to maintain a safe workplace. Consequently, the surface areas must be magnified, and the evaluation must be conducted offline and away from background ambient light sources present on the production line.

While veneer is discussed above as an illustrative example, accurately examining surface texture is important for any wood product, and especially for those wood products used as layers or that are composed of layers, i.e., layered wood products. This is because the presence of a rougher than optimal surfaces of veneer products can determine what uses the wood product can be put to and if the finished or intermediate wood product will remain structurally sound during and after processing. As a specific illustrative example, the texture of the surface of a wood product to be used as a layer in a finished or intermediate wood product can be critical in determining what type, and how much, adhesive should be used in processing the wood product and other processing parameters used in a layered wood product production layup line.

The presence of irregular surfaces in layered sheets can create serious problems, such as cracks or other defects, in the layered wood product. This, of course, results in compromised structural integrity of the layered wood product and/or undesirable imperfections in the appearance of the layered wood product.

In addition, layered wood products, such as plywood, EWP, PLV, and LVL are made of thin layers of veneer. Typically, the veneer is obtained manually from stacks or bins of veneer such as full veneer sheets, and stacks of core material including veneer strips, and/or partial veneer sheets. In theory, the veneer making up each of the stacks or bins of veneer should be of the same grade. However, using current methods, the stacks of full veneer sheets and/or core material are typically graded by human workers visually/manually and then stacked, in theory, according to grade by the same human workers. Indeed, using currently available methods and systems, not only are the veneer stacks created by manual operations, but the workers are also typically tasked with visually and manually grading the full veneer sheets and/or veneer strips and/or partial veneer sheets as the veneer stacks are created. This use of human workers to simultaneously grade and stack veneer represents a weak link in the production chain that often results in virtually ungraded veneer, poorly stacked veneer, wasted, or inefficiently used materials, safety issues, repetitive motion injuries, and worker fatigue/burnout.

To address this problem some layered wood product production systems could, in theory benefit from the use of prior art visible light systems for identifying surface irregularities to consistently grade veneer. However, as discussed above, prior art visible light systems for identifying these surface irregularities to grade veneer are often ineffective and inefficient for use with layered wood product production systems for at least the reasons discussed above. Consequently, as discussed above, even if prior art prior art visible light systems, were used, the results would be inconsistent and inaccurate and therefore the consistency of the veneer stacks would still be unacceptable.

As a result, using prior art methods and systems for producing layered wood products, the quality of veneer fed into process is often not efficiently and effectively inspected and graded during the veneer stacking operation. Therefore, undetected defects can cause products created using the veneer to be rejected downstream after significant time and energy has already been devoted to the panels, e.g., the veneer is processed into layered wood product on a layup line and pressing is complete and panel quality is analyzed. This is extremely problematic since, as discussed below, the processing of layered wood products is highly resource and labor intensive.

As noted, layered wood products, such as plywood, PLV, and LVL are made of thin layers of veneer. In the case of plywood, in addition to full veneer sheets, layers of “core material” that can include veneer sheet potions, and/or veneer stirps, and/or partial sheets, are placed such as to rotate the grain approximately 90 degrees from the full veneer sheets above and below. As noted, these full veneer sheets and core material, such as veneer sheet potions, and/or veneer stirps, and/or partial sheets, are obtained from stacks or bins of veneer that, in theory, should have been inspected and consistently graded.

In the example of plywood, the alternating layers of oriented grain material increase the structural rigidity of the panel. Typically, a first full veneer sheet is obtained from a first full veneer sheet stack of the appropriate grade and one side (top) of the first full veneer sheet is coated with an adhesive, e.g., glue, and then a layer of core material made up of include veneer sheet potions, and/or veneer stirps, and/or partial sheets, is manually obtained from a veneer core stack/bin of the appropriate grade and is placed on the first full veneer sheet. Glue is then applied to the layer of core material and a second full veneer sheet is obtained from a full veneer sheet stack of the appropriate grade and is applied to the layer of core material. The resulting three-ply structure made up of a first full veneer sheet (the first ply), glue, a layer of core material (the second ply), glue, and a second full veneer sheet (the third ply) is referred to as a three-ply “green” panel, with each individual layer of construction, e.g., full veneer sheets, or core material layer, within the panel commonly referred to as a “ply”. Typically, plywood panels are made up of multiple plys with three to eleven plys or more being common. Once the green panel is created, there remain additional processes that are required to transform the green panel into a cured, or finished, panel. Typically, the first process downstream is to “pre-press” the green panel product. This is typically performed on a stack of green panels with 12-40 panel stacks being common. The typical pre-press is a single opening press into which the entire stack of green panels is conveyed. The press closes, pressing the green panels between an upper and lower rigid surface. This pressing or “compaction” process is at ambient temperature and ensures all the air gaps between plys in each green panel are eliminated and a quality glue to wood contact is formed throughout the panel. After this pre-pressing action is completed, the resulting “pre-pressed panel” has increased rigidity and the stack of panels is ready for the next process, “Hot Pressing”.

The stack of pre-pressed green panels is then conveyed into an unstacking mechanism at the hot press. This mechanism sequentially loads a single pre-pressed green panel from the stack into individual separate heating chambers in the hot press. Essentially sandwiching each pre-pressed green panel between two heated metal plates, commonly referred to as heating platens. When each of the individual heating chambers “Platens” have a pre-pressed green panel loaded, the press closes applying pressure and heat to the pre-pressed green panel. The combination of heat and pressure cures the glue and creates a rigid “cured” panel. In this way a continuous material assembly and processing routine is created.

The production of PLV is similar to plywood production except that cross plies of core material made up of veneer strips and/or partial veneer sheets is typically not used so that each layer, e.g., ply, of PLV is a full veneer sheet. In this process, a first full veneer sheet is obtained from a first veneer stack of the appropriate grade and one side (top) of the first full veneer sheet is coated with an adhesive, e.g., glue. Then a second full veneer sheet is obtained from a second veneer stack of the appropriate grade and glue is applied to the second full veneer sheet. A third full veneer sheet is obtained from a third veneer stack of the appropriate grade and is applied to the second full veneer sheet. This process is repeated until the desired number of full veneer sheets, e.g., plys, is achieved. The resulting multiple full veneer sheet ply structure is called a PLV panel. As with plywood production, the resulting PLV panel is still a green panel, that must be “pre-pressed” to flatten out the veneer layer components and create the wood to glue bond, and then cured using a “hot press” where both pressure and heat are applied to cure the glue and create a cured panel. As with the plywood example discussed above, multiple green panels are produced, stacked, and sent to the pre-press. Then these pre-pressed panel stacks are sent to the hot press. In this way a continuous material assembly and processing routine is created.

Prior art layered wood product assembly methods and systems typically use a conveyor to move material progressively past multiple feeder stations where human workers obtain full veneer sheets and core material from veneer stacks. At the various feeder stations successive layers of full veneer sheets are obtained from full veneer sheet stacks, glue, and core material (if required) are obtained from core stacks veneer sheet potions, and/or veneer stirps, and/or partial sheets, to build a panel of a desired number of plys. This system of conveyor, feeder stations, glue applicators, etc. is commonly referred to as a “layup line.” When the multi-ply panel reaches the end of the layup line, it is discharged to form “green panel stack.”

From the layup line the green panel stacks are conveyed, typically by a second conveying system, to a pressing area and pressing stations. Typical plants utilize multiple press lines with two press lines being commonly used for small plants and up to eight press lines in large plants.

As discussed above, in the pressing area, the green veneer panel stacks are conveyed to a single opening pre-press machine center typically utilizing upper and lower platens positioned by mechanical or hydraulic rams to compact the green panel stack, eliminating air between layers of wood, and promoting an even spread of the glue between layers of veneer. After pre-pressing, the now pre-pressed layered wood product stacks are conveyed into an unstacking mechanism which feeds one pre-pressed layered wood product panel at a time from the stack into a multi-opening hot press. Typically, hot presses contain between 12 and 40 individual openings, each of which can process one pre-pressed layered wood product panel. When the hot press is loaded with panels, mechanical or hydraulic systems close the press and heat is applied to cure the glue. It is this combination of heat and pressure that causes the full veneer sheets and/or partial veneer sheets to bond and become cured plywood, PLV, or LVL panels.

The process described above is extremely complicated, material intensive, labor intensive, time consuming, involves literally hundreds of moving parts, and requires significant factory floor space and a significant number of human operators. FIGS. 3A through 3H are various representations of prior art layered wood product methods and systems. For simplicity, the prior art layered wood product methods and systems shown in FIGS. 3A through 3H are associated with the production of traditional plywood products. However, as discussed above, other layered wood product methods and systems are similar except that where a layer of core material is laid down in a traditional plywood product assembly line, for other layered wood products all layers would be veneer sheets. Consequently, with this one exception, in actual practice the same prior art equipment and methods shown in FIGS. 3A through 3H are used for all layered wood products.

FIG. 3A is a diagram representing traditional layered wood product panel assembly layup station 340A. As seen in FIG. 3A traditional layered wood product panel assembly layup station 340A includes traditional panel conveyor 301, which, as discussed later, is a conveyor system that in many cases extends one hundred feet or more, and in some cases three hundred feet or more.

The process of creating a traditional layered wood product panel begins at sheet feeder operator position 321A with a sheet feeder operator SFO1 using a vacuum conveyor 305 of sheet feeder station 302A to move a sheet of veneer 307A from veneer stack 303A to traditional panel conveyor 301. Sheet of veneer 307A then moves via traditional panel conveyor 301 down to first glue applicator 309A. At first glue applicator 309A a layer of glue is applied to a first side of sheet of veneer 307A. Of note is the fact that the amount of glue applied by glue applicator 309A is determined by the flow of glue through glue applicator 309A and the speed of traditional panel conveyor 301. The result is that using prior art methods and systems only a very coarse adjustment can be made to the amount of glue applied by glue applicators such as glue applicator 309A. In addition, if for any reason the speed of traditional panel conveyor 301 changes without a resulting adjustment to the flow of glue through the glue applicators, the result is that too much or too little glue is applied. As discussed below, this, in turn, can adversely affect the quality of the resulting plywood panels.

After glue is applied at glue applicator 309A, the structure is conveyed by traditional panel conveyor 301 to the core feeder station 323A and core stack 313A. At core stack 313A, a core placement operator CO1 places a portion of core material onto the assembly. The assembly 315A then proceeds to a second glue applicator 309B. As seen in FIG. 3A, at this point in the traditional process, even before an entire three-ply panel is created, two distinct glue applicators and at least two people are required.

Traditional layered wood product panel assembly layup station 340A is of significant size, has many moving parts, and is both complicated and potentially hazardous to operate. In addition, due to the rather large area and set up of traditional layered wood product panel assembly layup station 340A, significant waste products and debris are created that must be removed periodically. This, unfortunately requires the entire line be stopped, as discussed below.

FIG. 3B is a diagram representing a side view of the formation of a three-ply plywood panel being created using a traditional layered wood product panel assembly layup station 340A. As seen in FIG. 3B, at veneer layer sheet feeder operator position 321A, SFO1 uses sheet feeder station 302A, to place sheet of veneer 307A on traditional panel conveyor 301. Sheet of veneer 307A then moves along traditional panel conveyor 301 to glue applicator 309A where a layer of glue is applied. Then the structure moves along traditional panel conveyor 301 to core feeder station 323A where CO1 places core material to create a core layer and structure 315A. The structure 315A then moves along traditional panel conveyor 301 to second glue applicator 309B where a layer of glue is applied. Then at veneer layer sheet feeder operator position 321B a second sheet feeder operator SFO2 uses sheet feeder station 302B to place second sheet of veneer on structure 315A to create structure 307B. At this point, structure 307B represents a single three-ply plywood panel.

As noted, FIG. 3B is a representation of the creation of a single three-ply plywood panel structure using prior art methods. However, as noted above, in many cases a plywood panel includes even more plys, often eight or more.

Consequently, for each three plys, structures similar to that shown in FIGS. 3A and 3B, must be linked together along a very long traditional panel conveyor 301 to create a traditional layered wood product panel assembly layup line including, in practice, layup sheet feeder stations, glue application stations, and core feeder stations cumulatively represented as detailed in 340A. FIG. 3C is a diagram representing a traditional layered wood product panel assembly layup line 350 including five traditional layered wood product panel assembly layup stations 340A through 340E for creating a single plywood panel structure of up to eleven plys, or a plywood structure of a fewer number of plys, or multiple plywood panels structures of a fewer number of plys. As noted above, many plywood and other layered wood products, include a minimum of 3 plys and eleven or more plys is not uncommon. However, for simplicity of discussion, the illustrative example of a layup line 350 is shown with only five traditional layered wood product panel assembly layup stations 340A through 340E and therefore would produce, at most, an eleven-ply panel. In addition, as discussed in more detail below, by deactivating selected components making up traditional layered wood product panel assembly layup line 350, traditional layered wood product panel assembly layup line 350 could be used to create a plywood structure of a fewer number of plys, or multiple plywood panels structures of a fewer number of plys.

In operation, the process of creating a traditional layered wood product panel using traditional layered wood product panel assembly layup line 350 begins at sheet operator position 323A with a sheet feeder operator SFO1 using a vacuum conveyor of sheet feeder station 302A to move a sheet of veneer 307A from veneer stack 303A to traditional panel conveyor 301. Sheet of veneer 307A then moves via traditional panel conveyor 301 down to first glue applicator 309A. At first glue applicator 309A a layer of glue is applied to a top side of sheet of veneer 307A. Of note is the fact that the amount of glue applied by glue applicators 309A through 309J is determined by the flow of glue through glue applicator 309A and the speed of traditional panel conveyor 301. The result is that using prior art methods and systems only a very coarse adjustment can be made to the amount of glue applied by glue applicators such as glue applicator 309A through 309J. In addition, if for any reason the speed of traditional panel conveyor 301 changes without a resulting adjustment to the flow of glue through the glue applicators the result is that too much or too little glue is applied. As discussed below, this, in turn, can adversely affect the quality of the resulting plywood panels.

After glue is applied at glue applicator 309A, the structure is conveyed by traditional panel conveyor 301 to the core feeder station 323A and core stack 313A. At core stack 313A, a first core placement operator CO1 places a portion of core material onto the assembly. The resulting structure 315A then moves along traditional panel conveyor 301 to second glue applicator 309B where a layer of glue is applied. Then at veneer layer sheet feeder operator position 321B a second sheet feeder operator SFO2 uses sheet feeder station 302B, to place a second sheet of veneer from veneer stack 303B on structure 315A to create structure 307B. At this point, structure 307B represents a three-ply plywood panel structure.

Referring to FIG. 3C, it is worth noting that if only a three-ply wood product panel is desired, then third glue applicator 309C and fourth glue applicator 309D would be deactivated along with core feeder station 323B. However, if a five ply or greater panel structure is desired, structure 307B then moves along traditional panel conveyor 301 to third glue applicator 309C where a layer of glue is applied. Then the structure moves along traditional panel conveyor 301 to core feeder station 323B and core stack 313B where a second core operator CO2 places core material on structure 307B to create a core layer. The resulting structure 315B then moves along traditional panel conveyor 301 to fourth glue applicator 309D where a layer of glue is applied. Then at veneer layer sheet feeder operator position 321C a third sheet feeder operator SFO3 uses sheet feeder station 302C to place a third sheet of veneer from veneer stack 303C on structure 315B to create structure 307C. At this point, structure 307C represents a five-ply plywood panel structure.

Referring to FIG. 3C, it is again worth noting that if only a five-ply wood product panel is desired, then fifth glue applicator 309E and sixth glue applicator 309F would be deactivated along with core feeder station 323C. However, if a six ply or more structure is desired, structure 307C then moves along traditional panel conveyor 301 to fifth glue applicator 309E where a layer of glue is applied. Then the structure moves along traditional panel conveyor 301 to core feeder station 323C where a third core operator CO3 places core material from core stack 313C on the structure to create a core layer. The resulting structure 315C then moves along traditional panel conveyor 301 to sixth glue applicator 309F where a layer of glue is applied. Then at veneer layer sheet feeder operator position 321D a fourth sheet feeder operator SFO4 uses sheet feeder station 302D to place a fourth sheet of veneer from veneer stack 303D on structure 315C to create structure 307D. At this point, structure 307D represents a seven-ply plywood panel structure.

Referring to FIG. 3C, it is again worth noting that if only a seven-ply wood product panel is desired, then seventh glue applicator 309G and eighth glue applicator 309H would be deactivated along with core feeder station 323D. However, if an eight-ply or more structure is desired, structure 307D then moves along traditional panel conveyor 301 to seventh glue applicator 309G where a layer of glue is applied. Then the structure moves along traditional panel conveyor 301 to core feeder station 323D where a fourth core operator CO4 places core material from core stack 313D on the structure to create a core layer. The resulting structure 315D then moves along traditional panel conveyor 301 to eighth glue applicator 309H where a layer of glue is applied. Then at veneer layer sheet feeder operator position 321E a fifth sheet feeder operator SFO5 uses sheet feeder station 302E, to place a fifth sheet of veneer from veneer stack 303E on structure 315D to create structure 307E. At this point, structure 307E represents a nine-ply plywood panel structure.

Referring to FIG. 3C, it is again worth noting that if only a nine-ply wood product panel is desired, then ninth glue applicator 309I and tenth glue applicator 309J would be deactivated along with core feeder station 323E and veneer layer sheet feeder operator position 321E. However, if a nine-ply or more structure is desired, structure 307E then moves along traditional panel conveyor 301 to ninth glue applicator 309I where a layer of glue is applied. Then the structure moves along traditional panel conveyor 301 to core feeder station 323E and core pile 313E where a fifth core operator CO5 places core material from core stack 313E on the structure to create a core layer. The resulting structure 315E then moves along traditional panel conveyor 301 to tenth glue applicator 3091 where a layer of glue is applied. Then at veneer layer sheet feeder operator position 321E a sixth sheet feeder operator SFO6 uses sheet feeder station 302F to place a sixth sheet of veneer from veneer stack 303F on structure 315E to create green panel structure 307F. At this point, structure 307F represents an eleven-ply plywood panel structure.

As seen above, by activating or deactivating various glue applicators, core feeding stations, and/or veneer layer sheet feeder operator positions, traditional layered wood product panel assembly layup line 350, including five traditional layered wood product panel assembly layup stations 340A through 340E, can be used for creating a single plywood panel structure of up to eleven plys, or a plywood structure of a fewer number of plys, or multiple plywood panels structures of a fewer number of plys. However, this requires significant coordination and tracking of complicated components and represents one of numerous opportunities to introduce mechanical and/or human error into these prior art systems and methods as discussed above and depicted in FIG. 3C.

Green panel structure 307F is then moved by traditional panel conveyor 301 to stacker 324 and stacker operator SO. At stacker 324 multiple green panel structures, such as green panel structure 307F, are stacked into green panel stacks 360 for conveyance to the press area of FIG. 3D discussed below. In many cases, green panel stacks 360 can include forty or more individual green panel structures, such as green panel structure 307F. Consequently, each stack 360 represents a significant investment of resources.

As seen above, traditional layered wood product panel assembly layup line 350 is a very space intensive structure that extends hundreds of feet. Therefore, traditional layered wood product panel assembly layup line 350 is expensive in terms of factory floor footprint alone. In addition, the size of traditional layered wood product panel assembly layup line 350 also means that housekeeping requirements are continuous and extensive to prevent these large portions of the factory floor from becoming covered with debris, i.e., glue and wood particles. to keep the machinery running and ensure a safe working environment. As noted above, this typically requires continuous housekeeping in the areas safely accessible during operation, and for those areas where moving equipment is located, the entire traditional layered wood product panel assembly layup line 350 has to be shut down to perform housekeeping.

These are significant costs to maintain an acceptable clean and safe working environment. However, the cost of traditional layered wood product panel assembly layup line 350 is even more evident in the number of moving parts and personnel required to operate traditional layered wood product panel assembly layup line 350. For the eleven-ply layup line shown in traditional layered wood product panel assembly layup line 350 there must be a minimum of: a hundred foot or more traditional panel conveyor; six automated sheet feeder stations, six veneer stacks, and six sheet feeder operators; five core stacks and five core operators; ten glue applicators; a stacker and stacker operator; several forklift and stack replenishing operators; and multiple motors and control and communication systems. This requires thousands of moving parts and sensors, and at least twelve people, all of which must function accurately, safely, and in close coordination. This is a huge maintenance effort and a huge cost in terms of investment of man-hours. In addition, as discussed below, when there is a glitch in any of the thousands of moving parts, or there is any human error generated by the numerous human workers, often the entire line must be stopped, or at a minimum there is product degradation, or both. Not only is this inefficient, in and of itself in terms of time, but the increased time period between the glue application and the time when the panel is pressed impacts the glue bonding ability. Consequently, when the line is stopped for any error, or any reason, for more than a short interval, product quality is impacted, and longer intervals often results in large amounts of product waste.

In addition, while the reader can easily recognize the use and maintenance of traditional layered wood product panel assembly layup line 350 is significant, traditional layered wood product panel assembly layup line 350 is only an eleven-ply assembly layup line. Therefore, larger installations are proportionately more complicated, have proportionately more moving parts, and require proportionately more human operators.

The resultant product of traditional layered wood product panel assembly layup line 350 are green panel stacks 360 of multiple green panel structures such as green panel structure 307F. Like all green panels, these structures must be pressed and cured to create finished layered wood products. This process involves moving green panel stacks 360 to one or more press lines where each stack is first pre-pressed in a cold press to flatten the composite green panel structures and then to a hot press where individual pre pressed panels are subjected to pressure and heat to cure the glue and yield finished layered wood panels.

FIG. 3D is a diagram representing a traditional layered wood product panel assembly layup and press line 351 including traditional layered wood product panel assembly layup line 350 of FIG. 3C, stack press delivery line 362, and four pressing stations 353 through 359.

As seen in FIG. 3D, traditional layered wood product panel assembly layup and press line 351 includes stack production and processing section 399. Stack production and processing section 399 includes traditional layered wood product panel assembly layup line 350 and stack press delivery line 362 that is a conveyor moving multiple green panel stacks 360 to pressing stations 353 through 359.

As seen in FIG. 3D, stack press delivery line 362 conveys green panel stacks 360 to pressing stations 353 through 359 in a continuous movement and individual green panel stacks 360 are positioned in each press line. In FIG. 3D these include green panel stack 360A to press line 353, green panel stack 360B to press line 355, green panel stack 360C to press line 357, and green panel stack 360D to press line 359. In practice, the number of press lines can be fewer or more than the four shown in FIG. 3D. It is important to note that stack press delivery line 362 continues to convey green panel stacks 360 to pressing stations 353 through 359 as green panel stacks 360A through 360D are being processed at pressing stations 353 through 359, respectively.

As seen in FIG. 3D, green panel stacks 360A through 360D are processed at pressing stations 353 through 359, respectively, by press operators PO1, PO2, PO3, and PO4, respectively. Green panel stacks 360A through 360D are first loaded into pre-presses 370A, 370B, 370C, and 370D, respectively, where the green panel stacks 360A through 360D are subjected to cold pre-pressing. In the cold pre-presses 370A, 370B, 370C, and 370D, green panel stacks 360A through 360D are pressed to flatten out the structures and force out any air pockets that may exist in the green panel stacks 360A through 360D.

It is important to note that each of cold pre-presses 370A, 370B, 370C, and 370D can, in some instances, be capable of processing green panel stacks 360 of different sizes, i.e., of differing numbers of green layered wood structure panels. This is an important factor because it can require significant coordination between the stacker operator SO and each of the press operators PO1, PO2, PO3, and PO4. Otherwise, the wrong size green panel stack could be loaded into a cold press that is unable to process it.

The resulting pre-pressed stacks 361A, 361B, 361C, and 361D are conveyed into an unstacking mechanism which feeds one layered wood structure panel at a time from the pre-pressed stacks 361A, 361B, 361C, and 361D into slots of one or more multi-opening hot presses 380A, 380B. 380C, and 380D, respectively. At hot presses 380A, 380B. 380C, and 380D the layered wood structure panels making up pre-pressed stacks 361A, 361B, 361C, and 361D are subjected to pressure and heat to compress and cure the layered wood structure panels making up pre-pressed stacks 361A, 361B, 361C, and 361D. Then the layered wood structure panels are re-stacked resulting in cured layered wood panel product stacks 363A, 363B, 363C, and 363D, respectively.

It is important to note that, like each of cold pre-presses 370A, 370B, 370C, and 370D, each of hot presses 380A, 380B, 380C, and 380D can, in some instances, be capable of processing pre-pressed stacks 361A, 361B, 361C, and 361D of different sizes, i.e., of differing numbers of layered wood product panels. This is an important factor because it also can require significant coordination between the stacker operator SO and each of the press operators PO1, PO2, PO3, and PO4. Otherwise, the wrong size stack could be loaded into a hot press that is unable to process it. Some hot presses can handle pre-pressed stacks of up to forty or more layered wood structure panels.

Cured layered wood panel product stacks 363A, 363B, 363C, and 363D are then conveyed to panel trim, quality analysis, and shipping area 311 where the individual layered wood panels making up cured layered wood panel product stacks 363A, 363B, 363C, and 363D are trimmed to size, subjected to quality control analysis, and then shipped to customers.

In addition to the cost of operating traditional layered wood product panel assembly layup and press line 351, including stack production and processing section 399, i.e., traditional layered wood product panel assembly layup line 350 and stack press delivery line 362, there is a significant cost associated with any delays in traditional layered wood product panel assembly layup and press line 351 and/or pressing stations 353 through 359 which, in the prior art, are commonly fed by traditional layered wood product panel assembly layup line 350. These delays include delays due to failure of any of the thousands of moving parts associated with traditional layered wood product panel assembly layup and press line 351, and particularly stack production and processing section 399, or any human error introduced by the twelve or more people required to operate traditional layered wood product panel assembly layup and press line 351.

Referring to FIG. 3C, when a delay occurs, for whatever reason, the layers of glue applied by glue applicators 309A through 309J may dry out before the green panel stacks 360 reach the pressing stations 353 through 359. This, in turn, results in layered wood product panels that can separate or otherwise fail because the glue could not cure and adhere the layers properly. Unfortunately, this results in significant loss of product using traditional layered wood product panel assembly layup and press line 351. Currently there is an average loss of product to defects of ten percent or more using traditional layered wood product panel assembly layup and press line 351.

As shown above, prior art methods and systems for producing layered wood products suffer from several serious drawbacks. As noted, prior art systems for producing layered wood products are of large physical size, e.g., hundreds of feet, and therefore require substantial factory floor space.

In addition, as can be seen above, layered wood product processing is a resource intensive endeavor. Consequently, significant time, labor, and materials are expended creating a layered wood product panel. Therefore, any defective layered wood products represent a significant waste of resources and expense. However, as noted above, using traditional methods, defective veneer is often only discovered after significant amounts of defective veneer, and the resulting defective layered wood products are produced. Consequently, using prior art methods and systems for producing layered wood products, the quality of veneer fed into process is often not efficiently and effectively inspected and graded during the veneer stacking operation. Therefore, undetected defects can cause products created using the veneer to be rejected downstream after significant time and energy has already been devoted to the panels, e.g., pressing is complete and panel quality is analyzed.

The result is that large amounts of inferior or unusable layered wood product is often processed and produced before any problem was detected. This is neither an ideal situation for the producer of the wood products or the end customer who inevitably must pay a higher price to take into account these inefficiencies. It also represents an extremely unfortunate waste of natural and human resources.

In addition, as noted, even if prior art inspection and grading systems, such as visible light-based systems, were employed, prior art inspection and grading systems can be error prone and lead to inaccurate images of veneer being taken, which can result in the system improperly grading veneer.

In addition, prior art methods and systems for producing layered wood products have thousands of moving parts and sensors. This makes prior art methods and systems for producing layered wood products extremely maintenance intensive.

In addition, prior art methods and systems for producing layered wood products, including traditional conveyor systems use a large number of electric motors with substantial power consumption during operation. This makes prior art methods and systems for producing layered wood products expensive to operate and a drain on the environment.

In addition, prior art methods and systems for producing layered wood products are manpower intensive for operation and maintenance. This makes prior art methods and systems for producing layered wood products not only expensive to operate but also subject to human error and a source of potential injury.

In addition, any failure of any one of the thousands of moving parts required by prior art methods and systems for producing layered wood products, or any human error introduced, results in the entire lay-up line and process stopping until repaired. As also noted above, these stoppages often result in substantial product waste due to glue degradation, i.e., glue dry out. In cases where product is lost to an extended stoppage, hundreds of potential layered wood product panels can be lost. As noted above, this significantly contributes to ten percent or more of potential product currently being discarded.

In addition, using prior art methods and systems for producing layered wood products, material and glue systems are configured to run a single product at a time, i.e., only a three-ply count panel, or single type of product (plywood or PLV), at a time. Changing products requires stopping the machine, removing all in process material, and then reconfiguring controls for new product construction.

In addition, using prior art methods and systems for producing layered wood products, glue spread rates are only manually adjustable and in rather large incremental steps. Consequently, it is difficult to make fine adjustments to the amount of glue applied to compensate for ambient temperature, line speed changes, etc.

In addition, using prior art methods and systems for producing layered wood products, the quality of veneer fed into process is not inspected during feeding operation. Therefore, undetected defects can cause panels to be rejected downstream after significant time and energy has already been devoted to the panels, i.e., pressing is complete and panel quality is analyzed.

In addition, using prior art methods and systems for producing layered wood products, no direct correlation is made, or can readily be made, between individual panel quality and the assembly process variables used for construction of that specific panel.

Finally, using prior art methods and systems for producing layered wood products, housekeeping, i.e., keeping the workplace clean and safe, is a challenge due to physical size, physical construction, and operational characteristics discussed above.

Consequently, prior art methods and systems for producing layered wood products are extremely expensive to operate and extremely inefficient.

What is needed is a method and system for producing layered wood products that addresses the shortcoming of prior art methods and systems for producing layered wood products discussed above and thereby provides a solution to the long standing problem of providing a method and system for producing layered wood products that is more consistent, more effective, less expensive to operate and more efficient.

### SUMMARY

Embodiments of the present disclosure provide an effective and efficient technical solution to the long standing problem of providing a method and system for producing layered wood products that is more consistent, more effective, less expensive to operate and more efficient.

In one embodiment, irregularities on the surfaces of veneer are detected using Near InfraRed (NIR) technology, including Near InfraRed/Short Wave InfraRed (NIR/SWIR) cameras and detectors. In one embodiment, a grade is then assigned to the veneer based, at least in part, on the detected irregularities. In one embodiment, the graded veneer is then stacked based, at least in part, on the grade assigned to the veneer. The graded veneer stacks are then provided to local robotic panel assembly and pressing systems that include one or more local robotic panel assembly cells for processing the veneer into layered wood product panels.

To this end, embodiments of the present disclosure utilize NIR analysis systems including Near InfraRed (NIR) technology, such as Near InfraRed/Short Wave InfraRed (NIR/SWIR) cameras and detectors, to accurately identify surface irregularities and the specific locations of the irregularities in veneer, such as veneer ribbons, full veneer sheets, veneer strips, and/or partial veneer sheets. As discussed in more detail below, in some embodiments, an irregularity level to greyscale mapping database is generated that maps surface irregularities to NIR image greyscale values for the veneer. In one embodiment, the surface irregularity level to greyscale mapping database includes mapping data obtained via controlled empirical methods.

In one embodiment, the NIR analysis system is provided as part of a veneer analysis system. In one embodiment, the NIR analysis system includes one or more sources of illumination positioned to illuminate at least one surface of the veneer. In one embodiment, the NIR analysis system includes one or more NIR/SWIR cameras, hereafter referred to as simply NIR cameras, positioned to capture one or more NIR images of the illuminated surface of the veneer.

In one embodiment, the veneer to be analyzed is positioned in, or passed through, the NIR analysis system such that a surface of the veneer to be analyzed is illuminated by the one or more illumination sources. The one or more NIR cameras are then used to capture one or more NIR images of the illuminated surface of the veneer.

In one embodiment, the one or more NIR images of the illuminated surface of the veneer are converted to NIR greyscale images with different greyscale values indicating different irregularity sizes, heights, or levels in the illuminated surface of the veneer.

In one embodiment, the greyscale values shown in the NIR greyscale images are processed using the surface irregularity level to greyscale mapping database to identify irregularity sizes, heights, or levels over the entire surface of the veneer.

In one embodiment, the veneer is then graded based on the identified irregularity levels and their positions/locations over the surface of the veneer. In one embodiment, based, at least in part, on the grade assigned to the veneer being analyzed, one or more actions are taken with respect to the veneer including, but not limited to, assigning the veneer to a specific veneer stack associated with the grade assigned to the veneer.

As discussed in more detail below, in some embodiments, one or more machine learning based surface irregularity prediction models are trained using NIR image data for one or more full veneer sheets and/or core material such as veneer strips, and/or partial veneer sheets, along with various other production parameters and corresponding empirically determined irregularity levels and product failures for the grade assigned to the veneer.

In one embodiment, an NIR analysis system is provided that includes one or more sources of illumination positioned to illuminate a surface of the veneer and one or more NIR cameras positioned to capture one or more NIR images of the illuminated surface of the veneer.

In one embodiment, the veneer to be analyzed is positioned, or passed through, the NIR analysis system such that a first surface of the veneer to be analyzed is illuminated by the one or more illumination sources.

In one embodiment, one or more NIR images of the illuminated first surface of the veneer are then captured using the one or more NIR cameras and the one or more NIR images of the illuminated first surface of the veneer are processed to generate NIR image data for the illuminated first surface of the veneer.

In one embodiment, the NIR image data for the illuminated first surface of the veneer is then provided to the one or more trained machine learning based surface irregularity prediction models and surface irregularity prediction data for the veneer is obtained from the one or more trained machine learning based surface irregularity prediction models.

In one embodiment, a grade is assigned to the veneer based on the surface irregularity prediction data for the veneer and based at least in part on the grade assigned to the veneer, one or more actions are taken with respect to the veneer including, but not limited to, assigning the veneer to a specific veneer stack associated with the grade assigned to the veneer.

In one embodiment, production parameters such as preconditioning or processing parameters, of veneer, such as a veneer ribbon, are dynamically adjusted based on a level of surface irregularity of the veneer surface.

In one embodiment, a surface irregularity level to greyscale mapping database is generated, that maps surface irregularities to Near InfraRed (NIR) image greyscale values for veneer. In this embodiment, an NIR greyscale image to preconditioning level database is also generated mapping NIR greyscale images of a surface of veneer to a preconditioning level of wood source used to produce the veneer.

In one embodiment, an NIR greyscale image to processing parameter database is generated mapping NIR greyscale images of a surface of the veneer to processing parameter values used to produce the veneer or one or more misadjusted processing parameters used to produce the veneer.

In an alternative embodiment, one or more machine learning based production adjustment models are trained using Near InfraRed (NIR) image data for veneer and determined corresponding conditioning levels of wood source, such as logs, used to produce the veneer or one or more misadjusted production parameters used to produce the veneer.

In various embodiments, an NIR analysis system is provided that includes one or more sources of illumination positioned to illuminate a surface of veneer, such as a veneer ribbon, and one or more NIR cameras positioned to capture one or more NIR images of the illuminated surface of the veneer.

In one embodiment, the veneer to be analyzed is positioned in the NIR analysis system such that a first surface of the veneer to be analyzed is illuminated by the one or more illumination sources.

In one embodiment, one or more NIR images of the illuminated first surface of the veneer are captured using the one or more NIR cameras and the one or more NIR images of the illuminated first surface of the veneer are processed to generate NIR greyscale images indicating different irregularity levels in the illuminated first surface of the veneer.

In one embodiment, the greyscale values shown in the NIR greyscale images are processed using the surface NIR greyscale image to preconditioning level database and/or the NIR greyscale image to processing parameter database to identify irregularity levels over the surface of the veneer being analyzed.

In an alternative embodiment, the NIR image data for the illuminated first surface of the veneer is provided to the one or more trained machine learning based production adjustment models and production or processing adjustment parameter prediction data for the veneer is obtained from the one or more trained machine learning based surface irregularity prediction models.

Then, based on the determined preconditioning level or processing parameter maladjustment used to produce the veneer, or the determined necessary processing parameter adjustment, and/or the production or processing adjustment parameter prediction data, one or more one or more production parameters for producing subsequent veneer are adjusted.

In various embodiments, the one or more production parameters are preconditioning parameters for subsequent wood sources used to produce subsequent veneer and include: an amount of chemical used in a preconditioning liquid used to precondition the wood source; a type of chemical used in a preconditioning liquid used to precondition the wood source; a time the wood source soaks in a preconditioning liquid used to precondition wood source; and a temperature of a preconditioning liquid used to precondition the wood source.

In various embodiments, the one or more production parameters are processing parameters adjusted for producing subsequent veneer from the wood source in relative real time and include: replacing a knife or other processing component; adjusting a rotation speed of a lath turning the wood source; adjusting an angle between a knife used to cut the veneer from the wood source; and adjusting a pressure used to keep a knife used to cut veneer from the wood source in contact with a surface of the wood source.

The disclosed embodiments utilize NIR cameras to scan the surface of veneer for irregularities and create an NIR image of the surface of the veneer. Since essentially each pixel of camera image data is a sample point, the resolution and accuracy of the surface irregularity detection process is only limited by the number of pixels the camera has covering the field of view, e.g., the entire first surface of the veneer. Consequently, in the case where a 1.3 mega pixel camera is used there are essentially 1,300,000 individual measurement points on the surface of the veneer. In addition, NIR wavelengths are in the range of 750 nanometers (nm) to 3500 nm which are much smaller that the visible wavelengths of 380 to 740 nm. Consequently, the use of NIR cameras as disclosed herein results in resolutions and accuracy that simply cannot be achieved using traditional visual irregularity detection systems.

In addition, when, as disclosed herein, NIR cameras are used as the surface irregularity detection mechanism, if greater or less resolution is deemed necessary, a higher or lower mega-pixel camera can be selected to achieve the desired resolution for the process. This can be accomplished in a relatively simple and quick camera switch out procedure. In addition, NIR camera placement with respect to the sample under analysis can be adjusted such that a quality image can be obtained as long as there is a clear field of view between the veneer surface and NIR camera. Horizontal, vertical, or angled placements have no impact on the functionality of the NIR camera.

Therefore, the disclosed technical solution is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished veneer.

The use of NIR cameras, as disclosed herein, eliminates the need for any offline magnification of the veneer or the need for the surface irregularity detection device, i.e., the NIR camera, to be close to the surface of the veneer. This allows for more flexible placement of the sample taking device, i.e., the NIR camera.

In addition, unlike visual based detection methods NIR cameras are virtually immune to ambient visible light and interference. Consequently, use of NIR cameras as disclosed herein is far more suitable for a physical production line environment.

Further, NIR technology has been determined to be safe, i.e., representing no hazards to workers or other devices, by several testing and safety agencies. Consequently, the use of the disclosed NIR based surface irregularity detection systems results in a safe, comfortable, and efficient workplace and production floor.

Using the disclosed embodiments, surface irregularities on the surface of veneer can be identified efficiently, effectively, and quickly, while the production line continues operation at normal speeds, consequently, implementation of the disclosed embodiments does not slow down production speed or change product processing time.

Using the information available from the disclosed embodiments, preconditioning parameters for subsequent wood sources used to produce subsequent veneer can be evaluated and adjusted without slowing down the production line. These preconditioning parameters include the amount of chemical used in a preconditioning liquid used to precondition the wood source; the type of chemical used in a preconditioning liquid used to precondition the wood source; the time the wood source soaks in a preconditioning liquid used to precondition wood source; and the temperature of a preconditioning liquid used to precondition the wood source. Consequently, the disclosed embodiments provide a technical solution to the long-standing technical problem of how to identify the interaction of these preconditioning parameters and adjust the preconditioning process for optimal results before significant amounts of defective veneer have been produced.

In addition, using the information available from the disclosed embodiments, one or more processing parameters can be adjusted and applied to a single wood source as it is being processed into veneer in relative real time. These processing parameters include replacing a knife or other processing component; adjusting a rotation speed of a lath turning the wood source; adjusting an angle between a knife used to cut the veneer from the wood source; and adjusting a pressure used to keep a knife used to cut veneer from the wood source in contact with a surface of the wood source. Consequently, the disclosed embodiments provide a technical solution to the long-standing technical problem of adjusting processing parameters for optimal results from a single wood source before significant amounts of defective veneer have been produced.

In addition, in one embodiment, the NIR technology, including Near InfraRed/Short Wave InfraRed (NIR/SWIR) cameras and detectors, is used to accurately identify surface irregularities and the specific locations of the irregularities in veneer. In one embodiment, a grade is then assigned to the veneer based at least in part on the detected irregularities.

In one embodiment, the disclosed NIR analysis systems are part of one or more veneer analysis systems In one embodiment, individual full veneer sheets and/or veneer strips and/or partial veneer sheets are provided to one or more veneer analysis systems. In one embodiment, the NIR analysis systems of the one or more veneer analysis systems are used to analyze the surface of each individual full veneer sheet, veneer strip, and partial veneer sheet, quickly and automatically, and then assign a grade to each individual full veneer sheet, veneer strip, and partial veneer sheet.

In one embodiment, the veneer is then provided to a veneer stacking system that produces more consistently graded veneer stacks based, at least in part, on the grade assigned to the veneer by the disclosed the NIR analysis systems.

In one embodiment, the veneer stacks of now consistently graded veneer are then provided to disclosed local robotic panel assembly cells. In one embodiment, the disclosed local robotic panel assembly and pressing system includes one or more local robotic panel assembly cells.

In one embodiment, each local robotic panel assembly cell includes: one or more veneer handling robots; one or more glue application robots; and, in some embodiments, one or more core handling robots. According to the disclosed embodiments, the local robotic panel assembly cells are used to independently produce stacks of layered wood product panels at static positions at, or near, the pressing stations.

The disclosed local robotic panel assembly cells replace the prior art traditional panel conveyors, traditional layered wood product panel assembly layup lines, and stack press delivery lines discussed above with respect to FIGS. 3A through 3D. This, in turn, eliminates thousands of moving parts and dozens of people from the layered wood product production process. In addition, using the disclosed embodiments, hundreds of square feet of factory floor space traditionally used in the layered wood product production process are no longer required.

In accordance with the disclosed embodiments, the local robotic panel assembly cells are used to locally and independently utilize the stacks of now consistently graded veneer to produce stacks of layered wood product panels at, or near, the pressing stations. As disclosed, the local robotic panel assembly cells operate independently to assemble the stacks at static locations local to the pressing stations and as the stacks are required. Consequently, using the disclosed embodiments, the stacks of layered wood product panels are built independently and locally from consistently graded veneer stacks at the pressing stations thereby eliminating the need for traditional panel conveyors, traditional layered wood product panel assembly layup lines, and stack press delivery lines. This, in turn, eliminates thousands of moving parts and dozens of people from the layered wood product production process.

Consequently, using the disclosed embodiments, many of the shortcomings of prior art are minimized or by-passed/resolved. For instance, using the disclosed embodiment, NIR technology, including Near InfraRed/Short Wave InfraRed (NIR/SWIR) cameras and detectors, is used to accurately identify surface irregularities and the specific locations of the irregularities in veneer. This data is then used to accurately and consistently grade veneer and then place the veneer in stacks of similarly graded veneer to create consistently graded veneer stacks. Therefore, defects can be detected, and the veneer sheets can be graded before significant time and energy has already been devoted to creating layered wood product panels from the veneer.

Then, by way of the disclosed local robotic panel assembly cells, layered wood products are created from the consistently graded veneer and consistently graded veneer stacks without the need for prior at panel conveyors, traditional layered wood product panel assembly layup lines, nor stack press delivery lines. Therefore, the large physical size, e.g., hundreds of feet, of factory floor space required by prior art methods and systems are not needed.

In addition, since using the methods and systems for producing layered wood products disclosed herein there is no need for traditional panel conveyors, traditional layered wood product panel assembly layup lines, nor stack press delivery lines, the thousands of moving parts and sensors required by prior art methods and systems are no longer required nor utilized. This makes the disclosed methods and systems for producing layered wood products much less maintenance intensive and is far less susceptible to failure.

In addition, since using the methods and systems for producing layered wood products disclosed herein there is no need for traditional panel conveyors, traditional layered wood product panel assembly layup lines, nor stack press delivery lines, there is no need for the large number of electric motors and substantial power consumption required by prior art methods and systems. This makes the disclosed methods and systems for producing layered wood products less expensive to operate and less of a drain on the environment.

In addition, since using the methods and systems for producing layered wood products disclosed herein there is the no need for traditional panel conveyors, traditional layered wood product panel assembly layup lines, nor stack press delivery lines, the disclosed methods and systems are less manpower intensive for operation and maintenance. This makes the disclosed methods and systems for producing layered wood products not only less expensive to operate but also less subject to human error and potential injury.

In addition, unlike prior art methods and systems, any failure of any one of the substantially fewer moving parts required by the disclosed methods and systems for producing layered wood products, or any human error introduced, does not result in substantial product waste due to glue degradation, i.e., glue dry out. This is because using the methods and systems for producing layered wood products disclosed herein the stacks of layered wood product panels are built locally and independently at the pressing stations so there is, at most, only one stack of layered wood product panels that may be lost if there is a failure in the associated pressing station. This means a loss of, at most, forty layered wood product panels, as compared to a potential loss of four hundred or more panels using prior art methods and systems.

In addition, unlike prior art methods and systems, using the methods and systems for producing layered wood products disclosed herein material and glue systems can be configured to run multiple products at a time, i.e., multiple ply count panels and/or multiple types of product (plywood or PLV), at a time. This is because using the methods and systems for producing layered wood products disclosed herein the stacks of layered wood product panels are built at the pressing stations independently of each other. Consequently, each pressing station has its own robotic panel assembly cell and each robotic panel assembly cell can be directed/controlled by control signals to assemble a different product.

In addition, unlike prior art methods and systems, using the methods and systems for producing layered wood products disclosed herein glue application robots are used to assemble each layered wood product panel stack. These glue application robots apply the glue by moving back and forth over the structure, as opposed to having the structure move beneath the glue applicator. Consequently, glue spread rates can be very precisely controlled and it is relatively simple to make fine adjustments to the amount of glue applied to compensate for ambient temperature, line speed changes, etc.

In addition, unlike prior art methods and systems, using the methods and systems for producing layered wood products disclosed herein the robotic panel assembly cells and control systems can be used to make a direct correlation between individual panel quality and the assembly process variables/control signals used for construction of that specific panel.

In addition, since using the methods and systems for producing layered wood products disclosed herein there is no need for traditional panel conveyors, traditional layered wood product panel assembly layup lines, nor stack press delivery lines, housekeeping, i.e., keeping the workplace clean and safe, is a much simpler since the assembly locations are static and of relatively small physical size. In addition, since using the methods and systems for producing layered wood products disclosed herein each robotic panel assembly cell can operate a local robot panel assembly and pressing line completely independently of other local robot panel assembly and pressing lines, when keep up is required at one local robot panel assembly and pressing line, only that local and independently operating robot panel assembly and pressing line need be shut down while the other local robot panel assembly and pressing lines continue to operate.

As a result of these and other disclosed features, which are discussed in more detail below, the disclosed embodiments address the short comings of the prior art and provide an effective and efficient technical solution to the long standing problem of providing a method and system for producing layered wood products that is more consistent, more effective, less expensive to operate and more efficient.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a preconditioned wood source, in this example a peeler log, being processed using rotary cutting methods.

FIG. 2A is a representation of a magnified side view of a surface of veneer that was produced from an optimally preconditioned conditioned log.

FIG. 2B is a representation of a magnified surface of veneer that was produced from an over preconditioned log.

FIG. 2C is a representation of a magnified side view of a surface of veneer that was produced from an under preconditioned log.

FIG. 2D is a representation of a magnified view of a surface of veneer that was produced under conditions where the cutting knife edge was irregular, nicked, or otherwise damaged.

FIG. 2E is a representation of a magnified side view of a surface of veneer that was produced under conditions where the cutting knife edge was not held against the surface of the preconditioned log with a steady pressure.

FIG. 2F is a representation of a magnified side view of a surface of veneer that was produced under conditions where the cutting knife was dull.

FIG. 3A is a diagram representing traditional layered wood product panel assembly layup station.

FIG. 3B is a diagram representing a side view of the formation of layers, or plys, being created using a traditional layered wood product panel assembly layup station.

FIG. 3C is a diagram representing a traditional layered wood product panel assembly layup line including five traditional layered wood product panel assembly layup stations.

FIG. 3D is a diagram representing a traditional layered wood product panel assembly layup and press line including the traditional layered wood product panel assembly layup line of FIG. 1D and a press area including four pressing stations.

FIG. 4A is simplified block diagram of a system for detecting surface irregularity levels in veneer using NIR technology in accordance with one embodiment.

FIG. 4B shows an end view of veneer positioned in an NIR analysis station including three NIR cameras.

FIG. 4C is a representation of an NIR image of the surface of veneer that was produced from an optimally preconditioned conditioned log.

FIG. 4D is a representation of an NIR image of the surface of veneer that was produced from an over preconditioned log.

FIG. 4E is a representation of an NIR image of the surface of veneer that was produced from an under preconditioned log.

FIG. 4F is a representation of an NIR image of the surface of veneer that was produced under conditions where the cutting knife edge was irregular, nicked, or otherwise damaged.

FIG. 4G is a representation of an NIR image of the surface of veneer that was produced under conditions where the cutting knife edge was not held against the surface of the preconditioned log with a steady pressure.

FIG. 4H is a representation of an NIR image of the surface of veneer that was produced under conditions where the cutting knife was dull.

FIG. 5 is flow chart of a process for detecting surface irregularity levels in veneer using NIR technology in accordance with one embodiment.

FIG. 6 is simplified block diagram of a system for detecting surface irregularity levels in veneer using NIR technology and machine learning methods in accordance with one embodiment.

FIG. 7 is flow chart of a process for detecting surface irregularity levels in veneer using NIR technology and machine learning methods in accordance with one embodiment.

FIG. 8 is simplified block diagram of a system for adjusting a preconditioning process of wood sources used to produce veneer based on a level of irregularity of a first surface of the veneer in accordance with one embodiment.

FIG. 9 is flow chart of a process for adjusting a preconditioning process of wood sources used to produce veneer based on a level of irregularity of a first surface of the veneer in accordance with one embodiment.

FIG. 10 is simplified block diagram of a system for adjusting processing parameters used to produce veneer from a wood source based on a level of irregularity of a first surface of the veneer in accordance with one embodiment.

FIG. 11 is flow chart of a process for adjusting processing parameters used to produce veneer from a wood source based on a level of irregularity of a first surface of the veneer in accordance with one embodiment.

FIG. 12A is a diagram of a local robotic panel assembly and pressing station in accordance with one embodiment.

FIG. 12B is a diagram of a robotic panel assembly and pressing system including four local robotic panel assembly and pressing stations in accordance with one embodiment.

FIG. 12C is a diagram of a robotic panel assembly cell of FIGS. 12A and 12B in accordance with one embodiment.

FIG. 12D is a diagram of a local robotic panel assembly cell of FIGS. 12A and 12B including a veneer inspection and grading system in accordance with one embodiment.

FIG. 13 is a diagram of a local robotic panel assembly and pressing station including a quality analysis and feedback cell for process refinement in accordance with one embodiment.

FIG. 14A is a photograph of a structural density analysis report based on the results of processing using one type of wood product panel bond analyzer used in accordance with one embodiment.

FIG. 14B is a photograph of average panel thickness analysis report based on the results of processing using one type of wood product panel bond analyzer used in accordance with one embodiment.

FIG. 14C is a photograph of panel thickness trend analysis report based on the results of processing using one type of wood product panel bond analyzer used in accordance with one embodiment.

Common reference numerals are used throughout the figures and the detailed description to indicate like elements. One skilled in the art will readily recognize that the above figures are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, or described below. Rather, these exemplary embodiments are provided to allow a complete disclosure that conveys the principles of the invention, as set forth in the claims, to those of skill in the art.

Embodiments of the present disclosure provide an effective and efficient technical solution to the long standing problem of providing a method and system for producing layered wood products that is more consistent, more effective, less expensive to operate, and more efficient.

In one embodiment, irregularities on the surfaces of veneer, such as full veneer sheets, veneer strips, and/or partial veneer sheets are detected using Near InfraRed (NIR) technology, including Near InfraRed/Short Wave InfraRed (NIR/SWIR) cameras and detectors. In one embodiment, a grade is then assigned to the veneer based, at least in part, on the detected irregularities. In one embodiment, the graded veneer is then stacked based, at least in part, on the grade assigned to the veneer. The graded veneer stacks are then provided to local robotic panel assembly and pressing systems that include one or more local robotic panel assembly cells for processing the veneer into layered wood product panels.

To this end, the disclosed embodiments utilize NIR analysis systems and NIR technology, including NIR cameras and detectors, to accurately identify surface irregularities and the specific locations of the irregularities in veneer surface.

As discussed in more detail below, in one embodiment, this is accomplished by providing a NIR analysis system including one or more illumination sources and one or more NIR cameras. In addition, in some embodiments, visual cameras may be combined to further refine the NIR image based on physical features such as knots that impact veneer ribbon peel quality, or thermal cameras that show temperature variations in the material temperature that impacts veneer ribbon peel quality peel quality.

Once the irregularity levels over the first surface of the veneer are identified, a grade is assigned to the veneer based on the identified irregularity levels for the veneer. In one embodiment, based, at least in part, on the grade assigned to the veneer, one or more actions are taken with respect to the veneer including, but not limited to, assigning the veneer to a specific veneer stack associated with the grade assigned to the veneer.

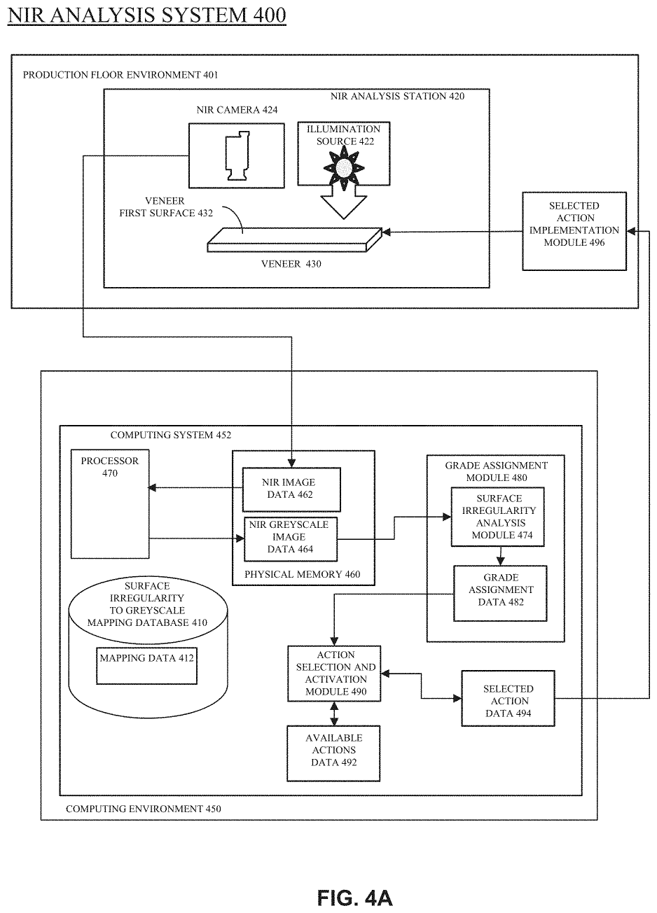

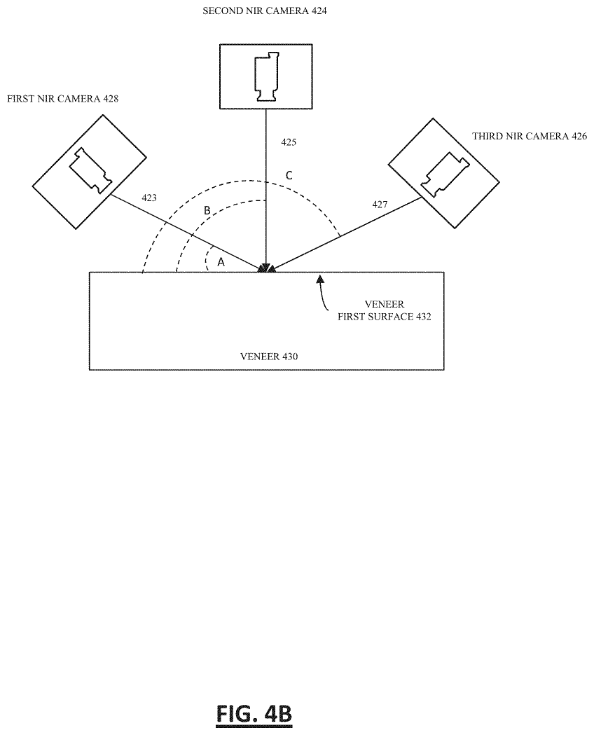

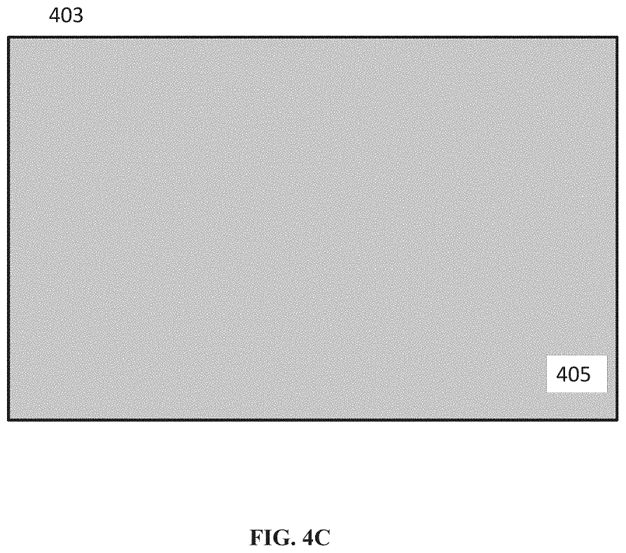

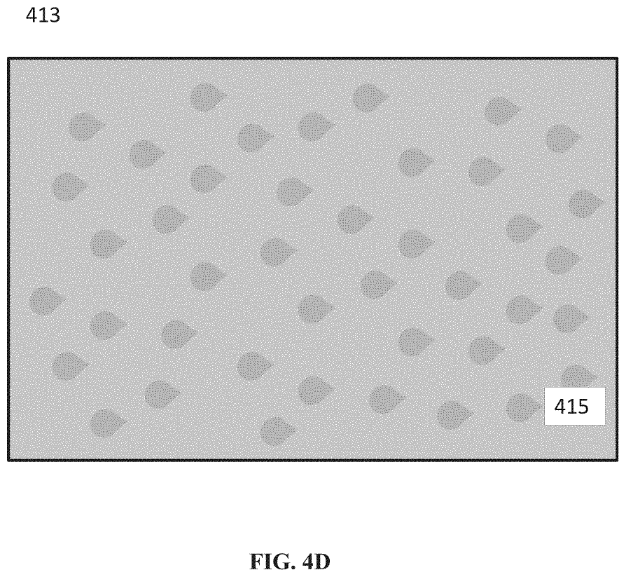

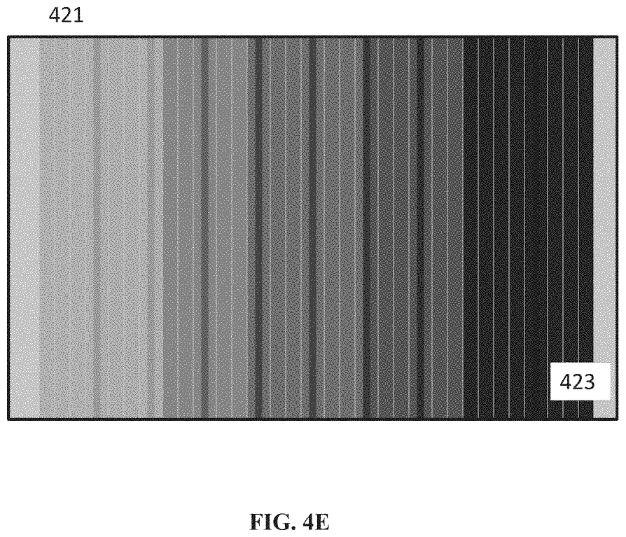

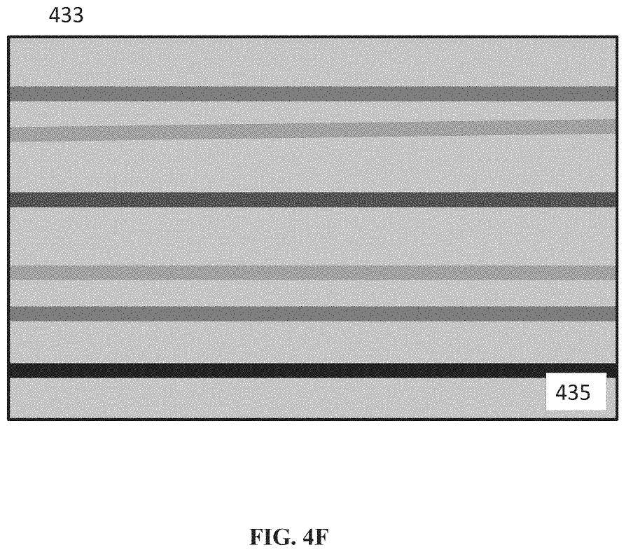

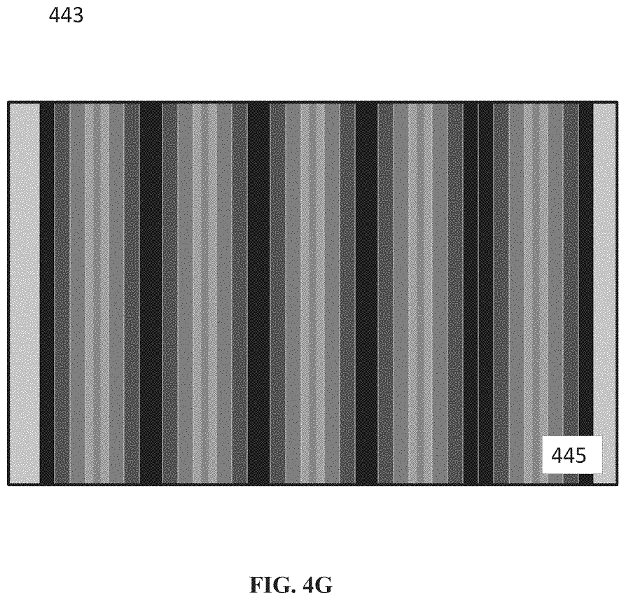

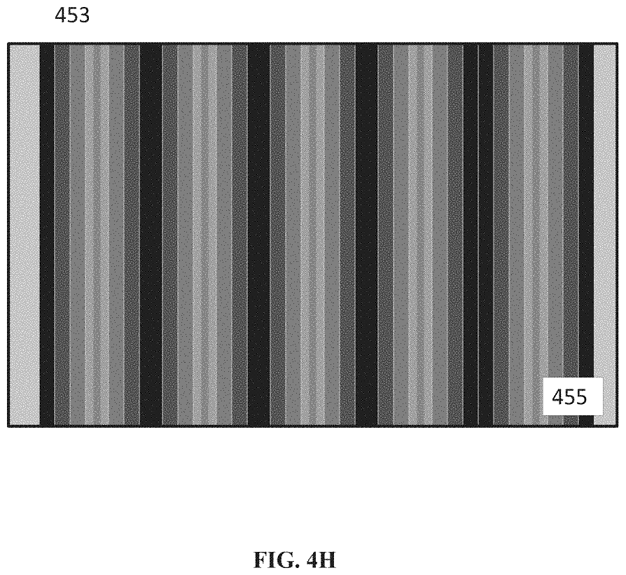

FIG. 4A is simplified block diagram of one embodiment of an NIR analysis system 400 for detecting surface irregularity levels in veneer using NIR technology in accordance with one embodiment.

In one embodiment, NIR analysis system 400 includes a production floor environment 401, including an NIR analysis station 420 and a computing environment 450. As discussed in more detail below, in one embodiment, NIR analysis system 400 is part of a veneer analysis system (not shown).

As seen in FIG. 4A, production floor environment 401 includes NIR analysis station 420 and selected action implementation module 496. As seen in FIG. 4A, NIR analysis station 420 includes one or more illumination sources, such as illumination source 422, positioned to illuminate a surface of veneer. In various embodiments, the one or more illumination sources, such as illumination source 422, can include one or more LED light sources. In other embodiments, the one or more illumination sources, such as illumination source 422, can include, but are not limited to, halogen, halogen and tungsten light sources, or any other light sources, as discussed herein, and/or as known in the art at the time of filing, and/or as developed after the time of filing.

As seen in FIG. 4A, NIR analysis station 420 also includes one or more NIR cameras, such as NIR camera 424, positioned to capture NIR image data 462 representing one or more NIR images of the illuminated surface of the veneer. In one embodiment, the one or more NIR cameras, such as NIR camera 424, are adjustably positioned and adjustably focused to capture any desired one or more NIR images of the illuminated surface of the veneer.

As used herein, the terms Near InfraRed (NIR) and Short-Wave InfraRed (SWIR) are used interchangeably to include wavelengths in the range of 750 nanometers (nm) to 4500 nm. In addition, all stated wave lengths herein are assumed to include values within 10% of the stated value. NIR wavelengths are in the range of 750 nanometers (nm) to 4500 nm which are much smaller that the visible wavelengths of 480 to 740 nm. Consequently, the use of NIR cameras as disclosed herein results in resolutions and accuracy that simply cannot be achieved using traditional visual irregularity detection systems.

As seen in FIG. 4A, and as discussed below, veneer 430 to be analyzed in the NIR analysis station 420 is positioned in NIR analysis station 420. In various embodiments, the veneer 430 can be any veneer as discussed herein, and/or as known in the art at the time of filing and/or as becomes known after the time of filing.

In one embodiment, the veneer 430 to be analyzed is positioned such that a veneer first surface 432 of the veneer 430 to be analyzed is illuminated by the illumination source 422 and a sample portion of the veneer first surface 432 is within view and focus of NIR camera 424. In one embodiment, the veneer 430 is positioned in the NIR analysis station 420 by passing the veneer 430 through the NIR analysis station 420 on a conveyor system.

In various embodiments, the one or more NIR cameras, such as NIR camera 424, can be of any resolution desired. As noted above, when the one or more NIR cameras, such as NIR camera 424, are used to scan the veneer first surface 432 of veneer 430 for irregularities and create an NIR image data 462 of the veneer first surface 432, essentially each pixel generated by NIR camera 424 is a sample point. Consequently, the resolution and accuracy of the surface irregularity detection process is only limited by the number of pixels the NIR camera 424 has covering the field of view, e.g., the entire veneer first surface 432 of veneer 430. Consequently, in the case where NIR camera 424 is a 1.3 mega pixel camera, there are essentially 1,400,000 individual measurement points on the veneer first surface 432. In addition, NIR wavelengths are in the range of 750 nanometers (nm) to 4500 nm which are much smaller that the visible wavelengths of 480 to 740 nm. Consequently, using NIR cameras, such as NIR camera 424, results in resolutions and accuracy that simply cannot be achieved using traditional surface magnified visual image methods.

Therefore, using NIR cameras, such as NIR camera 424, NIR analysis system 400 is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished veneer.

As seen in FIG. 4A, computing environment 450 includes computing system 452. As seen in FIG. 4A, in one embodiment, computing system 452 includes surface irregularity to greyscale mapping database 410 containing mapping data 412 that maps surface irregularities to Near InfraRed (NIR) image greyscale values for one or more full veneer sheet, veneer strip, and/or partial veneer sheets.

Using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer first surface 432 of veneer 430, more NIR energy is reflected from surfaces that are perpendicular the NIR camera lens. Consequently, locations having irregularities such that the surfaces are not perpendicular the NIR camera lens will appear darker, i.e., have a greater greyscale value.

When the NIR camera 424 takes an image of the veneer first surface 432, the NIR camera 424 picks up the NIR energy reflected off veneer first surface 432 at angles of about 90 degrees, i.e., that are reflected substantially perpendicular to veneer first surface 432. Consequently, when the NIR camera 424 takes an image of the veneer first surface 432, the areas of irregularities, which scatter NIR energy at various angles other than 90 degrees and therefore reflect less NIR energy at the desired angles of about 90 degrees, appear darker than less textured areas. In addition, the higher or more significant the irregularities that are present, the darker the area appears because less NIR energy is reflected at angles of about 90 degrees to be captured by the NIR camera 424.

Using this fact, NIR image data 462 captured by the NIR camera 424 can be processed into NIR greyscale image data 464. Greyscale images can be of varying resolution, or bit, types. A 16-bit integer grayscale image provides 65535 available tonal steps from 0 (black) to 65535 (white). A 32-bit integer grayscale image theoretically will provide 4,294,967,295 tonal steps from 0 (black) to 4294967295 (white). Converting an NIR image based on these numbers of greyscale tonal steps results in a margin of error of significantly less than 0.1%.

In some embodiments, two or more illumination sources, such as illumination source 422, are utilized, that are positioned a different angles with respect to veneer first surface 432. This allows different types and levels of irregularities to be detected. In addition, using two or more two or more illumination sources, such as illumination source 422, that are positioned at different angles means that different irregularities will have surfaces perpendicular to the camera lens and therefore will yield a 3-D effect when a composite NIR image is constructed.

Likewise, in some embodiments, two or more NIR cameras are utilized, such as NIR camera 424, that are operated at different NIR frequencies and/or that are positioned a different angles with respect to veneer first surface 432. This allows different types and levels of irregularities to be detected. In addition, using two or more NIR cameras, such as NIR camera 424, that are positioned at different angles means that different irregularities will have surfaces perpendicular to the camera lens and therefore will yield a 3-D effect when a composite NIR image is constructed.

FIG. 4B shows an end view of veneer 430 positioned in an NIR analysis station including three NIR cameras 428, 424, and 426. As seen in FIG. 4B, first NIR camera 428 is positioned such that line 423 from a lens of first NIR camera 428 is at an angle “A” with respect to veneer first surface 432. Similarly, second NIR camera 424 is positioned such that line 425 from a lens of second NIR camera 424 is at an angle “B” with respect to veneer first surface 432. Likewise, third NIR camera 426 is positioned such that line 427 from a lens of third NIR camera 426 is at an angle “C” with respect to veneer first surface 432.

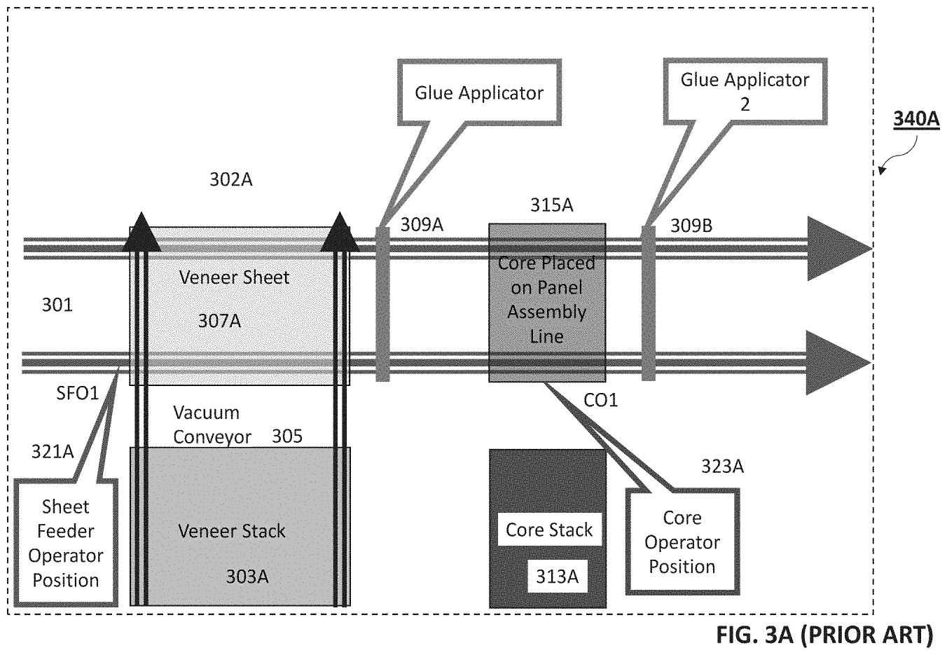

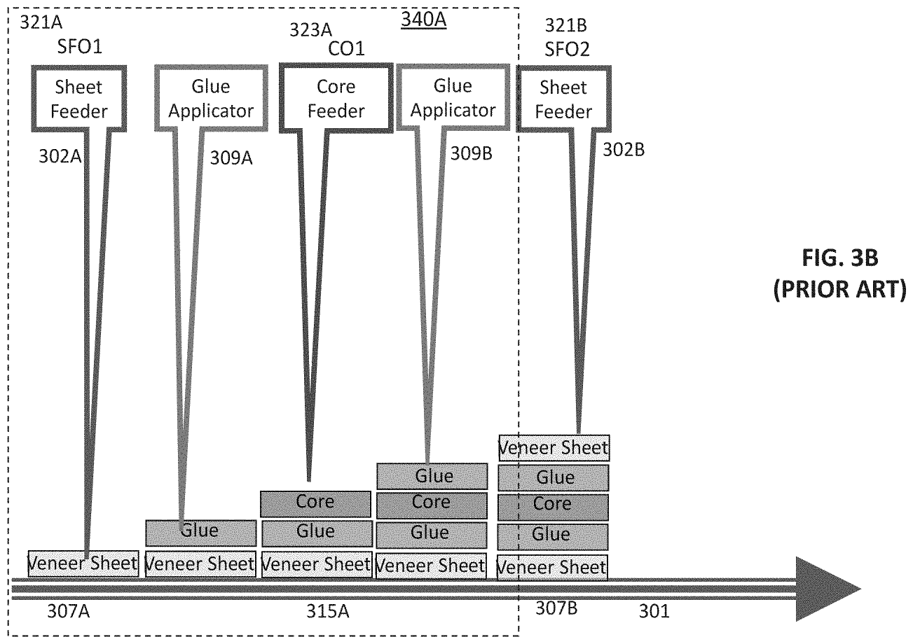

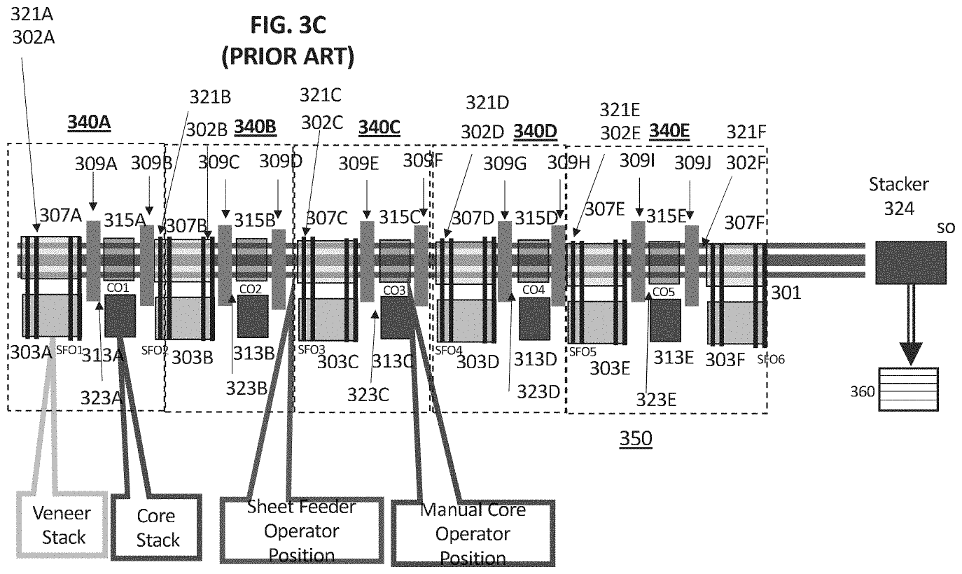

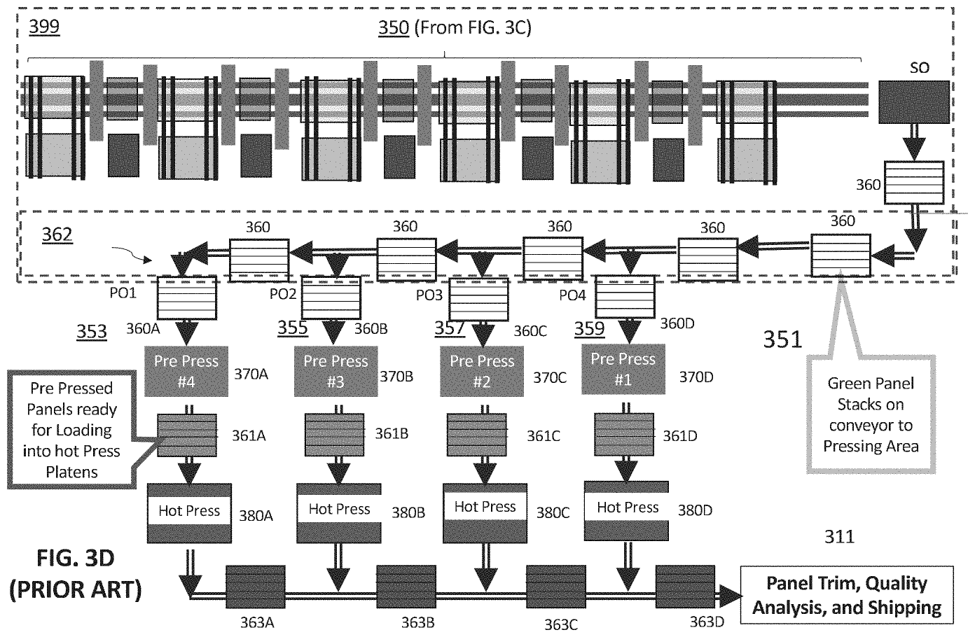

In some embodiments, each of NIR cameras 428, 424, and 426 can be operated at different NIR frequencies and as seen in FIG. 4B, are positioned a different angles A, B, and C, respectively, with respect to veneer first surface 432. In one embodiment, angle A is 45 degrees, angle B is 90 degrees, and angle C is 135 degrees. As noted, the arrangement shown in FIG. 3B allows different types and levels of irregularities to be detected. In addition, using two or more NIR cameras, such as NIR cameras 428, 424, and 426, that are positioned a different angles means that different irregularities will have surfaces perpendicular to the camera lens and therefore will yield a 3-D-like effect when a composite NIR image is constructed.

As noted above, in some embodiments, two or more illumination sources, such as illumination source 422, are utilized, that are positioned a different angles with respect to veneer first surface 432. This allows different types and levels of irregularities to be detected. In addition, using two or more two or more illumination sources, such as illumination source 422, that are positioned at different angles means that different irregularities will have surfaces perpendicular to the camera lens and therefore will yield a 3-D effect when a composite NIR image is constructed.

Consequently, in some embodiments, in an arrangement similar to FIG. 4B, a first illumination source can positioned such that line from the first illumination source is at an angle “A” with respect to veneer first surface, a second illumination source can positioned such that line from the second illumination source is at an angle “B” with respect to veneer first surface, and a third illumination source can positioned such that line from the third illumination source is at an angle “C” with respect to veneer first surface. As discussed above, in some embodiments, angles A, B, and C, respectively, with respect to veneer first surface are all different and, in one very specific embodiment, angle A is 45 degrees, angle B is 90 degrees, and angle C is 135 degrees.

In addition, as discussed in the disclosed related applications, in some embodiments, visual cameras may be combined to further refine the NIR image based on physical features such as knots that impact veneer ribbon peel quality, or thermal cameras that show temperature variations in the material temperature that impacts veneer ribbon peel quality peel quality.

Returning to FIG. 4A, using the concepts discussed above, the mapping data 412 of surface irregularity to greyscale mapping database 410 is obtained through one or more empirical and/or manual processes.

For instance, in one embodiment, sample full veneer sheet, veneer strip, and/or partial veneer sheets that have been identified and associated with one or more production parameter values can be passed through NIR analysis station 420 and known production parameter NIR images can be obtained for numerous sample full veneer sheets, veneer strips, and/or partial veneer sheets determined to be produced by known production parameters.

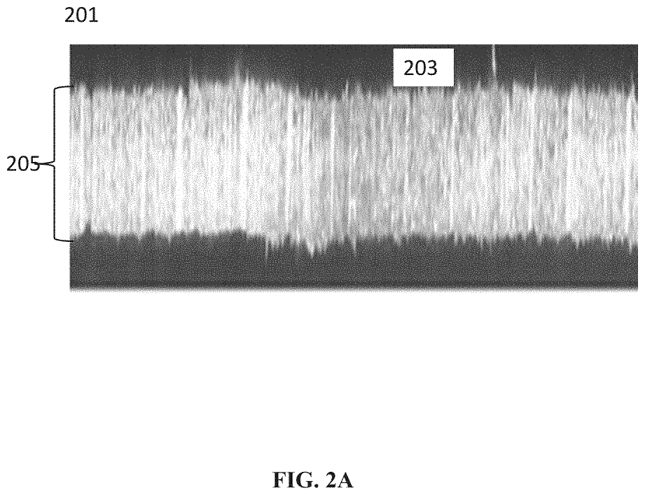

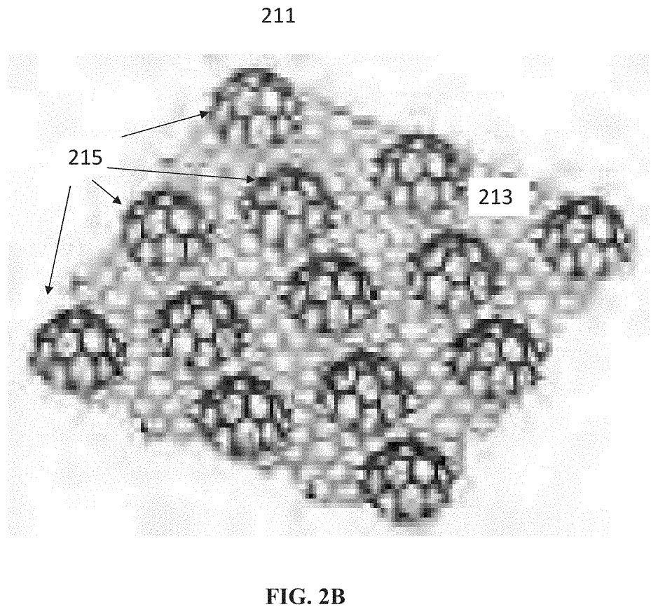

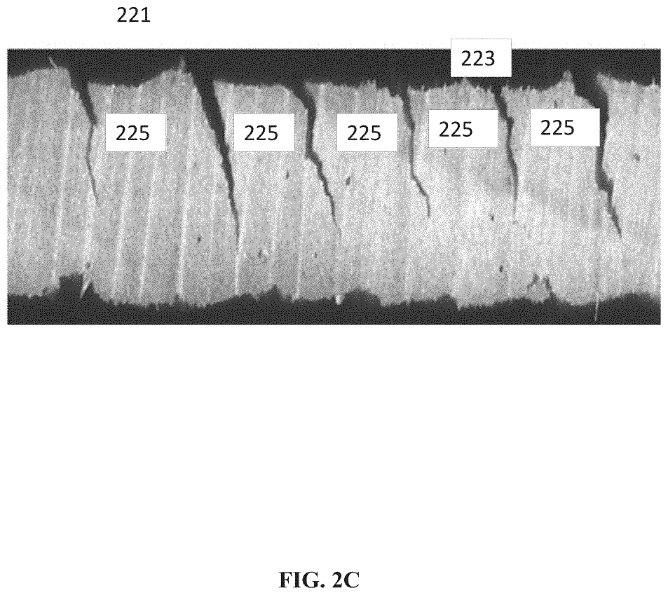

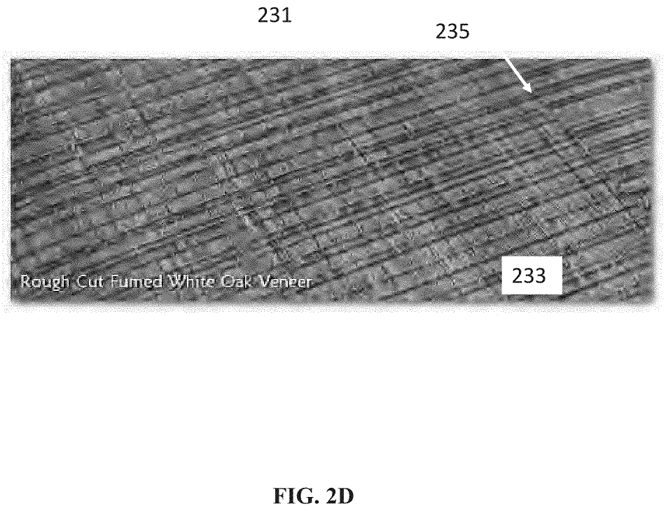

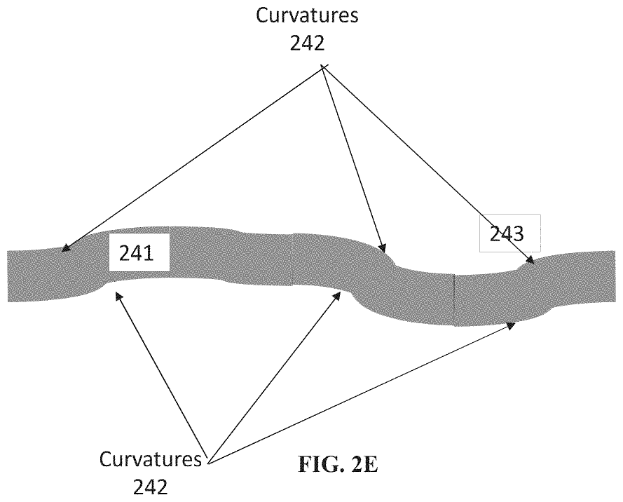

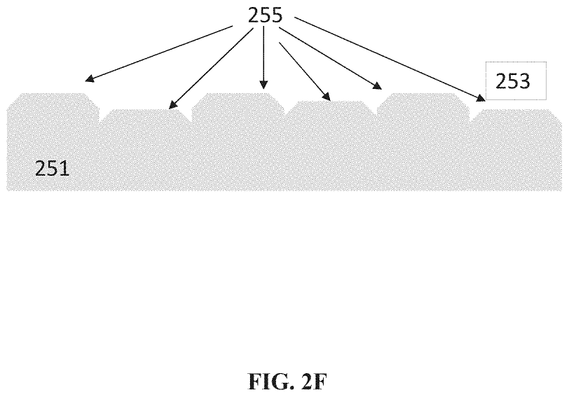

FIGS. 4C to 4H are illustrative examples of NIR images of surfaces of veneer produced under various optimal and non-optimal production parameters. In the specific examples of FIGS. 4C to 4H the NIR image illustrations of 4C, 4D, 4E, 4F, 4G and 4H, correlate to the magnified visual image illustrations of FIGS. 2A, 2B, 2C, 2D, 2E and 2F, respectively.

Consequently, FIG. 4C is a representation of an NIR image of a veneer surface that was produced from an optimally preconditioned conditioned log, FIG. 4D is a representation of an NIR image of a veneer surface that was produced from an over preconditioned log, FIG. 4E is a representation of an NIR image of a veneer surface that was produced from an under preconditioned log, FIG. 4F is a representation of an NIR image of a veneer surface that was produced under conditions where the cutting knife edge was irregular, nicked, or otherwise damaged, FIG. 4G is a representation of an NIR image of a veneer surface that was produced under conditions where the cutting knife edge was not held against the surface of the preconditioned log with a steady pressure, and FIG. 4H is a representation of an NIR image of a veneer surface that was produced under conditions where the cutting knife was dull.

Therefore, in the specific illustrative examples of FIGS. 2A and 4C, sample veneer ribbons, full veneer sheets, veneer strips, and/or partial veneer sheets determined empirically to be produced from optimally preconditioned wood sources, such as shown in FIG. 2A, can be passed through NIR analysis station 420 to generate known optimally preconditioned wood NIR images of surface 405 of veneer 403, as shown in FIG. 4C.

Similarly, in the specific illustrative examples of FIGS. 2B and 4D, sample veneer ribbon, full veneer sheet, veneer strip, and/or partial veneer sheets determined empirically to be produced from over preconditioned wood sources, such as shown in FIG. 2B, can be passed through NIR analysis station 420 to generate known over preconditioned wood NIR images of surface 415 of veneer 413, as shown in FIG. 4D.

Similarly, in the specific illustrative examples of FIGS. 2C and 4E, sample veneer ribbon, full veneer sheet, veneer strip, and/or partial veneer sheets determined empirically to be produced from under preconditioned wood sources, such as shown in FIG. 2C, can be passed through NIR analysis station 420 to generate known under preconditioned wood NIR images of surface 423 of veneer 421, as shown in FIG. 4E.

Likewise, in the specific illustrative examples of FIGS. 2D and 4F, sample veneer ribbon, full veneer sheet, veneer strip, and/or partial veneer sheets determined empirically to be produced under conditions where the cutting knife edge was irregular, nicked, or otherwise damaged, such as shown in FIG. 2D, can be passed through NIR analysis station 420 to generate known irregular cutting knife edge NIR images of surface 435 of veneer 433, as shown in FIG. 4F.

Likewise, in the specific illustrative examples of FIGS. 2E and 4G, sample veneer ribbon, full veneer sheet, veneer strip, and/or partial veneer sheets determined empirically to be produced under conditions where the cutting knife edge was not held against the surface of the preconditioned log with a steady pressure, such as shown in FIG. 2E, can be passed through NIR analysis station 420 to generate known irregular cutting knife pressure NIR images of surface 445 of veneer 443, as shown in FIG. 4G.

Similarly, in the specific illustrative examples of FIGS. 2F and 4H, sample veneer ribbon, full veneer sheet, veneer strip, and/or partial veneer sheets determined empirically to be produced under conditions where the cutting knife edge was dull, such as shown in FIG. 2F, can be passed through NIR analysis station 420 to generate known dull cutting knife NIR images of surface 455 of veneer 453, as shown in FIG. 4H.

This process is continued for multiple levels and types of surface irregularities and greyscale data for each irregularity increment is determined and correlated to the respective surface irregularities increment. In this way, mapping data 412 mapping each specific surface irregularities to specific greyscale values is generated for veneer ribbons, full veneer sheets, veneer strips, and/or partial veneer sheets. The process can then be repeated for different full veneer sheets, veneer strips, and/or partial veneer sheets, different types of wood, and under varying parameters and conditions. Consequently, the specific examples discussed herein are but illustrative examples and do not limit the scope of the invention as set forth in the claims below.

Returning the FIG. 4A, computing system 452 also includes physical memory 460. In one embodiment, the physical memory 460 includes NIR image data 462 representing one or more NIR images of the illuminated veneer first surface 432 of the veneer 430 captured using NIR camera 424.

As seen in FIG. 4A, in one embodiment, computing system 452 includes one or more processors 470 for processing the NIR image data representing one or more NIR images of the illuminated veneer first surface 432 of the veneer 430 to generate NIR greyscale image data 464 indicating different irregularity levels in the illuminated veneer first surface 432 of the veneer 430.

In one embodiment, processor 470 processes the NIR greyscale image data 464 using the mapping data 412 from surface irregularity to greyscale mapping database 410 to identify irregularity levels for the veneer first surface 432 of the veneer 430.

As seen in FIG. 4A, in one embodiment, computing system 452 includes a grade assignment module 480 for assigning a grade to the veneer 430 based on the identified irregularity levels for the veneer first surface 432. As seen in FIG. 4A, grade assignment module 480 includes surface irregularity analysis module 474 which, along with processor 470, processes the NIR greyscale image data 464 using the mapping data 412 from surface irregularity to greyscale mapping database 410 data to identify irregularity levels for the veneer first surface 432 of the veneer 430. As a result of the processing by surface irregularity analysis module 474 and processor 470, grade assignment data 482 is generated.

As seen in FIG. 4A, in one embodiment, grade assignment data 482 is provided to action selection and activation module 490 which selects an appropriate action of the actions represented in available actions data 492 based, at least in part on the grade indicated by grade assignment data 482. As seen in FIG. 4A, in one embodiment, the determined appropriate action is represented by selected action data 494.

As seen in FIG. 4A, in one embodiment, selected action data 494 is forwarded to an action activation module, such as selected action implementation module 496, in production floor environment 401 to initialize one or more actions with respect to the veneer 430 based, at least in part, on the grade represented by grade assignment data 482 and assigned to the veneer 430 by action selection and activation module 490. These actions can include assigning the veneer 430 to a specific veneer stack associated with the grade assigned to the veneer 430.

As discussed in more detail below, in some embodiments, the selected action indicated by selected action data 494 is to add veneer 430 to a specific veneer stack based, at least in part, on the grade represented by grade assignment data 482 and assigned to the veneer 430. In these embodiments, grade assignment data 482 is provided to action selection and activation module 490 which, in turn, forwards grade assignment data 482 to selected action implementation module 496. In one embodiment, selected action implementation module 496 then forwards grade assignment data 482 to a stacking system such as any stacking system discussed herein. As discussed in more detail below, in these embodiments, the veneer 430 is then added to a specific veneer stack based, at least in part, on the grade represented by grade assignment data 482 and assigned to the veneer 430.

In other embodiments, the one or more actions that can be taken represented in available actions data 492 can also include, but are not limited to: sorting veneer 430 into a bin or location based, at least in part, on the grade represented by grade assignment data 482 and assigned to the veneer 430; restricting the use of the veneer 430 based on the grade represented by grade assignment data 482 assigned to veneer 430; rejecting the veneer 430 based, at least in part, on the grade represented by grade assignment data 482 and assigned to the veneer 430; sending the veneer 430 back for further processing based, at least in part, on the grade represented by grade assignment data 482 and assigned to the veneer 430; adjusting one or more processing parameters of a production line based, at least in part, on the grade represented by grade assignment data 482 and assigned to the veneer 430 and one or more similarly graded similar full veneer sheet, veneer strip, and/or partial veneer sheets; adjusting one or more preconditioning parameters on a production line based, at least in part, on the grade represented by grade assignment data 482 and assigned to the veneer 430 and/or one or more similarly graded full veneer sheet, veneer strip, and/or partial veneer sheets; adjusting one or more veneer cutting parameters on a production line based, at least in part, on the grade represented by grade assignment data 482 and assigned to the veneer 430 and/or one or more similarly graded full veneer sheet, veneer strip, and/or partial veneer sheets; and selecting a type and amount of glue used on a production line in production floor environment 401 based, at least in part, on the grade represented by grade assignment data 482 and assigned to the veneer 430 and/or the grades assigned other full veneer sheet, veneer strip, and/or partial veneer sheets.

Those of skill in the art will ready recognize that the specific illustrative examples of one embodiment of a production floor environment 401 and components shown in FIGS. 4A and 4B are but specific examples of numerous possible production environments and arrangement of physical components. Consequently, the specific illustrative example of embodiments of a production floor environment 401 and components shown in FIGS. 4A and 4B is not intended to limit the scope of the invention as set forth in the claims below.

Likewise, those of skill in the art will ready recognize that the specific illustrative examples of one embodiment of FIGS. 2A through 2F and corresponding FIGS. 4C through 4H are but specific examples of numerous possible images. Consequently, the specific illustrative examples of one embodiment shown in FIGS. 2A through 2F and corresponding FIGS. 4C through 4H are not intended to limit the scope of the invention as set forth in the claims below.

As a specific illustrative example of potential variations, in various embodiments, the NIR analysis station 420 can include one or more illumination sources 422 positioned to illuminate two or more surfaces of the veneer and one or more NIR cameras 424 positioned to capture one or more NIR images of the two or more illuminated surfaces of the veneer.

As a further specific illustrative example of variations possible, additional input data can be considered such as current ambient temperature and humidity. The combination of these parameters can be analyzed by an Artificial Intelligence/Machine Learning (AI/ML) algorithm to further refine the production parameters for overall process efficiency.

These and numerous other variations are possible and contemplated by the inventors to be within the scope of the invention as set forth in the claims below.

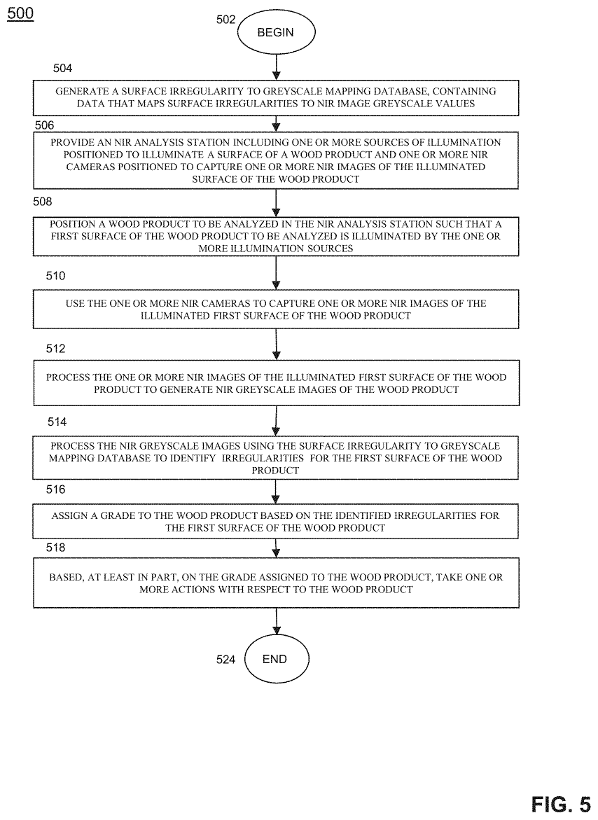

FIG. 5 is flow chart of a process 500 for detecting surface irregularity levels in veneer using NIR technology in accordance with one embodiment.

As seen in FIG. 5, process 500 begins at BEGIN operation 502 and then process proceeds to operation 504. In one embodiment, at operation 504 a surface irregularity level to greyscale mapping database is generated such as any database discussed above with respect to FIGS. 3A, FIGS. 2A through 2F and corresponding FIGS. 4C through 4H. In one embodiment, the surface irregularity level to greyscale mapping database contains mapping data that maps surface irregularities level to Near InfraRed (NIR) image greyscale values for one or more full veneer sheets, veneer strips, and/or partial veneer sheets.

Once a surface irregularity level to greyscale mapping database is generated at operation 504, process flow proceeds to operation 506. At operation 506, an NIR analysis station is provided. In one embodiment, the NIR analysis station is substantially similar to any NIR analysis station discussed above with respect to FIGS. 4A and 4B. As discussed above, in one embodiment, the NIR analysis station includes one or more sources of illumination positioned to illuminate a surface of wood product such as veneer and one or more NIR cameras positioned to capture one or more NIR images of the illuminated surface of the veneer.

Once an NIR analysis station is provided at operation 506, process flow proceeds to operation 508. In one embodiment, at operation 508, a wood product such as veneer to be analyzed is positioned in the NIR analysis station of operation 506 such that a first surface of the wood product such as veneer to be analyzed is illuminated by the one or more illumination sources using any of the methods and systems discussed above with respect to FIGS. 4A and 4B.

Once the wood product such as veneer to be analyzed is positioned in the NIR analysis station at 508, process flow proceeds to operation 510. In one embodiment, at operation 510 the one or more NIR cameras of NIR analysis station take one or more NIR images of the illuminated first surface of the wood product such as veneer using any of the methods and systems discussed above with respect to FIGS. 4A and 4B.

Once the one or more NIR cameras of NIR analysis station take one or more NIR images of the illuminated first surface of the wood product such as veneer at operation 510, process flow proceeds to operation 512.

In one embodiment, at operation 512, the one or more NIR images of the illuminated first surface of the wood product such as veneer of operation 510 are processed using any of the methods and systems discussed above with respect to FIGS. 4A and 4B, FIGS. 2A through 2F, and corresponding FIGS. 4C through 4H, to generate NIR greyscale images indicating irregularities in the illuminated first surface of the wood product such as veneer.

Once the one or more NIR images of the illuminated first surface of the wood product such as veneer are processed to generate NIR greyscale images indicating different irregularities in the illuminated first surface of the wood product such as veneer at operation 512, process flow proceeds to operation 514.

In one embodiment, at operation 514, the NIR greyscale images are processed using the surface irregularity level to greyscale mapping database to identify irregularity levels for the first surface of the wood product such as veneer by any of the methods and systems discussed above with respect to FIGS. 4A and 4B, FIGS. 2A through 2F, and corresponding FIGS. 4C through 4H.

Once the NIR greyscale images are processed using the surface irregularity level to greyscale mapping database to identify irregularity levels for the first surface of the wood product such as veneer at operation 514, process flow proceeds operation 516.

In one embodiment, at operation 516 a grade is assigned to the wood product such as veneer based on the identified irregularity levels for the wood product such as first surface of the veneer using any of the methods and systems discussed above with respect to FIGS. 4A and 4B, FIGS. 2A through 2F, and corresponding FIGS. 4C through 4H.

Once a grade is assigned to the wood product such as veneer based on the identified irregularity levels for the first surface of the wood product such as veneer at operation 516, process flow proceeds to operation 518. In one embodiment, at operation 518, based at least in part, on the grade assigned to the wood product such as veneer, one or more actions are taken with respect to the wood product such as veneer including, but not limited to, assigning the veneer to a specific veneer stack associated with the grade assigned to the veneer and/or any of the actions discussed above with respect to the methods and systems discussed above with respect to FIGS. 4A and 4B.

As discussed in more detail below, in some embodiments, the selected action of operation 518 is to add the veneer to a specific veneer stack based, at least in part, on the grade assigned to the veneer. As discussed in more detail below, in some embodiments, the selected action is to add the veneer to a specific veneer stack based, at least in part, on the grade assigned to the veneer. In these embodiments, grade assignment data is provided to and action selection and activation module which, in turn, forwards grade assignment data to a selected action implementation module. In one embodiment, the selected action implementation module then forwards the grade assignment data to a stacking system such as any stacking system discussed herein. As discussed in more detail below, in these embodiments, the veneer is then added to a specific veneer stack based, at least in part, on the grade assigned to the veneer.

Once one or more actions with respect to the wood product such as veneer at operation 518, process flow proceeds to END operation 524 where process 500 is exited to await new samples and/or data.

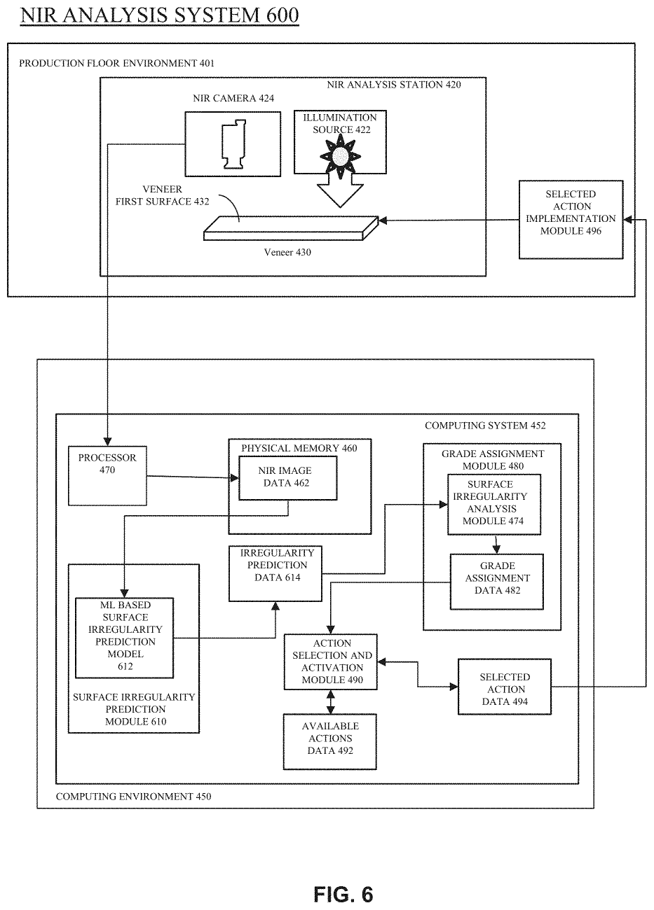

FIG. 6 is simplified block diagram of one embodiment of a NIR analysis system 600 for detecting surface irregularity levels in veneer using NIR technology and machine learning methods in accordance with one embodiment.

In one embodiment, system 600, like NIR analysis system 400 of FIGS. 4A and 4B, includes production floor environment 401 and a computing environment 450. As discussed in more detail below, in one embodiment, NIR analysis system 600 is part of a veneer analysis system.

As seen in FIG. 6, like NIR analysis system 400 of FIGS. 4A and 4B, production floor environment 401 includes NIR analysis station 420 and selected action implementation module 496. As seen in FIG. 6, NIR analysis station 420 includes one or more illumination sources, such as illumination source 422, positioned to illuminate a veneer first surface 432 of veneer 430. In various embodiments, the one or more sources of illumination, such as illumination source 422, can include one or more LED light sources. In other embodiments, the one or more illumination sources, such as illumination source 422, can include, but are not limited to, halogen or halogen and tungsten light sources, or any other light sources, as discussed herein, and/or as known in the art at the time of filing, and/or as developed after the time of filing.

As seen in FIG. 6, NIR analysis station 420 also includes one or more NIR cameras, such as NIR camera 424, positioned to capture NIR image data 462 representing one or more NIR images of the illuminated veneer first surface 432 of the veneer 430. In one embodiment, one or more NIR cameras, such as NIR camera 424, are adjustably positioned and adjustably focused to capture one or more NIR images of the illuminated veneer first surface 432 of the veneer 430.

As seen in FIG. 6, the veneer 430 to be analyzed in the NIR analysis station 420 is positioned in NIR analysis station 420. In various embodiments, the veneer 430 can be any veneer as discussed herein, and/or as known in the art at the time of filing, and/or as becomes known after the time of filing. In one embodiment, the veneer 430 to be analyzed is a veneer sheet.

In one embodiment, the veneer 430 to be analyzed is positioned such that the veneer first surface 432 of the veneer 430 to be analyzed is illuminated by the illumination source 422 and is within view and focus of NIR camera 424. In one embodiment, the veneer 430 is positioned in the NIR analysis station 420 by passing the veneer 430 through the NIR analysis station 420 on a conveyor system (not shown).

As seen in FIG. 6, like NIR analysis system 400 of FIGS. 4A and 4B, computing environment 450 includes computing system 452. However, unlike NIR analysis system 400 of FIGS. 4A and 4B, in one embodiment, computing system 452 of system 600 does not include surface irregularity to greyscale mapping database 410 but instead includes surface irregularity prediction module 610.

In one embodiment, surface irregularity prediction module 610 includes one or more trained Machine Learning (ML) based surface irregularity prediction models, such as Machine Learning (ML) based surface irregularity prediction model 612. In various embodiments the one or more trained machine learning based surface irregularity prediction models, such as machine learning based surface irregularity prediction model 612, are trained using NIR image data for one or more full veneer sheet, veneer strip, and/or partial veneer sheets and corresponding determined irregularity levels for the one or more full veneer sheet, veneer strip, and/or partial veneer sheets.

Various types of machine learning based models are well known in the art. Consequently, the one or more trained machine learning based surface irregularity prediction models, such as machine learning based surface irregularity prediction model 612, can be any machine learning based model type or use any machine learning based algorithm, as discussed herein, and/or as known in the art at the time of filing, and/or as becomes known or available after the time of filing.

Specific illustrative examples of machine learning based model types and machine learning based algorithms that can be used for, or with, the one or more trained machine learning based surface irregularity prediction models of surface irregularity prediction module 610, such as machine learning based surface irregularity prediction model 612, include, but are not limited to: supervised machine learning-based models; semi-supervised machine learning-based models; unsupervised machine learning-based models; classification machine learning-based models; logistical regression machine learning-based models; neural network machine learning-based models; and deep learning machine learning-based models.

In various embodiments, and largely depending on the machine-learning based models used, the NIR image data for one or more full veneer sheet, veneer strip, and/or partial veneer sheets, including in some cases various environmental and production parameters, and corresponding determined irregularity levels for the one or more full veneer sheet, veneer strip, and/or partial veneer sheets can be processed using various methods known in the machine learning arts to identify elements and vectorize the NIR image data and/or corresponding determined irregularity levels data. As a specific illustrative example, in a case where the machine learning based model is a supervised model, the NIR image data can be analyzed and processed into elements found to be indicative of veneer irregularity levels, product failures, and product performance. Then these elements are used to create vectors in multidimensional space which are, in turn, used as input data for one or more machine learning models. The correlated determined irregularity levels, product failures, and product performance data for each NIR image data vector is then used as a label for the resulting vector. This process is repeated for multiple, often millions, of correlated pairs of NIR image data vector and determined irregularity levels, product failures, and product performance data with the result being one or more trained machine learning based surface irregularity prediction models.

Then when new NIR image data is obtained, this new NIR image data is also vectorized and the new NIR image vector data is provided as input data to the one or more trained machine learning based surface irregularity prediction models. The new NIR image vector data is then processed to find a distance between the new NIR image vector and previously labeled NIR image vectors, whose associated irregularity level data is known. Based on a calculated distance between the new NIR image vector data and the previously labeled NIR image vector data, a probability that the new NIR image vector data correlates to an irregularity level, product failure, or product performance associated with the previously labeled NIR image vector data can be calculated. This results in a probability score for the veneer being analyzed.

Those of skill in the art will readily recognize that there are many different types of machine learning based models known in the art. Consequently, the specific illustrative example of a specific supervised machine learning based model discussed above is not limiting.

As seen in FIG. 6, computing system 452 also includes physical memory 460. In one embodiment, the physical memory 460 includes NIR image data 462 representing one or more NIR images of the illuminated veneer first surface 432 of the veneer 430 captured using NIR camera 424.

As seen in FIG. 6, in one embodiment, computing system 452 includes one or more processors, such as processor 470, for generating the NIR image data 462 representing one or more NIR images of the illuminated veneer first surface 432 of the veneer 430 from NIR camera 424.

In one embodiment, NIR image data 462 is provided to surface irregularity prediction module 610 where it is processed/vectorized and provided to machine learning based irregularity level prediction model 612.

Machine learning based irregularity level prediction model 612 then processes the vectorized NIR image data 462 as discussed above and generates irregularity prediction data 614 for the veneer 430.

As seen in FIG. 6, irregularity prediction data 614 for the veneer 430 is then provided to grade assignment module 480. As discussed above, grade assignment module 480 then assigns a grade to the veneer 430 based on irregularity prediction data 614 for the veneer 430.

As seen in FIG. 6, grade assignment module 480 includes surface irregularity analysis module 474 which, along with processor 470, processes irregularity prediction data 614 for the veneer 430 and generates grade assignment data 482 based on this processing

As seen in FIG. 6, in one embodiment, grade assignment data 482 is provided to action selection and activation module 490 which selects an appropriate action of the actions represented in available actions data 492 based, at least in part on the grade indicated by grade assignment data 482. As seen in FIG. 6, in one embodiment, the determined appropriate action is represented by selected action data 494.

As seen in FIG. 6, in one embodiment, selected action data 494 is forwarded to an action activation module, such as selected action implementation module 496 in production floor environment 401, to initialize one or more actions with respect to the veneer 430 based, at least in part, on the grade represented by grade assignment data 482 and assigned to the veneer 430 by action selection and activation module 490 including, but not limited to, assigning the veneer 430 to a specific veneer stack associated with the grade assigned to the veneer.

As discussed in more detail below, in some embodiments, the selected action indicated by selected action data 494 is to add veneer 430 to a specific veneer stack based, at least in part, on the grade represented by grade assignment data 482 and assigned to the veneer 430. In these embodiments, grade assignment data 482 is provided to action selection and activation module 490 which, in turn, forwards grade assignment data 482 to selected action implementation module 496. In one embodiment, selected action implementation module 496 then forwards grade assignment data 482 to a stacking system such as any stacking system discussed herein. As discussed in more detail below, in these embodiments, the veneer 430 is then added to a specific veneer stack based, at least in part, on the grade represented by grade assignment data 482 and assigned to the veneer 430.

In one embodiment, one or more actions that can be taken represented in available actions data 492 can also include, but are not limited to: sorting veneer 430 into a bin or location based, at least in part, on the grade represented by grade assignment data 482 and assigned to the veneer 430; restricting the use of the veneer 430 based, at least in part, on the grade represented by grade assignment data 482 and assigned to the veneer 430; rejecting the veneer 430 based, at least in part, on the grade represented by grade assignment data 482 and assigned to the veneer 430; sending the veneer 430 back for further processing based, at least in part, on the grade represented by grade assignment data 482 and assigned to the veneer 430; adjusting one or more processing parameters of a production line based, at least in part, on the grade represented by grade assignment data 482 and assigned to the veneer 430 and one or more similarly graded similar full veneer sheet, veneer strip, and/or partial veneer sheets; adjusting one or more preconditioning parameters on a production line based, at least in part, on the grade represented by grade assignment data 482 and assigned to the veneer 430 and/or one or more similarly graded full veneer sheet, veneer strip, and/or partial veneer sheets; adjusting one or more veneer cutting parameters on a production line based, at least in part, on the grade represented by grade assignment data 482 and assigned to the veneer 430 and/or one or more similarly graded full veneer sheet, veneer strip, and/or partial veneer sheets; and selecting a type and amount of glue used on a production line in production floor environment 401 based, at least in part, on the grade represented by grade assignment data 482 and assigned to the veneer 430 and/or the grades assigned other full veneer sheet, veneer strip, and/or partial veneer sheets.

Those of skill in the art will ready recognize that the specific illustrative example of one embodiment of FIG. 6 is but one example of numerous possible production environments and arrangement of components. Consequently, the specific illustrative example of one embodiment shown in FIG. 6 is not intended to limit the scope of the invention as set forth in the claims below.

As a specific illustrative example of possible variations, in some embodiments, the NIR analysis station 420 can include one or more illumination sources 422 positioned to illuminate two or more surfaces of veneer and one or more NIR cameras 424 positioned to capture one or more NIR images of the two or more illuminated surfaces of the veneer.

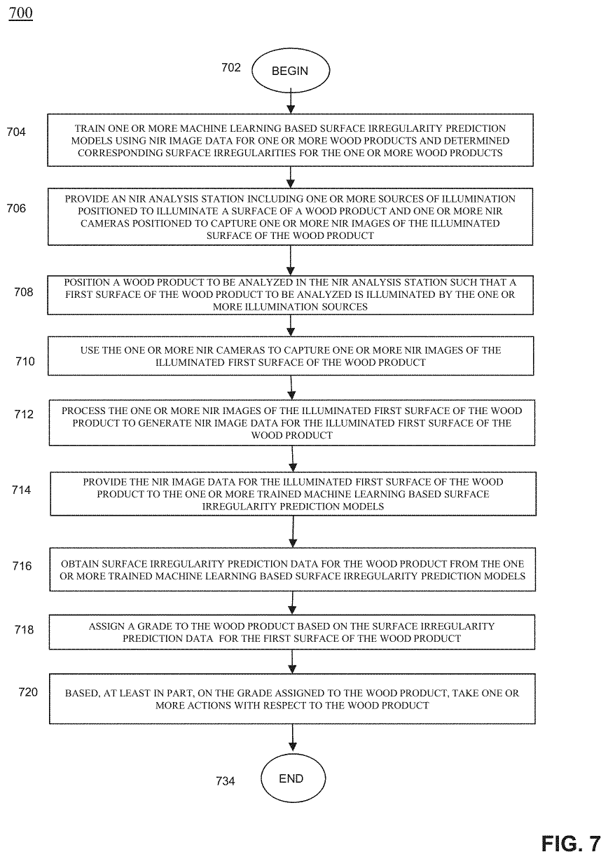

FIG. 7 is flow chart of a process 700 for detecting surface irregularity levels in wood product such as a veneer using NIR technology and machine learning methods in accordance with one embodiment.

As seen in FIG. 7, process 700 begins at BEGIN operation 702 and then process proceeds to operation 704. In one embodiment, at operation 704 one or more machine learning based surface irregularity prediction models are trained using NIR image data for one or more full veneer sheet, veneer strip, and/or partial veneer sheets and determined corresponding irregularity levels and/or failures for the one or more full veneer sheets, veneer strips, and/or partial veneer sheets by any of the systems or methods discussed above with respect to FIG. 6.

In one embodiment, once one or more machine learning based surface irregularity prediction models are trained using NIR image data for one or more full veneer sheet, veneer strip, and/or partial veneer sheets and determined corresponding irregularity levels for the one or more full veneer sheet, veneer strip, and/or partial veneer sheets at operation 704, process flow proceeds to operation 706.

At operation 706, an NIR analysis station is provided. In one embodiment, the NIR analysis station is substantially similar to any NIR analysis station discussed above with respect to FIGS. 4A, 4B, and 6, FIGS. 2A through 2F, and corresponding FIGS. 4C through 4H. As discussed above, in one embodiment, the NIR analysis station includes one or more sources of illumination positioned to illuminate a surface of veneer and one or more NIR cameras positioned to capture one or more NIR images of the illuminated surface of the veneer.

Once an NIR analysis station is provided at operation 706, process flow proceeds to operation 708. In one embodiment, at operation 708, veneer to be analyzed is positioned in the NIR analysis station of operation 706 such that a first surface of the veneer to be analyzed is illuminated by the one or more illumination sources using any of the methods and systems discussed above with respect to FIGS. 4A, 4B, and 6, FIGS. 2A through 2F, and corresponding FIGS. 4C through 4H.

Once the veneer to be analyzed is positioned in the NIR analysis station at 708, process flow proceeds to operation 710. In one embodiment, at operation 710 the one or more NIR cameras of NIR analysis station take one or more NIR images of the illuminated first surface of the veneer using any of the methods and systems discussed above with respect to FIGS. 4A, 4B, and 6, FIGS. 2A through 2F, and corresponding FIGS. 4C through 4H.

Once the one or more NIR cameras of NIR analysis station take one or more NIR images of the illuminated first surface of the veneer at operation 710, process flow proceeds to operation 712.

In one embodiment, at operation 712, the one or more NIR images of the illuminated first surface of the veneer of operation 710 are processed, using any of the methods and systems discussed above with respect to FIGS. 4A, 4B, and 6, FIGS. 2A through 2F, and corresponding FIGS. 4C through 4H, to generate NIR image data such as any NIR image data discussed above with respect to FIGS. 4A, 4B, and 6, FIGS. 2A through 2F, and corresponding FIGS. 4C through 4H.

Once the one or more NIR images of the illuminated first surface of the veneer are processed to generate NIR image data at operation 712, process flow proceeds to operation 714.

In one embodiment, at operation 714 the NIR image data for the illuminated first surface of the veneer of operation 712 is processed and provided to the one or more trained machine learning based surface irregularity prediction models using any of the methods and systems discussed above with respect to FIGS. 4A, 4B, and 6, FIGS. 2A through 2F, and corresponding FIGS. 4C through 4H.

Once the NIR image data for the illuminated first surface of the veneer is processed and provided to the one or more trained machine learning based surface irregularity prediction models at operation 714, process flow proceeds to process 716.

In one embodiment, at operation 716 the one or more trained machine learning based surface irregularity prediction models generate irregularity prediction data for the veneer using any of the methods and systems discussed above with respect to FIG. 6.

Once irregularity prediction data for the veneer is obtained from the one or more trained machine learning based surface irregularity prediction models at operation 716, process flow proceeds to operation 718.

In one embodiment, at operation 718, a grade is assigned to the veneer based on the surface irregularity prediction data for the veneer at operation 716 using any of the methods and systems discussed above with respect to FIGS. 4A, 4B, and 6.

Once a grade is assigned to the veneer based on the surface irregularity prediction data for the veneer at operation 718, process flow proceeds to operation 720. In one embodiment, at operation 720, based, at least in part, on the grade assigned to the veneer, one or more actions are taken with respect to the veneer including any of the actions discussed above with respect to the methods and systems discussed above with respect to FIGS. 4A, 4B, and 6.

As discussed in more detail below, in some embodiments, the selected action of operation 720 is to add the veneer to a specific veneer stack based, at least in part, on the grade assigned to the veneer. As discussed in more detail below, in some embodiments, the selected action is to add the veneer to a specific veneer stack based, at least in part, on the grade assigned to the veneer. In these embodiments, grade assignment data is provided to and action selection and activation module which, in turn, forwards grade assignment data to a selected action implementation module. In one embodiment, the selected action implementation module then forwards the grade assignment data to a stacking system such as any stacking system discussed herein. As discussed in more detail below, in these embodiments, the veneer is then added to a specific veneer stack based, at least in part, on the grade assigned to the veneer.

Once one or more actions with respect to the veneer at operation 720, process flow proceeds to END operation 734 where process 700 is exited to await new samples and/or data.

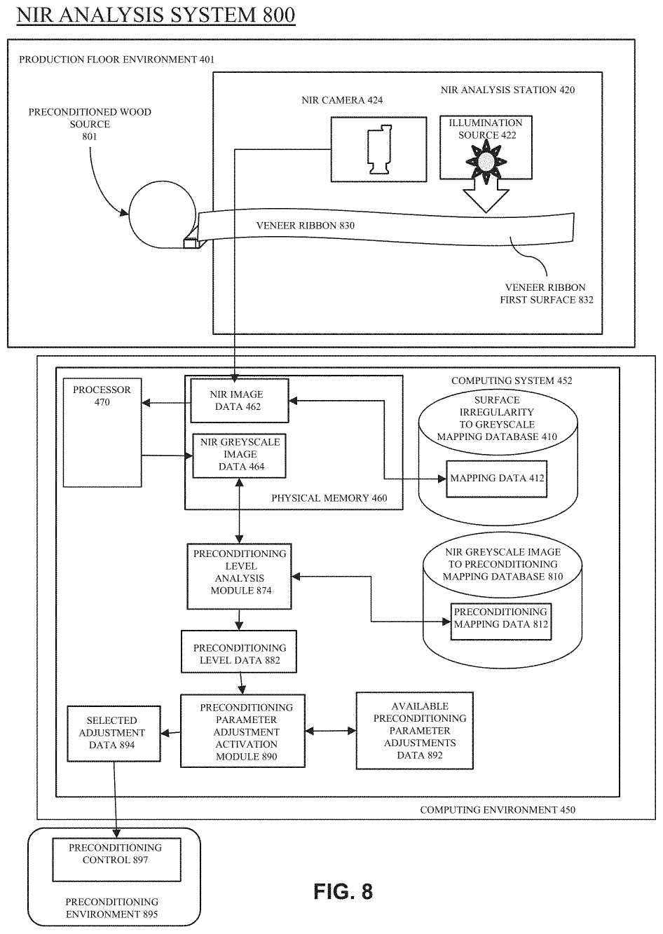

FIG. 8 is simplified block diagram of one embodiment of an NIR analysis system 800 for adjusting a preconditioning process of wood sources used to produce full veneer sheet, veneer strip, and/or partial veneer sheets based on NIR imagery of a first surface of the full veneer sheet, veneer strip, and/or partial veneer sheets in accordance with one embodiment.

As with NIR analysis system 400 discussed above with respect to FIG. 3A, in one embodiment, system 800 includes production floor environment 401 and computing environment 450. As seen in FIG. 8, production floor environment 401 includes NIR analysis station 420. As seen in FIG. 8, NIR analysis station 420 includes one or more illumination sources, such as illumination source 422, positioned to illuminate a surface of veneer ribbon 830. In various embodiments, the one or more illumination sources, such as illumination source 422, can include one or more LED light sources. In other embodiments, the one or more illumination sources, such as illumination source 422, can include, but are not limited to, halogen, halogen and tungsten light sources, or any other light sources, as discussed herein, and/or as known in the art at the time of filing, and/or as developed after the time of filing.

As with NIR analysis system 400 discussed above with respect to FIG. 3A, in FIG. 8, NIR analysis station 420 also includes one or more NIR cameras, such as NIR camera 424, positioned to capture NIR image data 462 representing one or more NIR images of the illuminated veneer ribbon 830. In one embodiment, the one or more NIR cameras, such as NIR camera 424, are adjustably positioned and adjustably focused to capture any desired one or more NIR images of the illuminated surface of the veneer ribbon 830.

As seen in FIG. 8, and as discussed below the veneer ribbon 830 to be analyzed in the NIR analysis station 420 is positioned in NIR analysis station 420. In the specific illustrative example of FIG. 8, the veneer ribbon 830 is a veneer ribbon 830 rotary cut from preconditioned wood source 801, such as a preconditioned peeler log.

In one embodiment, the veneer ribbon 830 to be analyzed is positioned such that a veneer ribbon first surface 832 of the veneer ribbon 830 to be analyzed is illuminated by the illumination source 422 and the sample portion or entire veneer ribbon first surface 832 is within view and focus of NIR camera 424. In one embodiment, the veneer ribbon 830 is positioned in the NIR analysis station 420 by passing the veneer ribbon 830 through the NIR analysis station 420 on a conveyor system.

In various embodiments, the one or more NIR cameras, such as NIR camera 424, can be of any resolution desired. As noted above, when the one or more NIR cameras, such as NIR camera 424, are used to scan the veneer ribbon first surface 832 of a veneer ribbon 830 for irregularities and create an NIR image data 462 of the veneer ribbon first surface 832, essentially each pixel generated by NIR camera 424 is a sample point. Consequently, the resolution and accuracy of the surface irregularity detection process is only limited by the number of pixels the NIR camera 424 has covering the field of view, e.g., the entire veneer ribbon first surface 832 of veneer ribbon 830. Consequently, in the case where NIR camera 424 is a 1.3 mega pixel camera, there are essentially 1,400,000 individual measurement points on the veneer ribbon first surface 832. In addition, NIR wavelengths are in the range of 750 nanometers (nm) to 4500 nm which are much smaller that the visible wavelengths of 480 to 740 nm. Consequently, using NIR cameras, such as NIR camera 424, results in resolutions and accuracy that simply cannot be achieved using traditional surface magnified visual image methods.

Therefore, using NIR cameras, such as NIR camera 424, system 800 is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished veneer.

As seen in FIG. 8, computing environment 450 includes computing system 452. As seen in FIG. 8, in one embodiment, computing system 452 includes surface irregularity to greyscale mapping database 410 containing mapping data 412 that maps surface irregularities to Near InfraRed (NIR) image greyscale values for veneer.

As discussed in some detail above with respect to FIG. 4A, using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer ribbon first surface 832 of veneer ribbon 830, more NIR energy is reflected from surfaces that are perpendicular the NIR camera lens. Consequently, at locations having irregularities such that the surfaces are not perpendicular the NIR camera lens will appear darker, i.e., have a greater greyscale value.

When the NIR camera 424 takes an image of the veneer ribbon first surface 832, the NIR camera 424 picks up the NIR energy reflected off veneer ribbon first surface 832 at approximately 90 degrees. Consequently, when the NIR camera 424 takes an image of the veneer ribbon first surface 832, the areas of irregularities, which scatter more NIR energy at angles other than 90 degrees and therefore reflect less NIR energy, appear darker than dry areas. In addition, the higher or more significant the irregularities that are present, the darker the area appears because less NIR energy is reflected to be captured by the NIR camera 424.

Using this fact, NIR image data 462 captured by the NIR camera 424 can be processed into NIR greyscale image data 464. Greyscale images can be of varying resolution, or bit, types. A 16-bit integer grayscale image provides 65535 available tonal steps from 0 (black) to 65535 (white). A 32-bit integer grayscale image theoretically will provide 4,294,967,295 tonal steps from 0 (black) to 4294967295 (white). Converting an NIR image based on these number of greyscale tonal steps results in a margin of error of significantly less than 0.1%.

In some embodiments, two or more NIR cameras are utilized, such as NIR camera 424, that are operated at different NIR frequencies and/or that are positioned a different angles with respect to veneer ribbon first surface 832. This allows different types and levels of irregularities to be detected. In addition, using two or more NIR cameras, such as NIR camera 424, that are positioned at different angles means that different irregularities will have surfaces perpendicular to the camera lens and therefore will yield a 3-D effect when a composite NIR image is constructed. A more detailed discussion of a one example of a multi-NIR camera system is discussed above with respect to FIG. 3B.

Returning to FIG. 8, and using the concepts discussed above, the mapping data 412 of surface irregularity to greyscale mapping database 410 is obtained through one or more empirical and/or manual processes, as discussed above with respect to FIG. 4A.

As discussed above, FIGS. 4C to 4H are illustrative examples of NIR images of surfaces of veneer produced under various optimal and non-optimal production parameters. In the specific examples of FIGS. 4C to 4H the NIR image illustrations of 4C, 4D, 4E, 4F, 4G and 4H, correlate to the magnified visual image illustrations of FIGS. 2A, 2B, 2C, 2D, 2E and 2F, respectively.

Returning the FIG. 8, computing system 452 also includes NIR greyscale image to preconditioning mapping database. In one embodiment, NIR greyscale image to preconditioning mapping database 810 include preconditioning mapping data 812 that maps NIR greyscale images to particular preconditioning parameters and issues based on known data obtained from known condition greyscale images, such as images 4C, 4D, and 4E.

Computing system 452 also includes physical memory 460. In one embodiment, the physical memory 460 includes NIR image data 462 representing one or more NIR images of the illuminated veneer ribbon first surface 832 of the veneer ribbon 830 captured using NIR camera 424. Physical memory 460 also includes NIR greyscale image data 464. In one embodiment, computing system 452 includes one or more processors 470 for processing the NIR image data representing one or more NIR images of the illuminated veneer ribbon first surface 832 of the veneer ribbon 830 to generate NIR greyscale image data 464 indicating different irregularity levels in the illuminated veneer ribbon first surface 832 of the veneer ribbon 830.

In one embodiment, processor 470 processes the NIR greyscale image data 464 using the mapping data 412 from surface irregularity to greyscale mapping database 410 to identify irregularity levels for the veneer ribbon first surface 832 of the veneer ribbon 830.

As seen in FIG. 8, in one embodiment, computing system 452 includes a preconditioning level analysis module 874 which analyzes preconditioning mapping data 812 and NIR greyscale image data 464 to determine a preconditioning parameter level represented by preconditioning level data 882. In various embodiments, preconditioning level data 882 determines which, if any, preconditioning parameters must be readjusted to adjust the preconditioning levels of subsequent wood sources.

Available preconditioning parameter adjustments data 892 includes data representing the available precondition adjustments such as, adjusting of chemical composition of the caustic water mix by adding or subtracting chemical or changing chemical; adjusting the temperature of the caustic water mix; or adjusting the soak time for preconditioned wood source 801, such as logs, in the vats of caustic water mix. The determined preconditioning parameter adjustment is then represented by preconditioning level data 882.

In some embodiments, preconditioning level analysis module 874 includes one or more machine learning based models such as any machine learning based models discussed herein, and/or as known in the art at the time of filing, and/or as become known/available after the time of filing.

For instance, based on the analysis of NIR greyscale image data 464 and preconditioning mapping data 812, preconditioning level analysis module 874 may determine a probability that the chemical used, or amount of chemical used in the preconditioning vat soak needs to be adjusted. Likewise, based on the analysis of NIR greyscale image data 464 and preconditioning mapping data 812, preconditioning level analysis module 874 may determine that the preconditioning vat soak time needs to be adjusted. Similarly, based on the analysis of NIR greyscale image data 464 and preconditioning mapping data 812, preconditioning level analysis module 874 may determine that the preconditioning temperature needs to be adjusted. In some cases, based on the analysis of NIR greyscale image data 464 and preconditioning mapping data 812, preconditioning level analysis module 874 may determine any combination, or all, of these preconditioning parameters, or other preconditioning parameters, need to be adjusted.

In various embodiments, the adjustments determined to be necessary by preconditioning level analysis module 874 are then represented by preconditioning level data 882 which is used to adjust the preconditioning parameters for subsequent wood sources. Once generated by preconditioning level analysis module 874, preconditioning level data 882 is provided to preconditioning parameter adjustment activation module 890 which generates selected adjustment data 894.

In various embodiments, selected adjustment data is then transferred to preconditioning control 897 in preconditioning environment 895 where the adjustments determined to be necessary by preconditioning level analysis module 874 are implemented. These can include one or more of: adjusting of chemical composition of the caustic water mix by adding or subtracting chemical or changing chemical; adjusting the temperature of the caustic water mix; or adjusting the soak time for preconditioned wood source 801, such as logs, in the vats of caustic water mix.

Using system 800 the preconditioning process so critical to veneer ribbon 830 production is adjusted dynamically using feedback based on actual veneer ribbon, veneer NIR surface image analysis. Consequently, using system 800, finding the best combination of chemical composition of the caustic water mix, temperature of the caustic water mix, and soak time for the logs in the vats of caustic water mix is more accurately determined based on empirical and relative real-time data. As a result, accurate adjustments can be made to minimize wasted product and maximize product value.

Those of skill in the art will ready recognize that the specific illustrative examples of one embodiment of a production floor environment 401 and components shown in FIG. 8 are but specific examples of numerous possible production environments and arrangement of physical components. Consequently, the specific illustrative example of an embodiment of a production floor environment 401 and components shown in FIG. 8 is not intended to limit the scope of the invention as set forth in the claims below.

As a specific illustrative example of potential variations, in various embodiments, the NIR analysis station 420 can include one or more illumination sources 422 positioned to illuminate two or more surfaces of veneer and one or more NIR cameras 424 positioned to capture one or more NIR images of the two or more illuminated surfaces of the veneer ribbon 830.

As a further specific illustrative example of variations possible, additional input data can be considered such as current ambient temperature and humidity. The combination of these parameters can be analyzed by an AI/ML algorithm to further refine the production parameters for overall process efficiency.

These and numerous other variations are possible and contemplated by the inventors to be within the scope of the invention as set forth in the claims below.

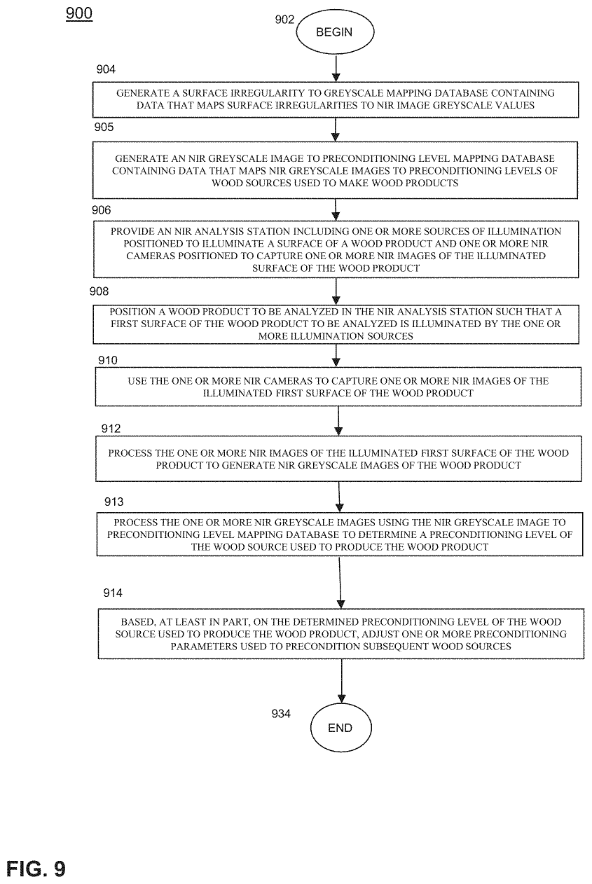

FIG. 9 is flow chart of a process 900 for adjusting a preconditioning process of wood sources used to produce veneer based on a level of irregularity of a first surface of the veneer in accordance with one embodiment.

As seen in FIG. 9, process 900 begins at BEGIN operation 902 and then process proceeds to operation 904. In one embodiment, at operation 904 a surface irregularity level to greyscale mapping database is generated such as any database discussed above with respect to FIG. 3A, FIG. 8, FIGS. 2A through 2C, and corresponding FIGS. 4C through 4H. In one embodiment, the surface irregularity level to greyscale mapping database contains mapping data that maps surface irregularities to Near InfraRed (NIR) image greyscale values for one or more veneer.

Once a surface irregularity level to greyscale mapping database is generated at operation 904, process flow proceeds to operation 905. In one embodiment, at operation 905 an NIR greyscale image to preconditioning level mapping database is generated using any of the methods and systems discussed above with respect to FIG. 8.

Once an NIR greyscale image to preconditioning level mapping database is generated at operation 905, process flow proceeds to operation 906. At operation 906, an NIR analysis station is provided. In one embodiment, the NIR analysis station is substantially similar to any NIR analysis station discussed above with respect to FIGS. 4A, 4B, and 8. As discussed above, in one embodiment, the NIR analysis station includes one or more sources of illumination positioned to illuminate a surface of the veneer and one or more NIR cameras positioned to capture one or more NIR images of the illuminated surface of the veneer.

Once an NIR analysis station is provided at operation 906, process flow proceeds to operation 908. In one embodiment, at operation 908, the veneer to be analyzed is positioned in the NIR analysis station of operation 906 such that a first surface of the veneer to be analyzed is illuminated by the one or more illumination sources using any of the methods and systems discussed above with respect to FIG. 4A, FIG. 8, FIGS. 2A through 2C, and corresponding FIGS. 4C through 4H.

Once the veneer to be analyzed is positioned in the NIR analysis station at 908, process flow proceeds to operation 910. In one embodiment, at operation 910 the one or more NIR cameras of NIR analysis station take one or more NIR images of the illuminated first surface of the veneer using any of the methods and systems discussed above with respect to FIGS. 3A, 3B and 8.

Once the one or more NIR cameras of NIR analysis station take one or more NIR images of the illuminated first surface of the veneer at operation 910, process flow proceeds to operation 912.

In one embodiment, at operation 912, the one or more NIR images of the illuminated first surface of the veneer of operation 910 are processed using any of the methods and systems discussed above with respect to FIGS. 4A, 4B, FIG. 8, FIGS. 2A through 2C, and corresponding FIGS. 4C through 4H, to generate NIR greyscale images indicating different irregularity levels in the illuminated first surface of the veneer.

Once the one or more NIR images of the illuminated first surface of the veneer are processed to generate NIR greyscale images indicating different irregularity levels in the illuminated first surface of the veneer at operation 912, process flow proceeds to operation 913.

In one embodiment, at operation 913, the NIR greyscale images are processed using NIR greyscale image to preconditioning level mapping database to determine a preconditioning level and preconditioning parameter adjustments using any of the methods and systems discussed above with respect to FIGS. 4A and 4B, FIG. 8, FIGS. 2A through 2C, and corresponding FIGS. 4C through 4H.

Once the NIR greyscale images are processed using NIR greyscale image to preconditioning level mapping database to determine a preconditioning level and preconditioning parameter adjustments at operation 913, process flow proceeds to operation 914.

In one embodiment, at operation 914 any preconditioning parameters that it is determined must be adjusted are adjusted via one or more actions such as any actions discussed above with respect to FIG. 8.

Once any preconditioning parameters that it is determined must be adjusted are adjusted at operation 914, process flow proceeds to END operation 934 where process 900 is exited to await new samples and/or data.

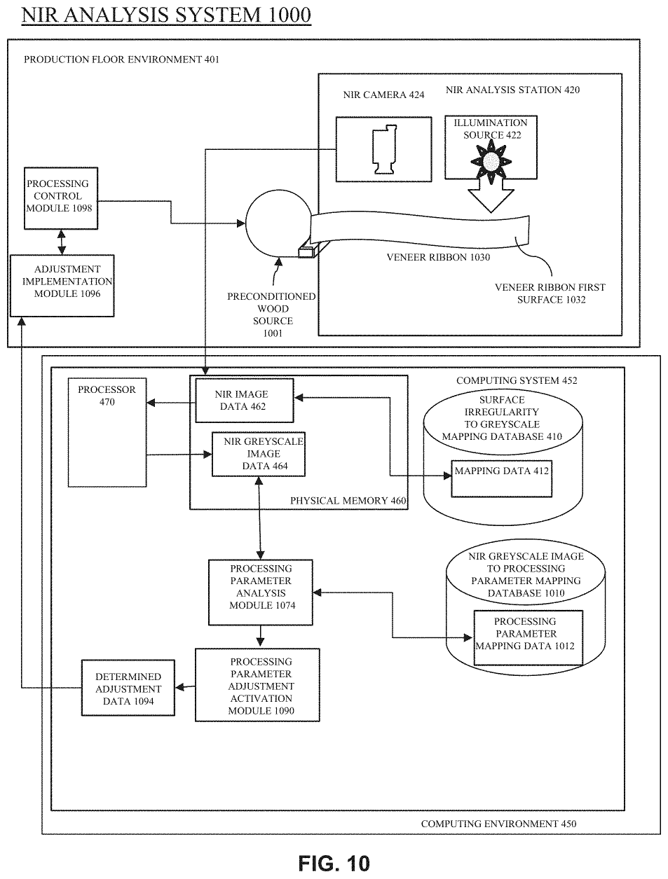

FIG. 10 is simplified block diagram of a system 1000 for adjusting processing parameters used to produce a veneer ribbon 1030 from a wood source based on a NIR images of a surface of the veneer ribbon 1030 in accordance with one embodiment.

As with NIR analysis system 400 discussed above with respect to FIG. 4A, in one embodiment, NIR analysis system 1000 includes production floor environment 401 and computing environment 450. As seen in FIG. 10, production floor environment 401 includes NIR analysis station 420. As seen in FIG. 10, NIR analysis station 420 includes one or more illumination sources, such as illumination source 422, positioned to illuminate a surface of veneer ribbon 1030. In various embodiments, the one or more illumination sources, such as illumination source 422, can include one or more LED light sources. In other embodiments, the one or more illumination sources, such as illumination source 422, can include, but are not limited to, halogen, halogen and tungsten light sources, or any other light sources, as discussed herein, and/or as known in the art at the time of filing, and/or as developed after the time of filing.

As with NIR analysis system 400 discussed above with respect to FIG. 4A, in FIG. 10, NIR analysis station 420 also includes one or more NIR cameras, such as NIR camera 424, positioned to capture NIR image data 462 representing one or more NIR images of the illuminated surface of the veneer ribbon 1030. In one embodiment, the one or more NIR cameras, such as NIR camera 424, are adjustably positioned and adjustably focused to capture any desired one or more NIR images of the illuminated surface of the veneer ribbon 1030.

As seen in FIG. 10, and as discussed below, the veneer to be analyzed in the NIR analysis station 420 is positioned in NIR analysis station 420. In the specific illustrative example of FIG. 10, veneer ribbon 1030 is rotary cut from preconditioned wood source 1001, such as a preconditioned peeler log.

In one embodiment, the veneer ribbon 1030 to be analyzed is positioned such that a veneer ribbon first surface 1032 of the veneer ribbon 1030 to be analyzed is illuminated by the illumination source 422 and a sample portion of veneer ribbon first surface 1032 is within view and focus of NIR camera 424. In one embodiment, the veneer ribbon 1030 is positioned in the NIR analysis station 420 by passing the veneer ribbon 1030 through the NIR analysis station 420 on a conveyor system.

In various embodiments, the one or more NIR cameras, such as NIR camera 424, can be of any resolution desired. As noted above, when the one or more NIR cameras, such as NIR camera 424, are used to scan the veneer ribbon first surface 1032 of a veneer ribbon 1030 for irregularities and create an NIR image data 462 of the veneer ribbon first surface 1032, essentially each pixel generated by NIR camera 424 is a sample point. Consequently, the resolution and accuracy of the surface irregularity detection process is only limited by the number of pixels the NIR camera 424 has covering the field of view, e.g., the entire veneer ribbon first surface 1032 of veneer ribbon 1030. Consequently, in the case where NIR camera 424 is a 1.3 mega pixel camera, there are essentially 1,400,000 individual measurement points on the veneer ribbon first surface 1032. In addition, NIR wavelengths are in the range of 750 nanometers (nm) to 4500 nm which are much smaller that the visible wavelengths of 480 to 740 nm. Consequently, using NIR cameras, such as NIR camera 424, results in resolutions and accuracy that simply cannot be achieved using traditional surface magnified visual image methods.

Therefore, using NIR cameras, such as NIR camera 424, system 1000 is capable of detecting irregularities in a wide range of samples sizes ranging from of a traditional 2″×2″ square, to a full 4′×10′ sheet or panel surface, and, by using a series of NIR images spliced together, up to a 100′-120′ ribbon of material. This, in turn, allows the disclosed embodiments to be implemented without significantly slowing down the production process or increasing the cost of the finished veneer.

As seen in FIG. 10, in this specific illustrative example, production floor environment 401 also includes adjustment implementation module 1096 for making relative real time adjustment to processing parameters for preconditioned wood source 1001 to generate veneer ribbon 1030 and processing control module 1098 which controls the processing of preconditioned wood source 1001 to generate veneer ribbon 1030.

As seen in FIG. 10, computing environment 450 includes computing system 452. As seen in FIG. 10, in one embodiment, computing system 452 includes surface irregularity to greyscale mapping database 410 containing mapping data 412 that maps surface irregularities to Near InfraRed (NIR) image greyscale values for one or more full veneer sheet, veneer strip, and/or partial veneer sheets.

As noted above with respect to FIG. 4A, using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer ribbon first surface 1032 of veneer ribbon 1030, more NIR energy is reflected from surfaces that are perpendicular the NIR camera lens. Consequently, at locations having irregularities such that the surfaces are not perpendicular the NIR camera lens will appear darker, i.e., have a greater greyscale value.

When the NIR camera 424 takes an image of the veneer ribbon first surface 1032, the NIR camera 424 picks up the NIR energy reflected off veneer ribbon first surface 1032 at approximately 90 degrees. Consequently, when the NIR camera 424 takes an image of the veneer ribbon first surface 1032, the areas of irregularities, which scatter more NIR energy at angles other than 90 degrees and therefore reflect less NIR energy, appear darker than dry areas. In addition, the higher or more significant the irregularities that are present, the darker the area appears because less NIR energy is reflected to be captured by the NIR camera 424.

Using this fact, NIR image data 462 captured by the NIR camera 424 can be processed into NIR greyscale image data 464. Greyscale images can be of varying resolution, or bit, types. A 16-bit integer grayscale image provides 65535 available tonal steps from 0 (black) to 65535 (white). A 32-bit integer grayscale image theoretically will provide 4,2114,1167,2115 tonal steps from 0 (black) to 4211411672115 (white). Converting an NIR image based on these number of greyscale tonal steps results in a margin of error of significantly less than 0.1%.

In some embodiments, two or more NIR cameras are utilized, such as NIR camera 424, that are operated at different NIR frequencies and/or that are positioned a different angles with respect to veneer ribbon first surface 1032. This allows different types and levels of irregularities to be detected. In addition, using two or more NIR cameras, such as NIR camera 424, that are positioned at different angles means that different irregularities will have surfaces perpendicular to the camera lens and therefore will yield a 3-D effect when a composite NIR image is constructed. A more detailed discussion of a one example of a multi-NIR camera system is discussed above with respect to FIG. 4B.

Returning to FIG. 10, using the concepts discussed above, the mapping data 412 of surface irregularity to greyscale mapping database 410 is obtained through one or more empirical and/or manual processes, as discussed above with respect to FIG. 4A.

As discussed above, FIGS. 4C through 4H are illustrative examples of NIR images of surfaces of veneer produced various optimal and non-optimal production parameters. In the specific examples of FIGS. 4C through 4H the NIR image illustrations of 4C, 4D, 4E, 4F, 4G, and 4H, correlate to the magnified visual image illustrations of FIGS. 2A, 2B, 2C, 2D, 2E and 2F, respectively.

Returning the FIG. 10, computing system 452 also includes NIR greyscale image to processing parameter mapping database 1010. In one embodiment, NIR greyscale image to processing parameter mapping database 1010 includes processing parameter mapping data 1012 that maps NIR greyscale images to particular processing parameters and issues based on known data obtained from known processing greyscale images, such as images 4D, 4E, and 4H.

Computing system 452 also includes physical memory 460. In one embodiment, the physical memory 460 includes NIR image data 462 representing one or more NIR images of the illuminated veneer ribbon first surface 1032 of the veneer ribbon 1030 captured using NIR camera 424. Physical memory 460 also includes NIR greyscale image data 464. In one embodiment, computing system 452 includes one or more processors 470 for processing the NIR image data representing one or more NIR images of the illuminated veneer ribbon first surface 1032 of the veneer ribbon 1030 to generate NIR greyscale image data 464 indicating different irregularity levels and types in the illuminated veneer ribbon first surface 1032 of the veneer ribbon 1030.

In one embodiment, processor 470 processes the NIR greyscale image data 464 using the mapping data 412 from surface irregularity to greyscale mapping database 410 to identify irregularity levels and types for the veneer ribbon first surface 1032 of the veneer ribbon 1030.

As seen in FIG. 10, in one embodiment, computing system 452 includes a processing parameter analysis module 1074 which analyzes processing parameter mapping data 1012 and NIR greyscale image data 464 to determine a processing parameter maladjustment or issue represented by processing parameter mapping data 1012. In various embodiments, processing parameter analysis module 1074 determines which, if any, processing parameters must be changed to adjust the processing of subsequent veneer ribbon 1030 from the same wood source 1001.

In some embodiments, processing parameter analysis module 1074 includes one or more machine learning based models such as any machine learning based models discussed herein, and/or as known in the art at the time of filing, and/or as become known/available after the time of filing.

For instance, based on the analysis of NIR greyscale image data 464 and processing parameter mapping data 1012, processing parameter analysis module 1074 may determine: a knife or other processing component needs replacement; a probability that a rotation speed of a lath turning the wood source 1001 needs adjusting; an angle of a knife used to cut the veneer ribbon 1030 from the wood source 1001 needs adjusting; and a pressure used to keep a knife used to cut veneer ribbon 1030 from the wood source 1001 in contact with a surface of the wood source 1001 needs adjustment or a repair.

Processing parameter analysis module 1074 may determine any combination, or all, of these processing parameters, or other processing parameters, need to be adjusted. In various embodiments, the adjustments determined to be necessary by processing parameter analysis module 1074 are then provided to processing parameter adjustment activation module 1090 which is used to generate determined adjustment data 1094.

In various embodiments, determined adjustment data 1094 is then transferred to adjustment implementation module 1096 in production floor environment 401. Adjustment implementation module 1096 then causes processing control module 1098 to make the desired adjustments to the processing of preconditioned wood source 1001 into veneer ribbon 1030. As noted, these adjustments can include replacing a knife or other processing component; adjusting a rotation speed of a lath turning the wood source 1001; adjusting an angle of a knife used to cut the veneer ribbon 1030 from the wood source 1001; and adjusting or making repairs so that a pressure used to keep a knife used to cut veneer ribbon 1030 from the wood source 1001 in contact with a surface of the wood source 1001.

Using system 1000 the processing parameters so critical to veneer ribbon 1030 production can be adjusted dynamically using feedback based on actual veneer NIR surface image analysis. In one embodiment, these adjustments are made as veneer ribbon 1030 is being created from a single wood source 1001, such as a single preconditioned log. Consequently, using system 1000, provides a technical solution to the long-standing technical problem of adjusting processing parameters for optimal results from a single wood source before significant amounts of defective veneer have been produced to minimize wasted product and maximize product value in relative real time.

Those of skill in the art will ready recognize that the specific illustrative examples of one embodiment of a production floor environment 401 and components shown in FIG. 10 are but specific examples of numerous possible production environments and arrangement of physical components. Consequently, the specific illustrative example of an embodiment of a production floor environment 401 and components shown in FIG. 10 is not intended to limit the scope of the invention as set forth in the claims below.

As a specific illustrative example of potential variations, in various embodiments, the NIR analysis station 420 can include one or more illumination sources 422 positioned to illuminate two or more surfaces of veneer ribbon 1030 and one or more NIR cameras 424 positioned to capture one or more NIR images of the two or more illuminated surfaces of veneer ribbon 1030.

As a further specific illustrative example of variations possible, additional input data can be considered such as current ambient temperature and humidity. The combination of these parameters can be analyzed by an AI/ML algorithm to further refine the production parameters for overall process efficiency.

These and numerous other variations are possible and contemplated by the inventors to be within the scope of the invention as set forth in the claims below.

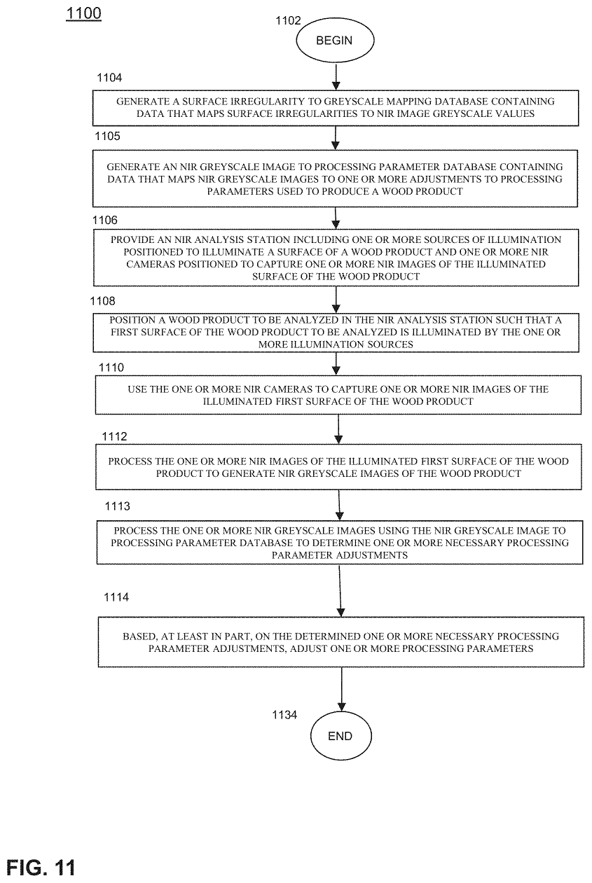

FIG. 11 is a flow chart of a process 1100 for adjusting processing parameters used to produce a veneer ribbon, full veneer sheet, veneer strip, and/or partial veneer sheets from a wood source based on a level of irregularity of a first surface of the veneer ribbon, full veneer sheet, veneer strip, and/or partial veneer sheets in accordance with one embodiment.

As seen in FIG. 11, process 1100 begins at BEGIN operation 1102 and then process proceeds to operation 1104. In one embodiment, at operation 1104 a surface irregularity level to greyscale mapping database is generated such as any database discussed above with respect to FIG. 4A, FIG. 10, FIGS. 2A through 2C, and corresponding FIGS. 4D through 4H. In one embodiment, the surface irregularity level to greyscale mapping database contains mapping data that maps surface irregularities to Near InfraRed (NIR) image greyscale values for veneer.

Once a surface irregularity level to greyscale mapping database is generated at operation 1104, process flow proceeds to operation 1105. In one embodiment, at operation 1105 an NIR greyscale image to processing parameter mapping database is generated using any of the methods and systems discussed above with respect to FIG. 10.

Once an NIR greyscale image to processing parameter mapping database is generated at operation 1105, process flow proceeds to operation 1106. At operation 1106, an NIR analysis station is provided. In one embodiment, the NIR analysis station is substantially similar to any NIR analysis station discussed above with respect to FIGS. 4A, 4B, and 10. As discussed above, in one embodiment, the NIR analysis station includes one or more sources of illumination positioned to illuminate a surface of the veneer and one or more NIR cameras positioned to capture one or more NIR images of the illuminated surface of the veneer.

Once an NIR analysis station is provided at operation 1106, process flow proceeds to operation 1108. In one embodiment, at operation 1108, the veneer to be analyzed is positioned in the NIR analysis station of operation 1106 such that a first surface of the veneer to be analyzed is illuminated by the one or more illumination sources using any of the methods and systems discussed above with respect to FIG. 4A, FIG. 10, FIGS. 2A through 2C, and corresponding FIGS. 4D through 4H.

Once the veneer to be analyzed is positioned in the NIR analysis station at 1108, process flow proceeds to operation 1110. In one embodiment, at operation 1110 the one or more NIR cameras of NIR analysis station take one or more NIR images of the illuminated first surface of the veneer using any of the methods and systems discussed above with respect to FIG. 4A, FIG. 10, FIGS. 2A through 2C, and corresponding FIGS. 4D through 4H.

Once the one or more NIR cameras of NIR analysis station take one or more NIR images of the illuminated first surface of the veneer at operation 1110, process flow proceeds to operation 1112.

In one embodiment, at operation 1112, the one or more NIR images of the illuminated first surface of the veneer of operation 1110 are processed using any of the methods and systems discussed above with respect to FIGS. 4A, 4B, FIG. 10, FIGS. 2D through 2F, and corresponding FIGS. 4D through 4H, to generate NIR greyscale images indicating different irregularities in the illuminated first surface of the veneer.

Once the one or more NIR images of the illuminated first surface of the veneer are processed to generate NIR greyscale images indicating different irregularities in the illuminated first surface of the veneer at operation 1112, process flow proceeds to operation 1113.

In one embodiment, at operation 1113, the NIR greyscale images are processed using the NIR greyscale image to processing parameter mapping database to determine processing parameter adjustments required using any of the methods and systems discussed above with respect to FIGS. 4A and 4B, FIG. 10, FIGS. 2D through 2F, and corresponding FIGS. 4D through 4H.

Once the NIR greyscale images are processed using NIR greyscale image to processing parameter mapping database to determine processing parameter adjustments at operation 1113, process flow proceeds to operation 1114.

In one embodiment, at operation 1114 any processing parameters that it is determined must be adjusted are adjusted via one or more actions such as any actions discussed above with respect to FIG. 10.

Once any processing parameters that it is determined must be adjusted are adjusted at operation 1114, process flow proceeds to END operation 1134 where process 1100 is exited to await new samples and/or data.

The disclosed embodiments utilize NIR cameras to scan the surface of veneer for irregularities and create an NIR image of the surface of the veneer. Since essentially each pixel of camera image data is a sample point, the resolution and accuracy of the surface irregularity detection process is only limited by the number of pixels the camera has covering the field of view, e.g., the entire first surface of veneer. Consequently, in the case where a 1.3 mega pixel camera is used there are essentially 1,400,000 individual measurement points on the surface of the veneer. In addition, NIR wavelengths are in the range of 750 nanometers (nm) to 4500 nm which are much smaller that the visible wavelengths of 480 to 740 nm. Consequently, the use of NIR cameras as disclosed herein results in resolutions and accuracy that simply cannot be achieved using traditional visual irregularity detection systems.

In addition, when, as disclosed herein, NIR cameras are used as the surface irregularity detection mechanism, if greater or less resolution is deemed necessary, a higher or lower mega-pixel camera can be selected to achieve the desired resolution for the process. This can be accomplished in a relatively simple and quick camera switch out procedure. In addition, NIR camera placement with respect to the sample under analysis can be adjusted such that a quality image can be obtained as long as there is a clear field of view between the veneer surface and NIR camera. Horizontal, vertical, or angled placements have no impact on the functionality of the NIR camera.

Therefore, the disclosed technical solution is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished veneer.

The use of NIR cameras, as disclosed herein, eliminates the need for any offline magnification of the veneer or the need for the surface irregularity detection device, i.e., the NIR camera, to be close to the surface of the veneer. This allows for more flexible placement of the sample taking device, i.e., the NIR camera.

In addition, unlike visual based detection methods NIR cameras are virtually immune to ambient visible light and interference. Consequently, use of NIR cameras as disclosed herein is far more suitable for a physical production line environment.

Further, NIR technology has been determined to be safe, i.e., representing no hazards to workers or other devices, by several testing and safety agencies. Consequently, the use of the disclosed NIR based surface irregularity detection systems results in a safe, comfortable, and efficient workplace and production floor.

Using the disclosed embodiments, surface irregularities on the surface of full veneer sheet, veneer strip, and/or partial veneer sheets can be identified efficiently, effectively, and quickly, while the production line continues operation at normal speeds, consequently, implementation of the disclosed embodiments, does not slow down production speed or change product processing time.

As noted above, embodiments of the present disclosure provide an effective and efficient technical solution to the technical problem of accurately and efficiently grading veneer. In one embodiment, the disclosed NIR analysis systems are part of one or more veneer analysis systems In one embodiment, individual full veneer sheets and/or veneer strips and/or partial veneer sheets are provided to one or more veneer analysis systems.

In one embodiment, once the veneer is graded using the detected using the disclosed NIR analysis system such as any of the NIR analysis systems of FIG. 3A. 3B, 5, 6, 7, 8, 9, 10, or 11, the veneer is then provided to a veneer stacking system that produces more consistently graded veneer stacks based, at least in part, on the grade assigned to the veneer by the disclosed the NIR analysis systems.

In one embodiment, the veneer stacking system is any veneer stacking system discussed herein, and/or as known in the art at the time of filing, and/or as developed/made available/becomes known after the time of filing capable of stacking veneer.

In one embodiment, the veneer stacking system is an improved veneer stacking system such as any of those disclosed in Bolton et al., U.S. patent application Ser. No. 17/230,470 (attorney docket number BCC-013), filed Apr. 14, 2021, entitled “METHOD AND SYSTEM FOR FULL VENEER SHEET GRADING AND STACKING,” which is hereby incorporated by reference in its entirety as if it were fully set forth herein.

In one embodiment, the veneer stacking system is an improved veneer stacking system such as any of those disclosed in Bolton et al., U.S. patent application Ser. No. 17/230,497 (attorney docket number BCC-017), filed Apr. 14, 2021, entitled “METHOD AND SYSTEM FOR VENEER STRIP GRADING AND STACKING,” which is hereby incorporated by reference in its entirety as if it were fully set forth herein.

In one embodiment, the veneer stacking system is an improved veneer stacking system such as any of those disclosed in Bolton et al., U.S. patent application Ser. No. 17/256,804 (attorney docket number BCC-004CIP1), filed Jun. 24, 2021, entitled “METHOD AND SYSTEM FOR GRADING AND STACKING VENEER SHEETS USING NEAR INFRARED IMAGING,” which is hereby incorporated by reference in its entirety as if it were fully set forth herein.

In one embodiment, the veneer stacking system is an improved veneer stacking system such as any of those disclosed in Bolton et al., U.S. patent application Ser. No. 17/356,805 (attorney docket number BCC-004CIP2), filed Jun. 24, 2021, entitled “METHOD AND SYSTEM FOR GRADING AND STACKING VENEER STRIPS USING NEAR INFRARED IMAGING,” which is hereby incorporated by reference in its entirety as if it were fully set forth herein.

In one embodiment, the veneer stacks of now consistently graded veneer are then provided to the disclosed local robotic panel assembly and pressing systems. In one embodiment, the disclosed local robotic panel assembly and pressing system includes one or more local robotic panel assembly cells.

In one embodiment, the disclosed local robotic panel assembly cells include: one or more veneer handling robots; one or more glue application robots; and, in some embodiments, one or more core handling robots. In accordance with the disclosed embodiments, the local robotic panel assembly cells are used to locally and independently utilize the stacks of now consistently graded veneer to produce stacks of layered wood product panels at, or near, the pressing stations. As disclosed, the local robotic panel assembly cells operate independently to assemble the stacks at static locations local to the pressing stations and as the stacks are required. Consequently, using the disclosed embodiments, the stacks of layered wood product panels are built independently and locally at the pressing stations thereby eliminating the need for traditional panel conveyors, traditional layered wood product panel assembly layup lines, and stack press delivery lines. This, in turn, eliminates thousands of moving parts and dozens of people from the layered wood product production process.

Consequently, using the disclosed embodiments, many of the shortcomings of prior art are minimized or by-passed/resolved. For instance, using the methods and systems for producing layered wood products disclosed herein there is the no need for traditional panel conveyors, traditional layered wood product panel assembly layup lines, nor stack press delivery lines. Therefore, the large physical size, e.g., hundreds of feet, of factory floor space required by prior art methods and systems are not needed.

In addition, as discussed below, using the disclosed embodiments, not only are there significant cost savings in the layered wood product production process, but the resulting layered wood products produced using the disclosed embodiments are of a higher and more consistent quality.

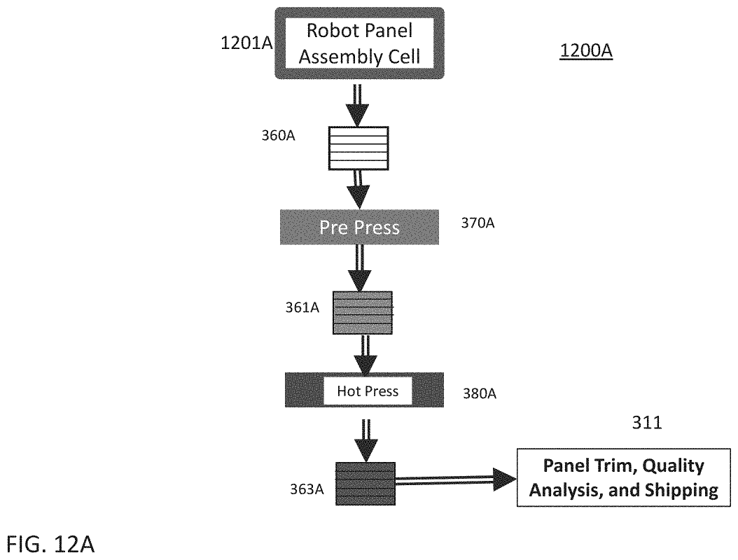

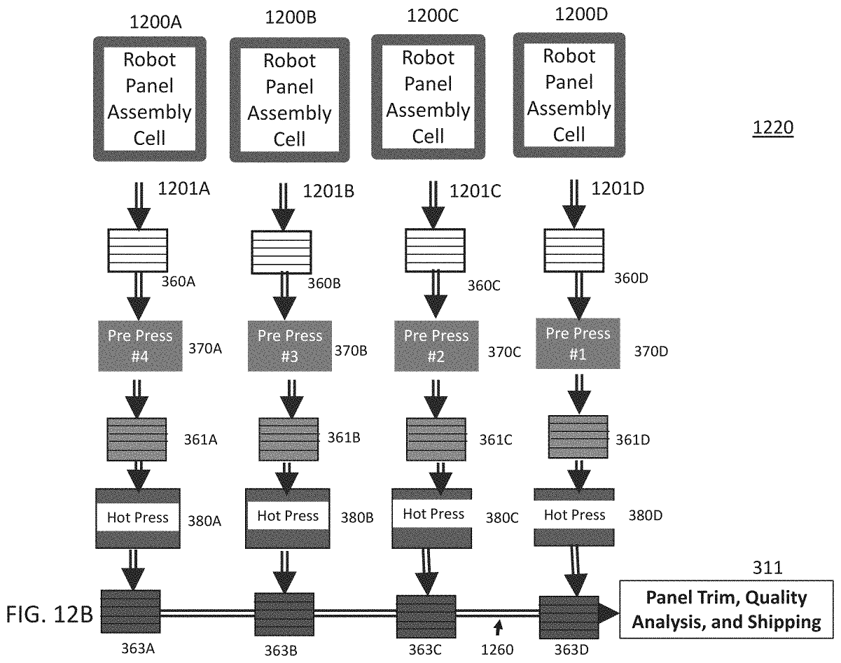

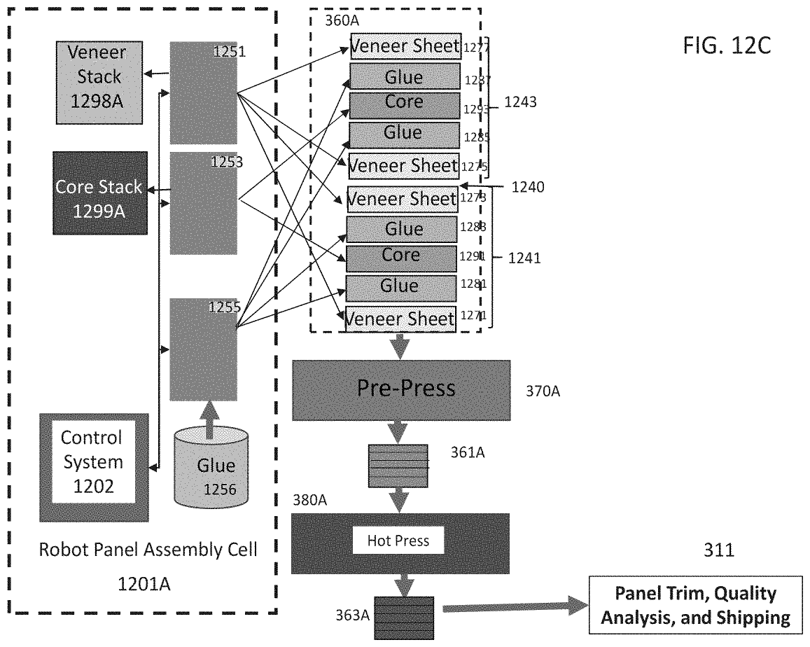

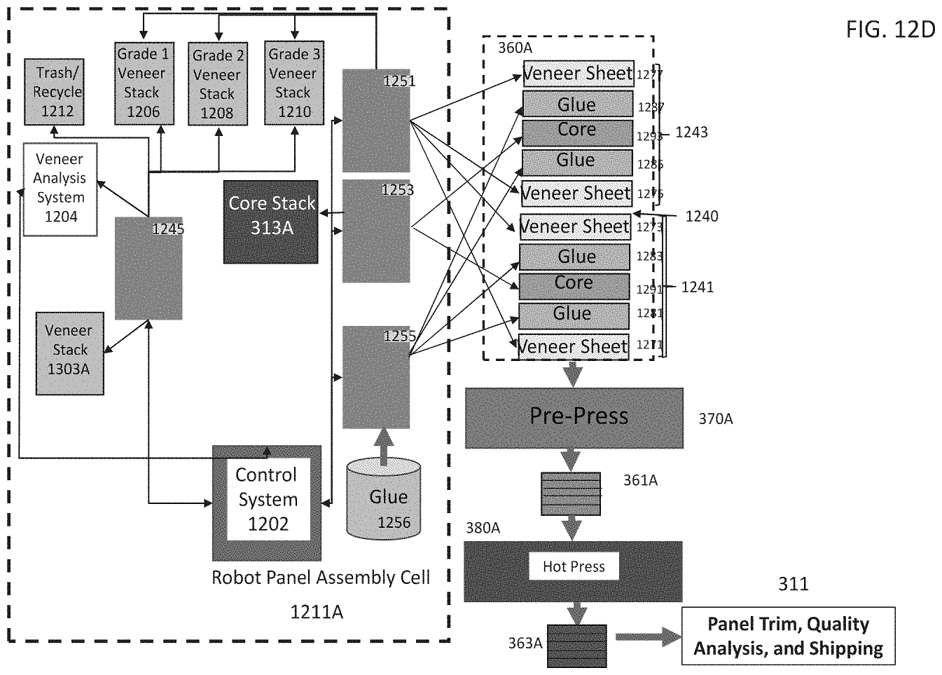

FIG. 12A is a high-level diagram of a local robotic panel assembly and pressing station 1200A in accordance with one embodiment. As seen in FIG. 12A, local robotic panel assembly and pressing station 1200A includes robotic panel assembly cell 1201A that is used to create green panel stacks, such as green panel stack 360A.

It is worth noting that green panel stack 360A of FIG. 12A produced by robotic panel assembly cell 1201A is virtually identical to green panel stack 360A of FIG. 3D, or any of the green panel stacks 360 of FIG. 3C or FIG. 3D. Consequently, robotic panel assembly cell 1201A literally replaces all of the prior art structure shown in as FIG. 3C and the stack production and processing section 399 of FIG. 3D, including traditional layered wood product panel assembly layup line 350 and stack press delivery line 362. This alone means that local robotic panel assembly and pressing station 1200A eliminates the need for hundreds of square feet of floor space, thousands of moving parts, multiple sensors and motors, and dozens of sub-assemblies and human operators.

As also seen in FIG. 12A, once robotic panel assembly cell 1201A creates green panel stack 360A, green panel stack 360A is transferred to pre-press 370A and green panel stack 360A is loaded into pre-press 370A where the green panel stack 360A is subjected to cold pre-pressing in the same pre-pressing process as discussed above. In the press 370A green panel stack 360A is pressed to flatten out the structure and force out any air pockets that may exist in the green panel stack 360A and to create pre-pressed stack 361A.

Once pre-pressed stack 361A is created, pre-pressed stack 361A is conveyed to an unstacking mechanism (not shown) which feeds the layered wood structure panels making up pre-pressed stack 361A one at a time into slots of hot press 380A and is then subjected to hot pressing in the same pre-pressing process as discussed above. At hot press 380A the layered wood structure panels making up pre-pressed stack 361A are subjected to further pressure and heat to further flatten and cure the layered wood structure panels making up pre-pressed stack 361A. The layered wood structure panels are then re-stacked to form cured layered wood panel product stack 363A.

Cured layered wood panel product stack 363A is then conveyed to panel trim, quality analysis, and shipping area 311 where the individual layered wood panels making up cured layered wood panel product stack 363A are trimmed to size, subjected to quality control analysis, and then shipped to customers.

As noted, the pressing and trimming/quality control/shipping process shown in FIG. 12A is virtually identical to the pressing and finishing/quality control/shipping process discussed above with respect to FIG. 3D. Thus, according to one embodiment, once robotic panel assembly cell 1201A creates green panel stack 360A, green panel stack 360A is processed in the same manner, and using the same equipment, as is used to traditionally process layered wood products. Consequently, existing cold and hot press equipment need not be replaced. Therefore, the use of the disclosed local robotic panel assembly and pressing station 1200A results in eliminating the need for hundreds of square feet of floor space, thousands of moving parts, multiple sensors and motors, and dozens of sub-assemblies and human operators of the prior art structure shown in as FIG. 3C and the stack production and processing section 399 of FIG. 3D, while still minimizing the amount of processing equipment that must be replaced.

According to the disclosed embodiments, multiple local robotic panel assembly and pressing stations, such as local robotic panel assembly and pressing station 1200A, can be operated at once, and independently, to form a robotic panel assembly and pressing system 1220.

FIG. 12B is a diagram of a robotic panel assembly and pressing system 1220 including four local robotic panel assembly and pressing stations 1200A through 1200D in accordance with one embodiment. In practice, the number of local robotic panel assembly and pressing stations can be fewer, or more, than the four shown in FIG. 12B.

As seen in FIG. 12B, each of local robotic panel assembly and pressing stations 1200A, 1200B, 1200C, and 1200D includes its own independently operating robotic panel assembly cell 1201A, 1201B, 1201C, and 1201D, respectfully, that are used to independently create green panel stacks 360A, 360B, 360C, and 360D.

It is worth noting again that green panel stacks 360A, 360B, 360C, and 360D of FIG. 12B produced by local robotic panel assembly cells 1201A, 1201B, 1201C, and 1201D are virtually identical to green panel stacks 360A, 360B, 360C, and 360D of FIGS. 3C and 3D. Consequently, the set of local robotic panel assembly cells 1201A, 1201B, 1201C, and 1201D literally replaces all of the prior art structure shown in as FIG. 3C and the stack production and processing section 399 of FIG. 3D, including traditional layered wood product panel assembly layup line 350 and stack press delivery line 362. This alone means that the set of local robotic panel assembly and pressing stations 1200A, 1200B, 1200C, and 1200D eliminates the need for hundreds of square feet of floor space, thousands of moving parts, multiple sensors and motors, and dozens of sub-assemblies and human operators.

As also seen in FIG. 12B, once local robotic panel assembly cells 1201A, 1201B, 1201C, and 1201D create green panel stacks 360A, 360B, 360C, and 360D, green panel stacks 360A, 360B, 360C, and 360D are transferred to pre-presses 370A, 370B, 370C, and 370D, respectively, where the green panel stacks 360A, 360B, 360C, and 360D are subjected to cold pre-pressing. In the pre-presses 370A, 370B, 370C, and 370D, green panel stacks 360A, 360B, 360C, and 360D are pressed to flatten out the structures and force out any air pockets that may exist in the green panel stacks 360A, 360B, 360C, and 360D and to create pre-pressed stacks 361A, 361B, 361C, and 361D by the same pre-pressing process as discussed above.

Once pre-pressed stacks 361A, 361B, 361C, and 361D are created, pre-pressed stacks 361A, 361B, 361C, and 361D are conveyed into one or more unstacking mechanisms (not shown) which feed one layered wood structure panel at a time from the pre-pressed stacks 361A, 361B, 361C, and 361D into slots of one or more multi opening hot presses 380A, 380B. 380C, and 380D, respectively. At hot presses 380A, 380B, 380C, and 380D the layered wood structure panels making up pre-pressed stacks 361A, 361B, 361C, and 361D are subjected to further pressure and heat to further flatten and cure the layered wood structure panels making up pre-pressed stacks 361A, 361B, 361C, and 361D by the same hot pressing process as discussed above. Then the layered wood structure panels are re-stacked resulting in cured layered wood panel product stacks 363A, 363B, 363C, and 363D, respectively.

Cured layered wood panel product stacks 363A, 3634B, 363C, and 363D are then conveyed by conveyor 1260 to panel trim, quality analysis, and shipping area 311 where the individual layered wood panels making up cured layered wood panel product stacks 363A, 3634B, 363C, and 363D are trimmed to size, subjected to quality control analysis, and then shipped to customers.

The pressing and trimming/quality control/shipping process shown in FIG. 12B is virtually identical to the pressing and finishing/quality control/shipping process discussed above with respect to FIG. 3D. Thus, according to one embodiment, once robotic panel assembly cells 1201A, 1201B, 1201C, and 1201D create green panel stacks 360A, 360B, 360C, and 360D, green panel stacks 360A, 360B, 360C, and 360D are processed by local robotic panel assembly and pressing stations 1200A through 1200D in the same manner, and using the same equipment, as used to traditionally process layered wood products. Consequently, existing cold and hot press equipment need not be replaced. Therefore, the use of the disclosed robotic panel assembly and pressing system 1220 results in eliminating the need for hundreds of square feet of floor space, thousands of moving parts, multiple sensors and motors, and dozens of sub-assemblies and human operators of the prior art structure shown in FIG. 3C and the stack production and processing section 399 of FIG. 3D, while still minimizing the amount of processing equipment that must be replaced.

In addition, robotic panel assembly and pressing system 1220 has several other processing advantages over prior art systems. First, recall that using prior systems such as that shown in FIG. 3D, in addition to the cost of operating traditional layered wood product panel assembly layup and press line 351, including stack production and processing section 399, i.e., traditional layered wood product panel assembly layup line 350 and stack press delivery line 362, there was a significant cost associated with any delays in traditional layered wood product panel assembly layup and press line 351. These delays included delays due to failure of any of the thousands of moving parts associated with traditional layered wood product panel assembly layup and press line 351, and particularly stack production and processing section 399, or any human error introduced by the twelve or more people required to operate traditional layered wood product panel assembly layup and press line 351.

Further recall that, referring to FIGS. 3D and 3F together, when a delay occurred, for whatever reason, the layers of glue applied by glue applicators 309A through 309J could dry out before the green panel stacks 360 reached the pressing stations 353 through 359. This, in turn, resulted in layered wood product panels that could separate or otherwise fail because the glue could not cure and adhere the layers properly. Unfortunately, this resulted in significant loss of product using traditional layered wood product panel assembly layup and press line 351. Currently there is an average loss of product to defects of ten percent or more using traditional layered wood product panel assembly layup and press line 351.

However, referring back to FIG. 12B, in direct contrast to prior art systems, using independently operating robotic panel assembly and pressing system 1220, the green panel stacks 360A, 360B, 360C, and 360D are independently built at individual static locations at, or near, the pressing area by individual and independently operating robotic panel assembly cells 1201A, 1201B, 1201C, and 1201D. Consequently, using robotic panel assembly and pressing system 1220 if there is a delay in any of the local robotic panel assembly and pressing stations 1200A through 1200D, the delay only affects the panels being processed by that particular local robotic panel assembly and pressing station, i.e., only one of pressing stations 1200A through 1200D. As a result, any such delay can, at most, cause a single stack of panels to be lost. This is in direct contrast to the multiple stacks that can be lost as a result of delays in traditional layered wood product panel assembly layup and press line 351. The product savings can literally be an order of magnitude or more as a delay in traditional layered wood product panel assembly layup and press line 351 can result in the loss of four hundred or more individual layered wood product panels while a delay in any of local robotic panel assembly and pressing stations 1200A through 1200D would typically result in, at most, forty individual layered wood product panels.

In addition, as noted above, using prior art methods and systems for producing layered wood products, such as using traditional layered wood product panel assembly layup and press line 351, material and glue systems are configured to run a single product at a time, i.e., only a single ply count panel, or single type of product (plywood or PLV), at a time. Changing products required stopping the machine, removing all in process material, and then reconfiguring controls for new product construction.

However, and again in direct contrast to prior art systems, using robotic panel assembly and pressing system 1220, and local robotic panel assembly and pressing stations 1200A through 1200D, the green panel stacks 360A, 360B, 360C, and 360D are built independently at individual static locations at, or near, the pressing area by individual robotic panel assembly cells 1201A, 1201B, 1201C, and 1201D. As a result, each of the local robotic panel assembly and pressing stations 1200A through 1200D can independently generate different products. Consequently, each of the local robotic panel assembly and pressing stations 1200A through 1200D can produce different ply count panels, or different types of products, plywood or PLV, independently and at the same time.

The fact that using robotic panel assembly, and pressing system 1220, local robotic panel assembly and pressing stations 1200A through 1200D, green panel stacks 360A, 360B, 360C, and 360D are built at independently operating individual static locations at or near the pressing area by individual robotic panel assembly cells 1201A, 1201B, 1201C, and 1201D eliminates the issues discussed above associated with prior art systems where it was critical to ensure coordination between the stacker operator SO and each of the press operators PO1, PO2, PO3, and PO4 of FIGS. 3C and 3D so that the wrong size stacks were not loaded into a pre-press or hot press that is unable to process them.

FIG. 12C is a more detailed diagram of a robotic panel assembly cell 1201A of FIGS. 12A and 12B in accordance with one embodiment.

Robotic panel assembly cell 1201A is exemplary of any of the individual robotic panel assembly cells 1201A, 1201B, 1201C, and 1201D of FIGS. 12A and 12B. As seen in FIG. 12C, robotic panel assembly cell 1201A is used to create green panel stack 360A which is itself exemplary of any of the green panel stacks 360A, 360B, 360C, and 360D of FIG. 12A and 2B.

As seen in FIG. 12C, robotic panel assembly cell 1201A includes veneer stack 1298A and core stack 1299A. In one embodiment, veneer stack 1298A is a stack of full sheets of veneer created using once or more of the disclosed NIR analysis systems and stacking systems discussed above with respect to FIGS. 4A, 4B, 4C through 4G, 5, 6, 7, 8, 9, 10, and 11.

In one embodiment, core stack 1299A is a stack of core material that can include portions of veneer sheets, and/or veneer strips, and/or partial veneer sheets created using once or more of the disclosed NIR analysis systems and any of the stacking systems discussed above with respect to FIGS. 4A, 4B, 4C through 4G, 5, 6, 7, 8, 9, 10, and 11.

As discussed in more detail above with respect to FIG. 4A and referring to FIGS. 4A and 12C, in some embodiments, selected action data 494 is forwarded to an action activation module, such as selected action implementation module 496, in production floor environment 401 to initialize one or more actions with respect to the veneer 430 based, at least in part, on the grade represented by grade assignment data 482 and assigned to the veneer 430 by action selection and activation module 490. These actions can include assigning the veneer 430 to a specific veneer stack, such as veneer stack 1298A or core stack 1299A, associated with the grade assigned to the veneer 430.

As also discussed in more detail above, in some embodiments, the selected action indicated by selected action data 494 is to add veneer 430 to a specific veneer stack, such as veneer stack 1298A or core stack 1299A, based, at least in part, on the grade represented by grade assignment data 482 and assigned to the veneer 430. In these embodiments, grade assignment data 482 is provided to action selection and activation module 490 which, in turn, forwards grade assignment data 482 to selected action implementation module 496. In one embodiment, selected action implementation module 496 then forwards grade assignment data 482 to a stacking system such as any stacking system discussed herein. As discussed in more detail below, in these embodiments, the veneer 430 is then added to a specific veneer stack, such as veneer stack 1298A or core stack 1299A, based, at least in part, on the grade represented by grade assignment data 482 and assigned to the veneer 430 and the grading data for the stack, such as veneer stack 1298A or core stack 1299A, is also provided to control system 1202.

In one embodiment, the veneer stacking system is any veneer stacking system discussed herein, and/or as known in the art at the time of filing, and/or as developed/made available/becomes known after the time of filing capable of stacking veneer.

In one embodiment, the veneer stacking system is an improved veneer stacking system such as any of those disclosed in Bolton et al., U.S. patent application Ser. No. 17/230,470 (attorney docket number BCC-013), filed Apr. 14, 2021, entitled “METHOD AND SYSTEM FOR FULL VENEER SHEET GRADING AND STACKING,” which is hereby incorporated by reference in its entirety as if it were fully set forth herein.

In one embodiment, the veneer stacking system is an improved veneer stacking system such as any of those disclosed in Bolton et al., U.S. patent application Ser. No. 17/230,497 (attorney docket number BCC-017), filed Apr. 14, 2021, entitled “METHOD AND SYSTEM FOR VENEER STRIP GRADING AND STACKING,” which is hereby incorporated by reference in its entirety as if it were fully set forth herein.

Returning to FIG. 12C, robotic panel assembly cell 1201A includes veneer handling robot 1251 which is representative of one or more veneer handling robots; glue application robot 1255 which is representative of one or more glue application robots; and, in some embodiments where plywood green layered wood product panel stacks are to be produced, core handling robot 1253 which is representative of one or more core handling robots.

Also seen in FIG. 12C is control system 1202 which is used to control veneer handling robot 1251, core handling robot 1253, and glue application robot 1255. In various embodiments, control system 1202 is representative of one or more computing systems which generate instructions for veneer handling robot 1251, core handling robot 1253, and glue application robot 1255 in the form of control signals. In this way, control system 1202 directs veneer handling robot 1251, core handling robot 1253, and glue application robot 1255 in the construction of the green panel stack 360A via the generated control signals and according to the grade of the veneer making up veneer stack 1298A and/or core stack 1299A.

In one embodiment, veneer handling robot 1251 is directed by the control signals from control system 1202 to retrieve veneer sheets from veneer stack 1298A and place the veneer sheet on green plywood panel stack 360A in accordance with received control signals to create the green layered wood product panels 1241 and 1243 in green panel stack 360A as discussed above and as shown in FIG. 12C.

In one embodiment, glue application robot 1255 is directed by the control signals from control system 1202 to apply a layer of glue from glue reservoir 1256 between sheets of veneer and/or core material in accordance with received control signals to create the green layered wood product panels 1241 and 1243 in green panel stack 360A as discussed above and as shown in FIG. 12C.

In embodiments where robotic panel assembly cell 1201A is used to create green plywood panels 1241 and a green plywood panel stack 360A, robotic panel assembly cell 1201A includes core handling robot 1253. In one embodiment, core handling robot 1253 is directed by the control signals from control system 1202 to retrieve core material from core stack 1299A and place a portion of core material on green plywood panel stack 360A in accordance with received control signals to create the green plywood panels 1241 and 1243 in green plywood panel stack 360A as discussed above and as shown in FIG. 12C.

Robots, such as veneer handling robot 1251, glue application robot 1255, and core handling robot 1253 are generally known in the art, at least generically as systems for handling materials and performing various tasks in response to control signals from one or more control systems. Consequently, a detailed description of the general structure and operation of robots is omitted here to avoid detracting from the invention. However, the tasks performed by veneer handling robot 1251, glue application robot 1255, and core handling robot 1253 and the use of veneer handling robot 1251, glue application robot 1255, and core handling robot 1253 to produce green layered wood panel stacks, such as green panel stack 360A are not known in the art and therefore the functions performed by veneer handling robot 1251, glue application robot 1255, and core handling robot 1253 are described in detail.

In particular, as shown in FIG. 12C, veneer handling robot 1251 is first directed by control signals from control system 1202 to retrieve veneer sheet 1271 from the stack of veneer sheets 1298A and place the veneer sheet 1271 on green panel stack 360A.

Then glue application robot 1255 is directed by the control signals from control system 1202 to apply a layer of glue 1281 from glue reservoir 1256 to veneer sheet 1271.

In embodiments where robotic panel assembly cell 1201A is used to create green plywood panels, then core handling robot 1253 is directed by the control signals from control system 1202 to retrieve core material from core stack 1299A and place a portion of core material on green panel stack 360A to create core layer 1291.

Glue application robot 1255 is then directed by the control signals from control system 1202 to apply a layer of glue 1283 from glue reservoir 1256 on core layer 1291. Then veneer handling robot 1251 is directed by control signals from control system 1202 to retrieve veneer sheet 1273 from the stack of veneer sheets 1298A and place the veneer sheet 1273 on green layered wood product panel 360A.

Of note, in embodiments where robotic panel assembly cell 1201A is used to produce green layered wood product stacks of other types of layered wood products, such as green PLV panels, core handling robot 1253 is either deactivated or not present. In these cases, veneer handling robot 1251 is directed by control signals from control system 1202 to retrieve veneer sheet 1271 from the stack of veneer sheets 1298A and place the veneer sheet 1271 on green panel stack 360A. Then glue application robot 1255 is directed by the control signals from control system 1202 to apply a layer of glue 1281 from glue reservoir 1256 to veneer sheet 1271. Then veneer handling robot 1251 is simply directed by control signals from control system 1202 to retrieve another veneer sheet 1273 from the stack of veneer sheets 1298A and place the veneer sheet 1273 on veneer sheet 1271.

The result of the operations above is a three-ply green layered wood product panel 1241. As noted above, plywood, and other layered wood product panels often have twenty-one or more plys. However, for simplicity of illustration, green layered wood product panel 1241 is a three-ply green layered wood product panel 1241.

Once green layered wood product panel 1241 is constructed by robotic panel assembly cell 1201A, robotic panel assembly cell 1201A begins to construct a second green layered wood product panel 1243 of green panel stack 360A. To this end, veneer handling robot 1251 is again directed by control signals from control system 1202 to retrieve a veneer sheet 1275 from the stack of veneer sheets 1298A and place the veneer sheet 1275 on the glue-free side of veneer sheet 1273. Importantly, veneer handling robot 1251 is directed by control signals from control system 1202 to retrieve veneer sheet 1275 from the stack of veneer sheets 1298A and place the veneer sheet 1275 on the veneer sheet 1273 directly, without any glue layer being applied by glue application robot 1255. This creates a dry veneer to veneer layer, or gap 1240. Gap 1240 therefore separates green layered wood product panel 1241 and green layered wood product panel 1243 in green panel stack 360A.

Then glue application robot 1255 is directed by the control signals from control system 1202 to apply a layer of glue 1285 from glue reservoir 1256 to veneer sheet 1275. In embodiments where robotic panel assembly cell 1201A is used to create green plywood panels, then core handling robot 1253 is directed by the control signals from control system 1202 to retrieve core material from core stack 1299A and place a portion of core material on green panel stack 360A to create core layer 1293. Then glue application robot 1255 is directed by the control signals from control system 1202 to apply a layer of glue 1287 from glue reservoir 1256 on core layer 1293. Then veneer handling robot 1251 is directed by control signals from control system 1202 to retrieve veneer sheet 1277 from the stack of veneer sheets 1298A and place the veneer sheet 1277 on green panel stack 360A.

Of note again, in embodiments where robotic panel assembly cell 1201A is used to produce green layered wood product stacks of other types of layered wood products, such as green PLV panels, core handling robot 1253 is either deactivated or not present. In these cases, veneer handling robot 1251 is directed by control signals from control system 1202 to retrieve veneer sheet 1275 from the stack of veneer sheets 1298A and place the veneer sheet 1275 on green panel stack 360A. Then glue application robot 1255 is directed by the control signals from control system 1202 to apply a layer of glue 1285 from glue reservoir 1256 to veneer sheet 1275. Then veneer handling robot 1251 is simply directed by control signals from control system 1202 to retrieve another veneer sheet 1277 from the stack of veneer sheets 1298A and place the veneer sheet 1277 on veneer sheet 1275.

The result of the operations above is a second three-ply green layered wood product panel 1243. The process above is then repeated to create the desired number of green layered wood product panels for green panel stack 360A. As noted above, it is not uncommon for green panel stack 360A to include forty or more individual green layered wood product panels.

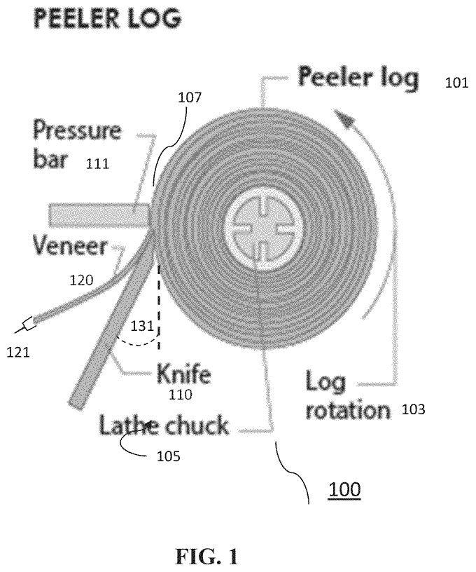

It is worth noting again that green panel stack 360A of FIG. 12C produced by robotic panel assembly cell 1201A is virtually identical to green panel stack 360A of FIG. 3D, or any of the green panel stacks 360 of FIG. 1D or FIG. 3D. Consequently, robotic panel assembly cell 1201A literally replaces all of the prior art structure shown in FIG. 3C and the stack production and processing section 399 of FIG. 3D, including traditional layered wood product panel assembly layup line 350 and stack press delivery line 362. This alone means that local robotic panel assembly and pressing station 1200A eliminates the need for hundreds of square feet of floor space, thousands of moving parts, multiple sensors and motors, and dozens of sub-assemblies and human operators.

In addition, according to the disclosed embodiments, and in contrast to prior art systems, robotic panel assembly cell 1201A is located locally at, or near, pre-press 370A and hot press 380A. Therefore, green panel stack 360A is assembled by robotic panel assembly cell 1201A locally with respect to the pressing line. Consequently, robotic panel assembly cell 1201A assembles the same green panel stack 360A as any of the green panel stacks 360 of FIG. 3C or FIG. 3D locally with respect to pre-press 370A and hot press 380A and at a single location.

As seen in FIG. 12A, once robotic panel assembly cell 1201A creates green panel stack 360A, green panel stack 360A is transferred to pre-press 370A and green panel stack 360A is loaded into pre-press 370A where the green panel stack 360A is subjected to cold pre-pressing. In the pre-press 370A green panel stack 360A is pressed to flatten out the structure and force out any air pockets that may exist in the green panel stack 360A and to create pre-pressed stack 361A.

Once pre-pressed stack 361A is created, pre-pressed stack 361A is conveyed to an unstacking mechanism (not shown) which feeds the layered wood structure panels making up pre-pressed stack 361A one at a time into slots of hot press 380A. At hot press 380A the layered wood structure panels making up pre-pressed stack 361A are subjected to further pressure and heat to further flatten and cure the layered wood structure panels making up pre-pressed stack 361A. The layered wood structure panels are then re-stacked to form cured layered wood panel product stack 363A.

Cured layered wood panel product stack 363A is then conveyed to panel trim, quality analysis, and shipping area 311 where the individual layered wood panels making up cured layered wood panel product stack 363A are trimmed to size, subjected to quality control analysis, and then shipped to customers.

In one embodiment, the pressing and trimming/quality control/shipping process shown in FIG. 12A is virtually identical to the pressing and finishing/quality control/shipping process discussed above with respect to FIG. 3D. Thus, according to one embodiment, once robotic panel assembly cell 1201A creates green panel stack 360A, green panel stack 360A is processed in the same manner, and using the same equipment, as is used to traditionally process layered wood products. Consequently, existing cold and hot press equipment need not be replaced. Therefore, the use of the disclosed local robotic panel assembly and pressing station 1200A results in eliminating the need for hundreds of square feet of floor space, thousands of moving parts, multiple sensors and motors, and dozens of sub-assemblies and human operators of the prior art structure shown in as FIG. 3C and the stack production and processing section 399 of FIG. 3D, while still minimizing the amount of processing equipment that must be replaced.

As discussed above, the same layering of veneer that potentially provides so many advantages in layered wood products can also present some drawbacks. For instance, the presence of irregular surfaces in the layered sheets of veneer, i.e., inconsistent surface texture and moisture content, can create problems, such as cracks or other defects, in the layered wood products. This, of course, can result in compromised structural integrity of the layered wood products and/or undesirable imperfections in the layered wood products. Consequently, it is critical to accurately and efficiently determine the surface texture and moisture content of the veneer sheets used in a layered wood products. However, accurately, effectively, and efficiently determining the surface texture and moisture content of the veneer sheets used in layered wood products has historically been a difficult technical problem to solve.

Consequently, prior art methods and systems for producing layered wood products typically do not include any process for inspecting or grading veneer sheets used in the production of layered wood products. As a result, using prior art methods and systems for producing layered wood products, the quality of veneer fed into process was not inspected during feeding operation. Therefore, undetected defects often caused panels to be rejected only downstream after significant time and energy had already been devoted to the panels, i.e., pressing is complete and panel quality is analyzed.

Using the disclosed NIR analysis systems and stacking systems discussed above with respect to FIGS. 4A, 4B, 4C through 4G, 5, 6, 7, 8, 9, 10, and 11 the surface texture of veneer used in layered wood products can be determined before the veneer is processed. In addition, several recently discovered technical solutions to the technical problem of accurately and efficiently determining the surface texture and moisture content of the veneer sheets used in a layered wood products are set forth in the related U.S. patent applications incorporated by reference above. These disclosed quality inspection methods and systems can also be used to determine the surface texture and moisture of veneer sheets used in layered wood products before the veneer is processed.

In one embodiment, the disclosed method and system for producing layered wood products takes advantage of the disclosed NIR analysis systems and stacking systems discussed above with respect to FIGS. 4A, 4B, 4C through 4G, 5, 6, 7, 8, 9, 10, and 11 and/or these other innovations to inspect and grade the veneer used in the disclosed method and system for producing layered wood products. To this end, in one embodiment, the disclosed local robotic panel assembly and pressing stations include a veneer analysis system. In one embodiment, the veneer analysis system includes inspection/grading robot which is used to determine the quality of veneer fed into process during feeding operation. Therefore, defects can be detected, and the veneer sheets can be graded before significant time and energy has already been devoted to the panels. In one embodiment, the

FIG. 12D is a diagram of a local robotic panel assembly cell 1211A that is similar to robotic panel assembly cell 1201A of FIGS. 12A, 12B, and 12C but that includes a veneer analysis system 1204 and multiple graded veneer stacks 1206, 1208, 1210 and 1212 in accordance with one embodiment.

The operation of local robotic panel assembly cell 1211A is substantially similar to the operation of robotic panel assembly cell 1201A of FIGS. 12A, 12B, and 12C. However, before veneer sheets from veneer stack 1303A are made available to veneer handling robot 1251 the veneer sheets are retrieved by veneer inspection/grading robot 1245 which is representative of one or more veneer inspection/grading robots. Veneer inspection/grading robot 1245 then presents each veneer sheet to the veneer analysis system 1204 in accordance with control signals from control system 1202.

At the veneer analysis system 1204 the veneer sheets are inspected and assigned a grade based on the inspection results. In one embodiment, veneer analysis system 1204 includes one or more of the disclosed NIR analysis systems discussed above with respect to FIGS. 4A, 4B, 4C through 4G, 5, 6, 7, 8, 9, 10, and 11 to detect surface irregularities, moisture levels, density, and to assign a grade to the veneer sheets of veneer stack 1303A.

In one embodiment, veneer analysis system 1204 can also utilize one or more inspection methods and systems such as any of those set forth in the related U.S. patent applications incorporated by reference above. For example, Veneer analysis system 1204 can utilize one of more visible light inspection systems and/or one or more Near Infrared (NIR) inspection systems and/or superimposed imaging to detect surface irregularities, moisture levels, density, and to assign a grade to the veneer sheets of veneer stack 1303A.

In one embodiment, the veneer stacking system is any veneer stacking system discussed herein, and/or as known in the art at the time of filing, and/or as developed/made available/becomes known after the time of filing capable of stacking veneer.

In one embodiment, the veneer stacking system is an improved veneer stacking system such as any of those disclosed in Bolton et al., U.S. patent application Ser. No. 17/230,470 (attorney docket number BCC-013), filed Apr. 14, 2021, entitled “METHOD AND SYSTEM FOR FULL VENEER SHEET GRADING AND STACKING,” which is hereby incorporated by reference in its entirety as if it were fully set forth herein.

In one embodiment, the veneer stacking system is an improved veneer stacking system such as any of those disclosed in Bolton et al., U.S. patent application Ser. No. 17/230,497 (attorney docket number BCC-017), filed Apr. 14, 2021, entitled “METHOD AND SYSTEM FOR VENEER STRIP GRADING AND STACKING,” which is hereby incorporated by reference in its entirety as if it were fully set forth herein.

In one embodiment, based on the grade assigned to each veneer sheet, each veneer sheet is placed in one of graded veneer stacks, such as graded veneer stacks 1206, 1208, 1210 and 1212 of FIG. 12D by veneer inspection/grading robot 1245. In one embodiment, veneer stack 1206 is a grade 1 veneer stack that includes veneer sheets that are deemed to be of acceptable appearance and quality to be used for outer veneer layers of a layered wood panel. In one embodiment, veneer stack 1208 is a grade 2 veneer stack that includes veneer sheets that are deemed to be of acceptable structural quality to be used for inner veneer layers of a layered wood panel but perhaps lack the appearance to be used as outer layers of a layered wood panel. In one embodiment, veneer stack 1210 is a grade 3 veneer stack that includes veneer sheets that are deemed to have structural anomalies, such as knot holes, and therefore must be sparingly used for inner veneer layers of a layered wood panel and perhaps must be sandwiched between higher grade veneer sheets to provide adequate structural quality for the layered wood panel. Finally, in one embodiment, trash 1212 contains veneer sheets of unacceptable quality.

By grading veneer sheets from veneer stack 1303A and stacking the veneer sheets according to grade, the quality of veneer fed into process during feeding operation is again determined before resources are expended processing the veneer, i.e., defects can be detected in the veneer sheets, and the veneer sheets can be graded, and allocated for their best use, before significant time and energy is devoted to their use in processed panels.

Once the veneer sheets from veneer stack 1303A are inspected/graded by inspection grading system 1204, and the sheets are placed in appropriate graded veneer stacks 1206, 1208, 1210 and 1212 by veneer inspection/grading robot 1245. In one embodiment, robotic panel assembly cell 1211A operates the same way as robotic panel assembly cell 1201A of FIGS. 12A, 12B, and 12C.

In particular, as shown in FIG. 12D, veneer handling robot 1251 is directed by control signals from control system 1202 to retrieve veneer sheet 1271 from the appropriate graded veneer stack 1206, 1208, 1210 and place the veneer sheet 1271 on green panel stack 360A.

Then glue application robot 1255 is directed by the control signals from control system 1202 to apply a layer of glue 1281 from glue reservoir 1256 to veneer sheet 1271.

In embodiments where robotic panel assembly cell 1211A is used to create green plywood panels, then core handling robot 1253 is directed by the control signals from control system 1202 to retrieve core material from core stack 1299A and place a portion of core material on green panel stack 360A to create core layer 1291.

Glue application robot 1255 is then directed by the control signals from control system 1202 to apply a layer of glue 1283 from glue reservoir 1256 on core layer 1291. Then veneer handling robot 1251 is directed by control signals from control system 1202 to retrieve veneer sheet 1273 from the appropriate graded veneer stack 1206, 1208, 1210 and place the veneer sheet 1273 on green layered wood product panel 360A.

Of note, in embodiments where robotic panel assembly cell 1211A is used to produce green layered wood product stacks of other types of layered wood products, such as green PLV panels, core handling robot 1253 is either deactivated or not present. In these cases, veneer handling robot 1251 is directed by control signals from control system 1202 to retrieve veneer sheet 1271 from the appropriate graded veneer stack 1206, 1208, 1210 and place the veneer sheet 1271 on green panel stack 360A. Then glue application robot 1255 is directed by the control signals from control system 1202 to apply a layer of glue 1281 from glue reservoir 1256 to veneer sheet 1271. Then veneer handling robot 1251 is simply directed by control signals from control system 1202 to retrieve another veneer sheet 1273 from the appropriate graded veneer stack 1206, 1208, 1210 and place the veneer sheet 1273 on veneer sheet 1271.

The result of the operations above is a single three-ply green layered wood product panel 1241. As noted above, plywood, and other layered wood product panels often have twenty-one or more plys. However, for simplicity of illustration, green layered wood product panel 1241 is a single three-ply green layered wood product panel 1241.

Once green layered wood product panel 1241 is constructed by robotic panel assembly cell 1211A, robotic panel assembly cell 1211A begins to construct a second green layered wood product panel 1243 of green panel stack 360A. To this end, veneer handling robot 1251 is again directed by control signals from control system 1202 to retrieve veneer sheet 1275 from the appropriate graded veneer stack 1206, 1208, 1210 and place the veneer sheet 1275 on the glue-free side of veneer sheet 1273. Importantly, veneer handling robot 1251 is directed by control signals from control system 1202 to retrieve veneer sheet 1275 from the appropriate graded veneer stack 1206, 1208, 1210 and place the veneer sheet 1275 on the veneer sheet 1273 directly, without any glue layer being applied by glue application robot 1255. This creates a dry veneer to veneer layer, or gap 1240. Gap 1240 therefore separates green layered wood product panel 1241 and green layered wood product panel 1243 in green panel stack 360A.

Then glue application robot 1255 is directed by the control signals from control system 1202 to apply a layer of glue 1285 from glue reservoir 1256 to veneer sheet 1275. In embodiments where robotic panel assembly cell 1211A is used to create green plywood panels, then core handling robot 1253 is directed by the control signals from control system 1202 to retrieve core material from core stack 1299A and place a portion of core material on green panel stack 360A to create core layer 1293. Then glue application robot 1255 is directed by the control signals from control system 1202 to apply a layer of glue 1287 from glue reservoir 1256 on core layer 1293 Then veneer handling robot 1251 is directed by control signals from control system 1202 to retrieve veneer sheet 1277 from the appropriate graded veneer stack 1206, 1208, 1210 and place the veneer sheet 1277 on green panel stack 360A.

Of note again, in embodiments where robotic panel assembly cell 1211A is used to produce green layered wood product stacks of other types of layered wood products, such as green PLV panels, core handling robot 1253 is either deactivated or not present. In these cases, veneer handling robot 1251 is directed by control signals from control system 1202 to retrieve veneer sheet 1275 from the appropriate graded veneer stack 1206, 1208, 1210 and place the veneer sheet 1275 on green panel stack 360A. Then glue application robot 1255 is directed by the control signals from control system 1202 to apply a layer of glue 1285 from glue reservoir 1256 to veneer sheet 1275. Then veneer handling robot 1251 is simply directed by control signals from control system 1202 to retrieve another veneer sheet 1277 from the appropriate graded veneer stack 1206, 1208, 1210 and place the veneer sheet 1277 on veneer sheet 1275.

The result of the operations above is a second single three-ply green layered wood product panel 1243. The process above is then repeated to create the desired number of green layered wood product panel for green panel stack 360A. As noted above, it is not uncommon for green panel stack 360A to include forty or more individual green layered wood product panels.

It is worth noting again that green panel stack 360A of FIG. 12D produced by robotic panel assembly cell 1211A is virtually identical to green panel stack 360A of FIG. 3D, or any of the green panel stacks 360 of FIG. 1D or FIG. 3D. Consequently, robotic panel assembly cell 1211A literally replaces all of the prior art structure shown in as FIG. 3C and the stack production and processing section 399 of FIG. 3D, including traditional layered wood product panel assembly layup line 350 and stack press delivery line 362. This alone means that local robotic panel assembly and pressing station 1200A eliminates the need for hundreds of square feet of floor space, thousands of moving parts, multiple sensors and motors, and dozens of sub-assemblies and human operators.

In addition, according to the disclosed embodiments, and in contrast to prior art systems, robotic panel assembly cell 1211A is located locally at, or near, pre-press 370A and hot press 380A. Therefore, green panel stack 360A is assembled by robotic panel assembly cell 1211A locally with respect to the pressing line. Consequently, robotic panel assembly cell 1211A assembles the same green panel stack 360A as any of the green panel stacks 360 of FIG. 3D or FIG. 3D locally with respect to pre-press 370A and hot press 380A and at a single location.

As seen in FIG. 12D, once robotic panel assembly cell 1211A creates green panel stack 360A, green panel stack 360A is transferred to pre-press 370A and green panel stack 360A is loaded into pre-press 370A where the green panel stack 360A is subjected to pre-pressing by the methods discussed above. In the cold press 370A green panel stack 360A is pressed to flatten out the structure and force out any air pockets that may exist in the green panel stack 360A and to create pre-pressed stack 361A.

Once pre-pressed stack 361A is created, pre-pressed stack 361A is conveyed to an unstacking mechanism (not shown) which feeds the layered wood structure panels making up pre-pressed stack 361A one at a time into slots of hot press 380A. At hot press 380A the layered wood structure panels making up pre-pressed stack 361A are subjected to further pressure and heat to further flatten and cure the layered wood structure panels making up pre-pressed stack 361A by the methods discussed above. The layered wood structure panels are then re-stacked to form cured layered wood panel product stack 363A.

Cured layered wood panel product stack 363A is then conveyed to panel trim, quality analysis, and shipping area 311 where the individual layered wood panels making up cured layered wood panel product stack 363A are trimmed to size, subjected to quality control analysis, and then shipped to customers.

The pressing and trimming/quality control/shipping process shown in FIG. 12D is virtually identical to the pressing and finishing/quality control/shipping process discussed above with respect to FIG. 3D. Thus, according to one embodiment, once robotic panel assembly cell 1211A creates green panel stack 360A, green panel stack 360A is processed in the same manner, and using the same equipment, as is used to traditionally process layered wood products. Consequently, existing cold and hot press equipment need not be replaced. Therefore, the use of the disclosed local robotic panel assembly and pressing station 1200A results in eliminating the need for hundreds of square feet of floor space, thousands of moving parts, multiple sensors and motors, and dozens of sub-assemblies and human operators of the prior art structure shown in as FIG. 3C and the stack production and processing section 399 of FIG. 3D, while still minimizing the amount of processing equipment that must be replaced.

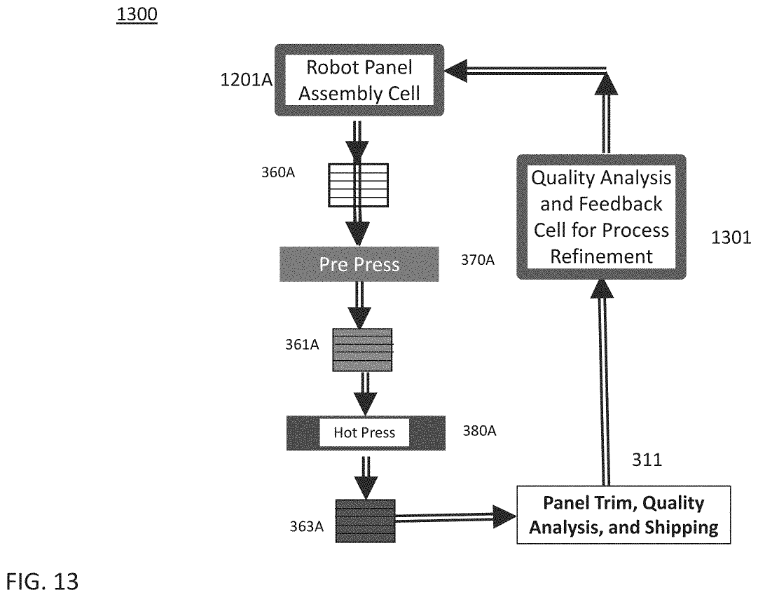

In some embodiments, a quality analysis and feedback cell for process refinement is included in a local robotic panel assembly cell. FIG. 13 is a diagram of a local robotic panel assembly and pressing station 1300 including a quality analysis and feedback cell 1301 for process refinement in accordance with one embodiment.

As seen in FIG. 13, once local robotic panel assembly cell 1201A creates green panel stack 360A, green panel stack 360A is transferred to pre-press 370A and green panel stack 360A is loaded into pre-press 370A where the green panel stack 360A is subjected to cold pre-pressing. In the pre-press 370A green panel stack 360A is pressed to flatten out the structure and force our any air pockets that may exist in the green panel stack 360A and to create pre-pressed stack 361A by the methods discussed above.

Once pre-pressed stack 361A is created, pre-pressed stack 361A is conveyed to an unstacking mechanism (not shown) which feeds the layered wood structure panels making up pre-pressed stack 361A one at a time into slots of hot press 380A. At hot press 380A the layered wood structure panels making up pre-pressed stack 361A are subjected to further pressure and heat to further flatten and cure the layered wood structure panels making up pre-pressed stack 361A by the methods discussed above. The layered wood structure panels are then re-stacked to form cured layered wood panel product stack 363A.

Cured layered wood panel product stack 363A is then conveyed to panel trim, quality analysis, and shipping area 311 where the individual layered wood panels making up cured layered wood panel product stack 363A are trimmed to size, subjected to quality control analysis, and then shipped to customers.

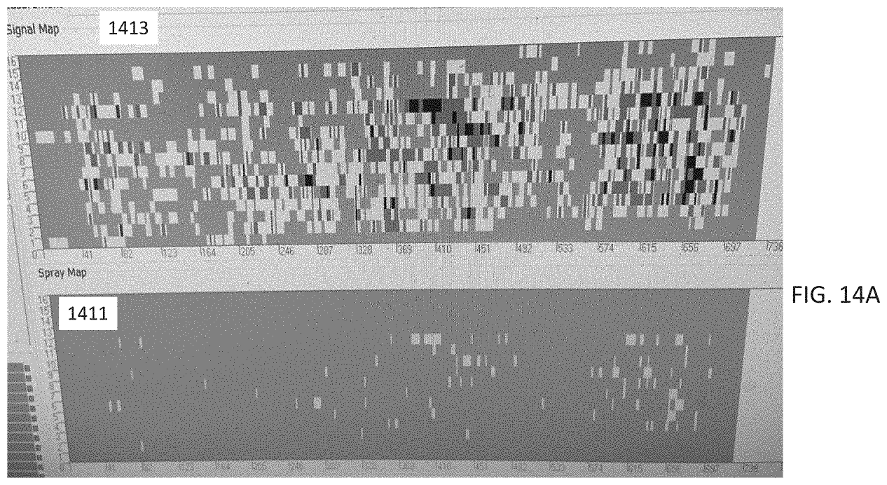

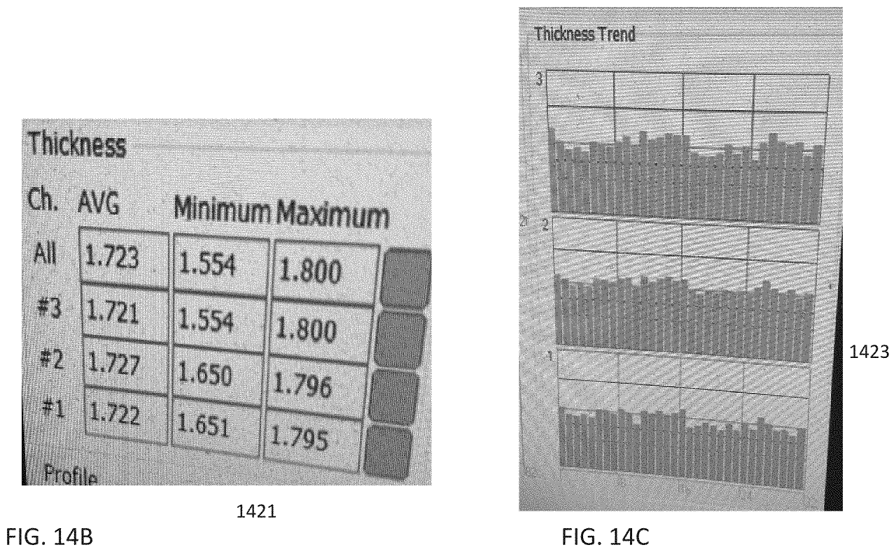

FIG. 14A is a photograph of a structural density analysis report 1411 based on the results of processing using one type of wood product panel bond analyzer used in accordance with one embodiment.

As seen in FIG. 14A, in one embodiment, the wood panel exits the press and typically passes through the wood product panel bond analyzer (not shown) of quality analysis and feedback cell 1301. Typically, a wood product panel bond analyzer is configured to analyze and record the reading for each 3″×3″ square of the panel as it passes the ultrasonic heads. This size can be configured per customer requirements, with 3″ being common in wood products panel manufacturing. For each panel analyzed, the grader prepares a data file and represents it in a visual format. The top image 1413 is typically gray scale and the lower image 1411 being colorized. The customer can define the values required for quality and alert if those thresholds are not met. Numerous combinations of quality and number of adjacent squares can be considered per customer requirements.

FIG. 14B is a photograph of average panel thickness analysis report 1421 based on the results of processing using one type of wood product panel bond analyzer used in accordance with one embodiment.

FIG. 14C is a photograph of panel thickness trend analysis report 1423 based on the results of processing using one type of wood product panel bond analyzer used in accordance with one embodiment.

Referring to FIGS. 14B and 14C together, typically each panel is also measured for thickness. Alert points can be configured as to allow alerting when thresholds are exceeded. Panel thickness is often controlled by press pressure and/or press to position instrumentation allowing the press to compress the panel the required amount to produce a completed panel withing selected tolerances.

The pressing and trimming/quality control/shipping process shown in FIGS. 12A, 12B, 12C, 12D, and 13 is virtually identical to the pressing and finishing/quality control/shipping process discussed above with respect to FIG. 3D. Thus, according to one embodiment, once robotic panel assembly cell 1201A creates green panel stack 360A, green panel stack 360A is processed in the same manner, and using the same equipment, as is used to traditionally process layered wood products. Consequently, existing cold and hot press equipment need not be replaced. Therefore, the use of the disclosed local robotic panel assembly and pressing station 1200A results in eliminating the need for hundreds of square feet of floor space, thousands of moving parts, multiple sensors and motors, and dozens of sub-assemblies and human operators of the prior art structure shown in as FIG. 3C and the stack production and processing section 399 of FIG. 3D, while still minimizing the amount of processing equipment that must be replaced.

Referring to FIGS. 12C and 13 together, when the individual layered wood panels making up cured layered wood panel product stack 363A are subjected to quality control analysis at panel trim, quality analysis, and shipping area 311, quality parameter data, such as, but not limited to, the data discussed above with respect to FIGS. 4A, 4B, 4C, and 4D, regarding each layered wood panel making up cured layered wood panel product stack 363A is collected.

In various embodiments, this quality parameter data represents results from analysis of specific quality parameters and specific quality parameter values, such as density and thickness as discussed above.

In one embodiment, the specific quality parameters and specific quality parameter values of the quality parameter data obtained from the quality control analysis at panel trim, quality analysis and shipping area 311 is correlated with control signal and production parameter data obtained from control system 1202 of robotic panel assembly cell 1201A. In one embodiment, the quality parameter data and control signal and production parameter data are forwarded to quality analysis and feedback cell 301 for analyzing the quality of cured layered wood product panels. Based on this analysis, the control signals sent from control system 1202 of robotic panel assembly cell 1201A to the one or more veneer handling robots, the one or more core handling robots, and the one or more glue application robots is adjusted in order to improve the quality of subsequent cured layered wood product panels.

In one embodiment, the quality analysis and feedback cell 1301 includes an artificial intelligence module (not shown). In one embodiment, the quality analysis and feedback cell 1301 obtains the quality parameter data from the quality analysis of multiple cured layered wood product panels and correlates the quality parameter data associated with each cured layered wood product panel and the control signal and production parameter data associated with the control signals generated by control system 1202 used to control the one or more veneer handling robots, the one or more glue application robots, and the one or more core handling robots used to produce the cured layered wood product panel.

In one embodiment, the correlated quality data and control signal and production parameter data is then used as training data to generate a trained artificial intelligence module. In one embodiment, the trained artificial intelligence module is then used adjust the control signals used to control the one or more veneer handling robots, the one or more glue application robots, and the one or more core handling robots automatically for subsequent green layered wood product panel stack production.

As discussed above, embodiments of the present disclosure provide an effective and efficient technical solution to the long-standing technical problem of providing a method and system for producing layered wood products that is more consistent, more effective, less expensive to operate and more efficient than prior art methods.

The innovations disclosed herein are described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms may be high-level descriptions of the actual operations that are performed. The actual operations that correspond to these terms may vary depending on the particular implementation.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically, or chemically) coupled or linked and does not exclude the presence of intermediate elements between the coupled or associated items absent specific contrary language.

As used herein, operations that occur “simultaneously” or “concurrently” occur generally at the same time as one another, although delays in the occurrence of one operation relative to the other due to, for example, spacing, play or backlash between components in a mechanical linkage such as threads, gears, etc., are expressly within the scope of the above terms, absent specific contrary language.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosed technology may be applied, it should be recognized that the illustrated embodiments are only preferred examples of the disclosed technology and should not be taken as limiting the scope of the disclosed technology. Rather, the scope of the disclosure is at least as broad as the following claims. We therefore claim all that comes within the scope of these claims.

Therefore, numerous variations, whether explicitly provided for by the specification or implied by the specification or not, may be implemented by one of skill in the art in view of this disclosure.

What is claimed is:

1. A system for producing layered wood products comprising:
an NIR analysis system, the NIR analysis system for analyzing a veneer surface and assigning a grade to the veneer based, at least in part, on the analysis of the veneer surface;
at least one stack of veneer, the at least one stack of veneer including veneer graded by the NIR analysis system;
a robotic panel assembly cell, the robotic panel assembly cell producing a stack of green layered wood product panels using veneer from the at least one stack of veneer;
a pre-press, the pre-press pressing the stack of green layered wood product panels to produce pre-pressed layered wood product panels; and
a hot press, the hot press heating and pressing the pre-pressed layered wood product panels to produce cured layered wood product panels.

2. The system of claim 1 wherein the robotic panel assembly cell includes:
one or more veneer handling robots, the one or more veneer handling robots retrieving veneer sheets from the at least one stack of veneer and placing the veneer sheets on a green layered wood product panel stack in accordance with received control signals;
one or more glue application robots, the one or more glue application robots applying a layer of glue between sheets of veneer in the green layered wood product panel stack in accordance with received control signals; and
a control system for controlling the one or more veneer handling robots and the one or more glue application robots and directing the one or more veneer handling robots and the one or more glue application robots in the construction of the green layered wood product panel stack via control signals sent to the one or more veneer handling robots and the one or more glue application robots.

3. The system of claim 1 wherein the local robotic panel assembly and pressing station is used to produce a plywood panel stack and the robotic panel assembly cell includes:
one or more veneer handling robots, the one or more veneer handling robots retrieving veneer sheets from the at least one stack of veneer and placing the veneer sheets on a green plywood panel stack in accordance with received control signals;
one or more core handling robots, the one or more core handling robots retrieving core material from a core material stack including veneer graded by the NIR analysis system and placing the core material on the green plywood panel stack in accordance with received control signals;
one or more glue application robots, the one or more glue application robots applying a layer of glue between sheets of veneer and layers of core material in the green plywood panel stack in accordance with received control signals; and
a control system for controlling the one or more veneer handling robots, the one or more core handling robots, and the one or more glue application robots and directing the one or more veneer handling robots, the one or more core handling robots, and the one or more glue application robots in the construction of the green plywood panel stack via control signals sent to the one or more veneer handling robots and the one or more glue application robots.

4. The system of claim 3 wherein the green plywood panel stack includes two or more individual green plywood panels.

5. The system of claim 1 wherein the local robotic panel assembly and pressing station is used to produce Parallel-Laminated Veneer (PLV) panel stacks and the robotic panel assembly cell includes:
one or more veneer handling robots, the one or more veneer handling robots retrieving veneer sheets from the at least one stack of veneer and placing the veneer sheets on a on a green PLV panel stack in accordance with received control signals;
one or more glue application robots for applying a layer of glue between sheets of veneer in the green PLV panel stack in accordance with received control signals; and
a control system for controlling the one or more veneer handling robots and the one or more glue application robots and directing the one or more veneer handling robots and the one or more glue application robots in the construction of the green PLV panel stacks via control signals sent to the one or more veneer handling robots and the one or more glue application robots.

6. The system of claim 5 wherein the green PLV panel stack includes two or more individual green PLV panels.

7. The system of claim 1 wherein the NIR analysis system includes:
a surface irregularity level to greyscale mapping database, the surface irregularity level to greyscale mapping database containing mapping data that maps surface irregularities to Near InfraRed (NIR) image greyscale values for veneer;
one or more sources of illumination positioned to illuminate a veneer surface, the NIR analysis system including one or more NIR cameras positioned to capture one or more NIR images of the illuminated veneer surface;
a physical memory, the physical memory including NIR image data representing one or more NIR images of the illuminated surface of the veneer captured using the one or more NIR cameras;
one or more processors for processing the data representing one or more NIR images of the illuminated surface of the veneer to generate NIR greyscale image data indicating irregularities in the illuminated surface of the veneer;
one or processors for processing the NIR greyscale image data using the surface irregularity level to greyscale mapping database data to identify irregularities for the surface of the veneer;
a grade assignment module for generating grading data representing a grade assigned to the veneer based on the identified irregularities for the surface of the veneer.

8. The system of claim 7 wherein the one or more sources of illumination include one or more LED light sources.

9. The system of claim 7 wherein one or more NIR cameras are adjustably positioned to capture one or more NIR images of the illuminated surface of the veneer.

10. The system of claim 1 wherein the NIR analysis system includes one or more sources of illumination positioned to illuminate a veneer surface and at least three NIR cameras positioned to capture one or more NIR images of the illuminated veneer surface, the at least three NIR cameras including:
a first NIR camera positioned to capture one or more NIR images of the illuminated surface of the full veneer sheet at a first angle with respect to a line parallel to the illuminated surface of the full veneer sheet;
a second NIR camera positioned to capture one or more NIR images of the illuminated surface of the full veneer sheet at a second angle with respect to a line parallel to the illuminated surface of the full veneer sheet, the second angle being different from the first angle; and
a third NIR camera positioned to capture one or more NIR images of the illuminated surface of the full veneer sheet at a third angle with respect to a line parallel to the illuminated surface of the full veneer sheet, the third angle being different from the first angle.

11. The system of claim 10 wherein the first angle is approximately 45 degrees, the second angle is approximately 90 degrees, and the third angle is approximately 135 degrees.

12. A system for producing layered wood products comprising:
a veneer analysis system for analyzing a veneer surface and assigning a grade to the veneer based, at least in part, on the analysis of the veneer surface, the veneer analysis system including an NIR analysis system;
one or more veneer selection and stacking robot control systems to control the operation of one or more veneer selection and stacking robots, the one or more veneer selection and stacking robot control systems generating veneer selection and stacking robot control signals based, at least in part, on the grade assigned to the veneer;
one or more veneer selection and stacking robots, the one or more veneer selection and stacking robots moving veneer from the veneer analysis system to an appropriate one of at least one veneer sheet stack in response to the veneer selection and stacking robot control signals received from the one or more veneer selection and stacking robot control systems;
at least one stack of veneer, the at least one stack of veneer having been created by the one or more veneer selection and stacking robots;
a robotic panel assembly cell, the robotic panel assembly cell producing a stack of green layered wood product panels using veneer from the at least one stack of veneer;
a pre-press, the pre-press pressing the stack of green layered wood product panels to produce pre-pressed layered wood product panels; and
a hot press, the hot press heating and pressing the pre-pressed layered wood product panels to produce cured layered wood product panels.

13. The system of claim 12 wherein the NIR analysis system includes:
a surface irregularity level to greyscale mapping database, the surface irregularity level to greyscale mapping database containing mapping data that maps surface irregularities to Near InfraRed (NIR) image greyscale values for veneer;
one or more sources of illumination positioned to illuminate a veneer surface, the NIR analysis system including one or more NIR cameras positioned to capture one or more NIR images of the illuminated veneer surface;
a physical memory, the physical memory including NIR image data representing one or more NIR images of the illuminated surface of the veneer captured using the one or more NIR cameras;
one or more processors for processing the data representing one or more NIR images of the illuminated surface of the veneer to generate NIR greyscale image data indicating irregularities in the illuminated surface of the veneer;
one or processors for processing the NIR greyscale image data using the surface irregularity level to greyscale mapping database data to identify irregularities for the surface of the veneer; and
a grade assignment module for generating grading data representing a grade assigned to the veneer based on the identified irregularities for the surface of the veneer.

14. The system of claim 12 wherein the veneer analysis system includes a camera for capturing a black and white image of a veneer surface.

15. The system of claim 14 wherein the veneer analysis system is configured to determine a scaling factor between the full veneer sheet and the black and white image based at least in part on known dimensions of a reference image.

16. The system of claim 14, wherein the veneer analysis system is configured to translate the black and white image such that the black and white image is oriented to match the orientation of the reference image.

17. The system of claim 12 wherein at least one of the one or more veneer selection and stacking robots includes a selectively activated vacuum head for moving each individual full veneer sheet from the veneer analysis and selection conveyor system to an appropriate veneer stack in response to the veneer selection and stacking robot control signals received from the one or more veneer selection and stacking robot control systems.

18. A method for producing layered wood products comprising:
providing an NIR analysis system for analyzing a veneer surface and assigning a grade to the veneer based, at least in part, on the analysis of the veneer surface;
creating at least one stack of veneer including veneer graded by the NIR analysis system;
providing a robotic panel assembly cell;
using the robotic panel assembly cell to produce a stack of green layered wood product panels using veneer from the at least one stack of veneer;
providing a pre-press;
using the pre-press to press the stack of green layered wood product panels to produce pre-pressed layered wood product panels;
providing a hot press; and
using the hot press heating and pressing the pre-pressed layered wood product panels to produce cured layered wood product panels.

19. The method of claim 18 wherein the robotic panel assembly cell includes:
one or more veneer handling robots, the one or more veneer handling robots retrieving veneer sheets from the at least one stack of veneer and placing the veneer sheets on a green layered wood product panel stack in accordance with received control signals;
one or more glue application robots, the one or more glue application robots applying a layer of glue between sheets of veneer in the green layered wood product panel stack in accordance with received control signals; and
a control system for controlling the one or more veneer handling robots and the one or more glue application robots and directing the one or more veneer handling robots and the one or more glue application robots in the construction of the green layered wood product panel stack via control signals sent to the one or more veneer handling robots and the one or more glue application robots.

20. The method of claim 18 wherein the NIR analysis system includes:
a surface irregularity level to greyscale mapping database, the surface irregularity level to greyscale mapping database containing mapping data that maps surface irregularities to Near InfraRed (NIR) image greyscale values for veneer;
one or more sources of illumination positioned to illuminate a veneer surface, the NIR analysis system including one or more NIR cameras positioned to capture one or more NIR images of the illuminated veneer surface;
a physical memory, the physical memory including NIR image data representing one or more NIR images of the illuminated surface of the veneer captured using the one or more NIR cameras;
one or more processors for processing the data representing one or more NIR images of the illuminated surface of the veneer to generate NIR greyscale image data indicating irregularities in the illuminated surface of the veneer;
one or processors for processing the NIR greyscale image data using the surface irregularity level to greyscale mapping database data to identify irregularities for the surface of the veneer; and
a grade assignment module for generating grading data representing a grade assigned to the veneer based on the identified irregularities for the surface of the veneer.
